(19) United States
(12) Patent Application Publication
(10) Pub. No.: US 2014/0036759 A1
(43) Pub. Date: Feb. 6, 2014

(54) DIGITAL BROADCAST TRANSMITTER FOR TRANSMITTING TRANSPORT STREAM CONTAINING AUDIO PACKETS, DIGITAL BROADCAST RECEIVER FOR RECEIVING SAME, AND METHODS THEREOF

(71) Applicants: Jin-hee Jeong, Yongin-si (KR); Hak-ju Lee, Incheon (KR); Jae-yoel Kim, Suwon-si (KR)

(72) Inventors: Jin-hee Jeong, Yongin-si (KR); Hak-ju Lee, Incheon (KR); Jae-yoel Kim, Suwon-si (KR)

(73) Assignee: SAMSUNG ELECTRONICS CO., LTD., Suwon-si (KR)

(21) Appl. No.: 14/110,530

(22) PCT Filed: Apr. 6, 2012
(86) PCT No.: PCT/KR12/02637

§ 371 Date: Oct. 8, 2013

Related U.S. Application Data
(60) Provisional application No. 61/473,362, filed on Apr. 8, 2011.

(30) Foreign Application Priority Data
Apr. 5, 2012 (KR) 10-2012-0035471

(51) Int. Cl. H04W 4/06

(52) U.S. Cl. CPC H04W 4/06
USPC 370/312

(57) ABSTRACT

Disclosed is a method for processing a stream of a digital broadcast transmitter. The method includes forming a stream containing normal data and mobile/handheld (M/H data), and encoding and interleaving the stream and outputting and transmitting the encoded and interleaved stream, wherein the forming of the stream includes forming the stream such that a predetermined number of audio packets of the normal data are disposed per predetermined time cycle.

### CROSS-REFERENCE TO RELATED APPLICATIONS

This Application is a National Stage Entry of PCT/KR2012/002637, which claims priority to U.S. provisional patent application No. 61/473,362, filed on Apr. 8, 2011 in the U.S. Patent and Trademark Office and Korean patent application No. 10-2012-0035471, filed on Apr. 5, 2013 in the Korean Patent Office, the entire disclosures of which are herein incorporated by reference in their entirety.

### BACKGROUND

1. Field

Methods and apparatuses consistent with the exemplary embodiments relate to a digital broadcast transmitter for transmitting a transport stream containing audio packets, a digital broadcast receiver for receiving the same, and methods thereof, and more particularly, to a digital broadcast transmitter for forming a transport stream where audio packets of a predetermined size are disposed per predetermined period and for transmitting the transport stream, a digital broadcast receiver for receiving and processing the transport stream, and methods thereof.

2. Description of the Related Art

With the propagation of digital broadcasts, various types of electronic apparatuses provide digital broadcast services. Especially, recently, besides apparatuses in households, for example, digital broadcast TVs, and set top boxes, etc., portable apparatuses that individuals carry, for example, mobiles phones, navigations, PDAs, and MP3 players, etc., have functions supporting digital broadcast services.

Therefore, there have been discussions about the digital broadcast standards for providing digital broadcast services in portable apparatuses.

Among these, there have been discussions on the ATSC-MH standard. According to the ATSC-MH standard, technologies for disposing mobile data inside a transport stream for transmitting normal data and transmitting the transport stream are disclosed.

Mobile data is data to be received from a mobile apparatus and then processed. Thus, due to the mobility of mobile apparatuses, mobile data is processed to have more protection against errors as compared to normal data, and is included inside the transport stream.

FIG. 1 is a view illustrating an example of a transport stream containing mobile data and normal data.

A) of FIG. 1 illustrates a stream where each of mobile data and normal data is disposed in packets and then muxed.

The stream shown in A) of FIG. 1 is converted into a structure like the stream shown in B) of FIG. 1 by interleaving. According to B of FIG. 1, MH, that is, mobile data, may be divided into A area and B area by interleaving. A area denotes an area within a certain range based on a portion where mobile data of or more than a certain size is gathered in a plurality of transmit units, while B area denotes the portion other than A area. Division of A area and B area is just an example, and thus, the areas may be divided differently according to circumstances. That is, in B) of FIG. 1, A area may be the portion in which normal data is not included, while the portion corresponding to the transmit unit in which normal data is disposed albeit just a little may be B area.

There have been discussions on technologies for transmitting mobile data and normal data based on more diverse and efficient methods using a stream having a structure of FIG. 1. Especially, there may be cases where not enough audio packets of audio data are transmitted due to transmission of mobile data. Thus, there is a growing need for a technology for preventing such cases.

### SUMMARY

An aspect of the present disclosure is to resolve the aforementioned problems, and more particularly to provide a digital broadcast transmitter which transmits a transport stream configured so as to buffer an appropriate number of audio packets in a digital broadcast receiver, a digital broadcast receiver which receives and processes the transport, and methods thereof.

### BRIEF DESCRIPTION OF THE DRAWINGS

The above and/or other aspects of the present disclosure will be more apparent by describing certain exemplary embodiments with reference to the accompanying drawings, in which:

FIG. 1 is a view illustrating an example of a configuration of a transport stream according to the ATSC-MH standard;

FIGS. 2 to 4 are block diagrams illustrating a configuration of a digital broadcast transmitter according to various exemplary embodiments;

FIGS. 5 and 6 are block diagrams illustrating an example of a configuration of a frame encoder;

FIG. 7 is a block diagram illustrating an example of a block processor;

FIG. 8 is a view for explaining an example of a block classification of a stream;

FIG. 9 is a block diagram illustrating an example of a configuration of a signaling encoder;

FIGS. 10 to 13 are views illustrating various examples of a configuration of a trellis encoder;

FIG. 14 is a view for explaining an example of a structure of a mobile data frame;

FIGS. 15 to 21 are views illustrating a stream configuration according to various exemplary embodiments;

FIGS. 22 to 28 are views illustrating a base data inserting pattern according to various exemplary embodiments;

FIG. 29 is a view illustrating a pattern where mobile data is disposed in a normal data area according to a first mode;

FIG. 30 is a view illustrating an interleaved state of the stream of FIG. 29;

FIG. 31 is a view illustrating a pattern where mobile data is disposed in a normal data area according to a second mode;

FIG. 32 is a view illustrating an interleaved state of the stream of FIG. 31;

FIG. 33 is a view illustrating a pattern where mobile data is disposed in a normal data area according to a third mode;

FIG. 34 is a view illustrating an interleaved state of the stream of FIG. 33;

FIG. 35 is a view illustrating a pattern where mobile data is disposed in a normal data area according to a fourth mode;

FIG. 36 is a view illustrating an interleaved state of the stream of FIG. 35;

FIGS. 37 to 40 are views illustrating a pattern where mobile data is disposed according to various modes according to exemplary embodiments;

FIGS. 41 to 43 are views illustrating a state where various types of slots are sequentially repeatedly disposed;

FIGS. 44 to 47 are views for explaining a block allocation method according to various exemplary embodiments;

FIG. 48 is a view for explaining various exemplary embodiments defining a starting point of an RS frame;

FIG. 49 is a view for explaining an inserting location of signaling data;

FIG. 50 is a view illustrating an example of a data field sync configuration for delivering signaling data;

FIGS. 51 to 53 are views illustrating a configuration of a digital broadcast receiver according to various exemplary embodiments;

FIG. 54 is an example of a stream format after interleaving;

FIG. 55 is a view for explaining an example of a method of pre-signaling information of a next frame;

FIG. 56 is a stream structure after interleaving at Scalable Mode 11a;

FIG. 57 is a stream structure before interleaving at Scalable Mode 11a;

FIG. 58 is a stream structure illustrating a first type Orphan area after interleaving;

FIG. 59 is a stream structure illustrating a first type Orphan area before interleaving;

FIG. 60 is a stream structure illustrating a second type Orphan area after interleaving;

FIG. 61 is a stream structure illustrating a second type Orphan area before interleaving;

FIG. 62 is a stream structure illustrating a third type Orphan area after interleaving;

FIG. 63 is a stream structure illustrating a third type Orphan area before interleaving;

FIG. 64 is a stream structure before interleaving at block expansion mode 00;

FIG. 65 is a stream structure after interleaving at block expansion mode 00;

FIG. 66 is a group allocation order in a sub frame;

FIG. 67 is a slot allocation pattern for a multi parade;

FIG. 68 is a block diagram illustrating a configuration of a digital broadcast receiver according to another exemplary embodiment;

FIG. 69 is a frame size code table defined in a standard;

FIG. 70 is a block diagram illustrating a configuration of a digital broadcast transmitter for transmitting an audio packet according to an exemplary embodiment;

FIGS. 71 to 74 are views for explaining an audio packet transmitting method according to various exemplary embodiments; and

FIG. 75 is a block diagram illustrating a configuration of a digital broadcast receiver configured to receive a transport stream and process an audio packet according to an exemplary embodiment.

### DESCRIPTION OF THE EXEMPLARY EMBODIMENTS

Certain exemplary embodiments are described in greater detail below with reference to the accompanying drawings.

[Digital Broadcast Transmitter]

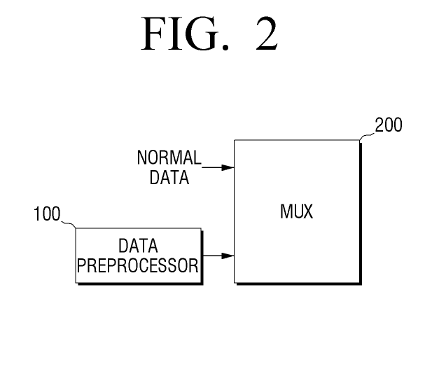

According to FIG. 2, a digital broadcast transmitter according to an exemplary embodiment includes a data preprocessor 100 and mux 200.

The data preprocessor 100 is configured to receive mobile data, process the received mobile data appropriately, and convert the processed mobile data into a format suitable for transmission.

The multiplexer (e.g., mux) 200 forms a transport stream which contains the mobile data output from the data preprocessor 100. In a case where normal data must be transmitted together with the mobile data, the mux 200 multiplexes (e.g., muxes) the mobile data and normal data, to form a transport stream.

The data preprocessor 100 may process in a format where mobile data is disposed in an entirety or portion of a packet allocated to normal data of an entire stream.

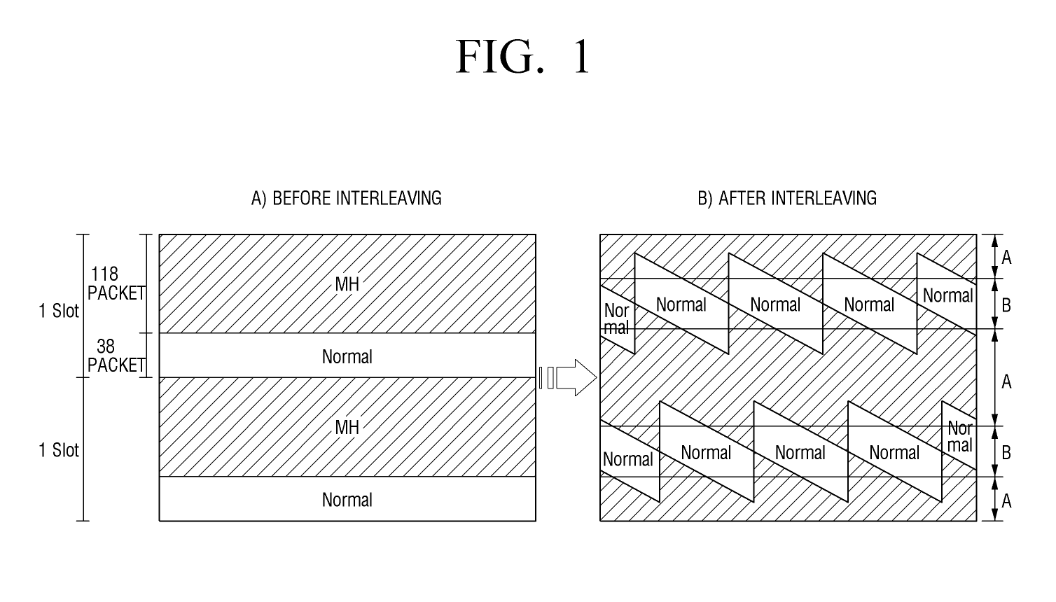

That is, as illustrated in FIG. 1, according to the ATSC-MH standard, some packets of the entire group of packets are allocated to normal data. More specifically, for example, as in FIG. 1, a stream may be divided into a plurality of slots in time units, and one slot may consist of a total of 156 packets. Of these, 38 packets may be a portion allocated to normal data, while the remaining 118 packets may be a portion allocated to mobile data. For convenience of explanation, in this specification, the aforementioned 118 packets will be denoted as an area allocated to mobile data or a first area, and the aforementioned 38 packets will be denoted as an area allocated to normal data, or a second area. In addition, normal data refers to various types of conventional data that may be received from a conventional TV and be processed, while mobile data refers to types of data that may be received and processed in a mobile apparatus. Mobile data may be called by various terms, such as robust data, turbo data, or additional data, etc., depending of the circumstances.

The data preprocessor 100 may dispose mobile data in a packet area allocated to mobile data, and also dispose mobile data in a portion or entirety of a packet allocated to normal data. For convenience of explanation, mobile data disposed in a packet allocated to mobile data will be called existing mobile data, and an area allocated to the existing mobile data will be called a first area as aforementioned. On the other hand, mobile data disposed in a packet allocated to normal data will be called new mobile data or mobile data, for convenience of explanation. Existing mobile data and mobile data may be the same data or a different type of data.

The data preprocessor 100 may dispose mobile data in various types according to the setting state, such as a frame mode, etc. Disposition formation of mobile data will be explained with reference to the drawings hereinafter.

The mux 200 muxes a stream and normal data output from the data preprocessor 100 and forms a transport stream.

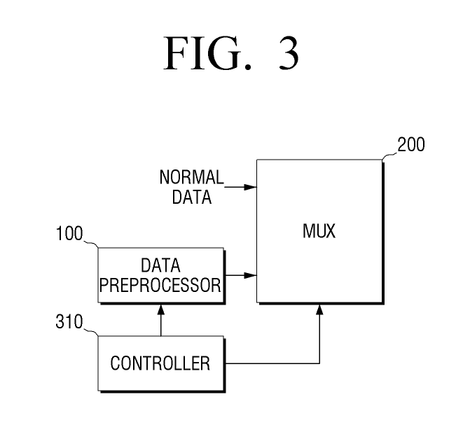

FIG. 3 illustrates an exemplary embodiment where a controller 310 is added to the digital broadcast transmitter of FIG. 2. According to FIG. 3, the controller 310 provided in the digital broadcast transmitter determines a setting state of a frame mode, and controls operations of the data preprocessor 100.

More specifically, when it is determined that a first frame mode is set, the controller 310 controls the data preprocessor 100 to dispose mobile data not in the entirety of the packets allocated to normal data, but only in the first area. That is, the data preprocessor 100 outputs a stream only containing existing mobile data. Accordingly, in the packets allocated to the normal data, normal data is disposed by the mux 200, thereby forming a transport stream.

When it is determined that a second frame mode is set, the controller 310 controls the preprocessor 100 to dispose existing mobile data in the packets allocated to mobile data, that is, the first area, and to dispose mobile data in at least a portion of the packets allocated to the normal data, that is the second area.

In this case, the controller 310 may determine a setting state of another mode provided separately from the frame mode, that is, a mode determining the number of packets at which mobile data will be disposed of among the packets allocated to the normal data. Accordingly, the controller may control the data preprocessor 100 to dispose mobile data in the number of packets corresponding to the setting state of the mode, among the entire packets allocated to normal data.

Herein, a mode may be provided in various formats. For example, a mode may include at least one compatibility mode, or at least one incompatibility mode. A compatibility mode denotes a mode which maintains compatibility with a conventional normal data receiver which receives and processes normal data, while an incompatibility mode denotes a mode which does not maintain compatibility.

More specifically, a compatibility mode may include a plurality of compatibility modes disposing new mobile data in at least a portion of the second area. For example, a compatibility mode may be one of a first compatibility mode which disposes mobile data in only some of the packets among the entirety of packets allocated to normal data and a second compatibility mode which disposes mobile data in the entirety of packets allocated to normal data.

Herein, the first compatibility mode may be a mode for disposing mobile data in only a portion of each data area of some of the packets in the second area. That is, mobile data may be disposed in some data area of the entire data area of some packets, and normal data may be disposed in the remaining data area.

Otherwise, the first compatibility mode may be embodied as a mode for disposing mobile data in the entire area of some packets inside the second area.

Besides the above, a mode may be provided in various formats comprehensively considering the number of packets allocated to normal data, size, type, transmission time, transmission environment, etc., of mobile data.

For example, when 38 packets are allocated to normal data as illustrated in FIG. 1, the first compatibility mode may include:

1) a first mode of disposing new mobile data in 38 packets in 1/4 ratio,

2) a second mode of disposing new mobile data in 38 packets in 2/4 ratio,

3) a third mode of disposing new mobile data in 38 packets in 3/4 ratio, and

4) a fourth mode of disposing new mobile data in the entire 38 packets,

Herein, in the case of a first mode, it is possible to dispose new mobile data in 2 packets among 38 packets combined with 9 packets corresponding to the remaining 36 packets divided by 4, that is, a total of 11 packets. In addition, in the case of a second mode, it is possible to dispose new mobile data in 2 packets among 38 packets combined with 18 packets corresponding to the remaining packets divided by 2, that is, a total of 20 packets. In the case of a third mode, it is possible to dispose new mobile data in 2 packets among 38 packets combined with 27 packets which is ¾ of the remaining 36 packets, that is, a total of 29 packets. In the case of a fourth mode, it is possible to dispose new mobile data in all 38 packets.

An incompatibility mode refers to a mode capable of increasing the transmission capacity of new mobile data, regardless of the compatibility with the receiver receiving normal data. More specifically, an incompatibility mode may be a mode of disposing new mobile data using not only the entire second area but also an MPEG header and RS parity area provided inside the first area.

Consequently, the data preprocessor 100 of FIG. 2 or FIG. 3 may form a transport stream by disposing new mobile data according to the following various modes.

1) a first mode of disposing new mobile data in a total of 11 packets among the 38 packets allocated to normal data,

2) a second mode of disposing new mobile data in a total of 20 packets among the 39 packets allocated to normal data,

3) a third mode disposing new mobile data in a total of 29 packets among the 39 packets allocated to normal data,

4) a fourth mode disposing new mobile data in the entire 39 packets allocated to normal data, and

5) a fifth mode of disposing new mobile data in the entire 38 packets allocated to normal data and the area corresponding to the MPEG header and parity area among the areas allocated to existing mobile data.

In the present exemplary embodiments, for convenience of explanation, the fifth mode is called an incompatibility mode, and first to fourth modes are called a compatibility mode, but each mode may be called differently. In addition, in the aforementioned exemplary embodiment, a total of 5 modes including 4 compatibility modes and one incompatibility mode exist, but the number of the incompatibility modes may be changed. For example, the first to third modes may be used as compatibility modes as aforementioned and the fourth mode may be determined as same type as a fifth mode as aforementioned, that is, an incompatibility mode.

The data preprocessor 100 may insert base data besides mobile data. Base data refers to a sequence that both the digital broadcast transmitter and the digital broadcast receiver know. The digital broadcast receiver may receive base data transmitted from the digital broadcast transmitter, check the difference from the sequence that the digital broadcast receiver knows, and apprehend the degree of error correction, etc. Alternatively, the base data may be expressed as training data, training sequence, criteria signal, and additional criteria signal etc., but according to exemplary embodiments, it is called base data.

The data preprocessor 100 may insert at least one of mobile data and base data in various portions among the entirety of the transport stream, to improve receiving performance.

That is, in the stream configuration illustrated in B) of FIG. 1, in A area, MH, that is, mobile data is gathered, while in B area, MH is formed in a cone shape. Accordingly, A area may be called a body area, and B area may be called a head/tail area. It has been a problem in the past that since base data is not disposed in the head/tail area, the performance of the head/tail area is inferior as compared to the data of the body area.

Accordingly, the data preprocessor 100 inserts base data in an appropriate location so that base data can be disposed in the head/tail area as well. Base data may be disposed in a long training sequence format where data of or above a predetermined size are sequentially connected, or in a discontinuously dispersed format.

The insertion formation of mobile data and base data may be made in various ways according to the exemplary embodiments. This will be explained hereinbelow with reference to the drawings. However, prior to that, an example of a detailed configuration of a digital broadcast receiver will be explained in more detail hereinbelow.

[Example of a Detailed Configuration of a Digital Broadcast Receiver]

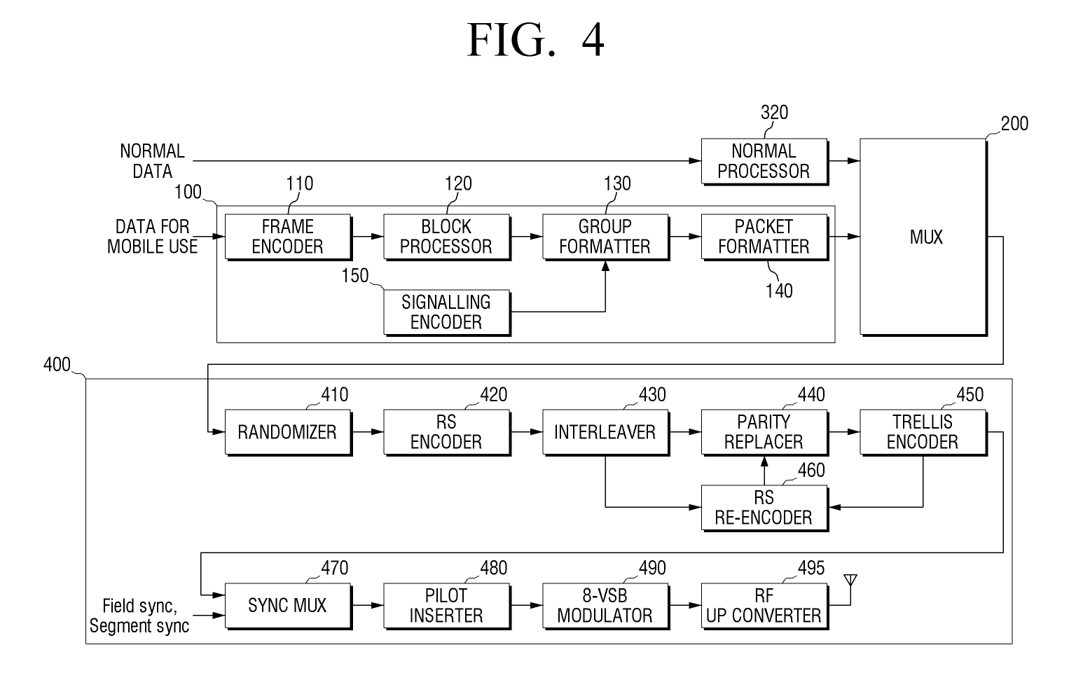

FIG. 4 is a block diagram illustrating an example of a detailed configuration of a digital broadcast transmitter according to an exemplary embodiment of the present disclosure. According to FIG. 4, the digital broadcast transmitter may include a normal processor 320, and exciter 400, besides the data preprocessor 100 and mux 200. Herein, for convenience of explanation, the portion including the data preprocessor 100, normal processor 320, and mux 200 may be called a stream configuration.

In FIG. 4, an illustration of the controller 310 of FIG. 3 is omitted, but it is understood that the controller 310 may also be included in the digital broadcast transmitter. In addition, some of the configurative elements of the digital broadcast transmitter of FIG. 4 may be deleted, or new elements may be added thereto, and the arrangement order and numbers of the elements may also be changed.

According to FIG. 4, the normal processor 320 receives normal data and converts the received normal data into a format suitable to a transport stream configuration. That is, the digital broadcast transmitter forms a transport stream containing normal data and mobile data and transmits the transport stream, and the receiver which receives normal data must be able to receive and process the normal data appropriately. Therefore, the normal processor 320 performs packet timing and PCR adjustment of the normal data (which may also be referred to as main service data) so as to be suitable to the MPEG/ATSC standard used in normal data decoding. A specific explanation thereof is disclosed in ANNEX B of ATSC-MH, and thus, further explanation is omitted.

The data preprocessor 100 includes a frame encoder 110, block processor 120, group formatter 130, packet formatter 140, and signaling encoder 150.

The frame encoder 110 performs an RS frame encoding. More specifically, the frame encoder 110 receives one service and builds a predetermined number of RS frames. For example, if the one service is an M/H ensemble unit consisting of a plurality of M/H parades, the frame encoder 110 forms a predetermined number of RS frames. More specifically, the frame encoder 110 randomizes mobile data being input, performs RS-CRC encoding, divides each RS frame according to the predetermined frame mode, and outputs a predetermined number of RS frames.

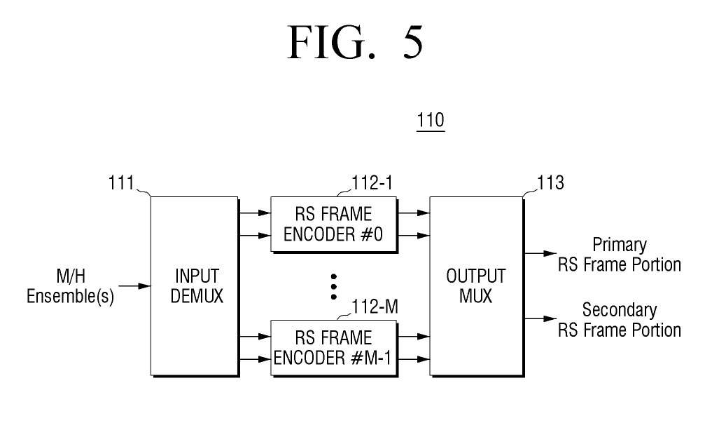

FIG. 5 is a block diagram illustrating an example of a configuration of a frame encoder 100. According to FIG. 5, the frame encoder 110 includes an input demux 111, a plurality of RS frame encoders 112-1˜112-M, and output mux 113.

When mobile data of a predetermined service unit (for example, M/H ensemble) is input, the input demux 111 demuxes the mobile data into a plurality of ensembles, for example, a primary ensemble and secondary ensemble, according to predetermined configuration information, that is, a frame mode, and outputs the data to each RS frame encoder 112-1˜112-M. Each RS frame encoder 112-1˜112-M performs randomization, RS-CRC encoding, and dividing, etc. regarding the input ensemble, and outputs the same to the output mux 113. The output mux 113 muxes the frame portions output from each RS frame encoder 112-1˜112-M and outputs the primary RS frame portion and secondary RS frame portion. In this case, only the primary RS frame portion may be output according to the setting state of the frame mode.

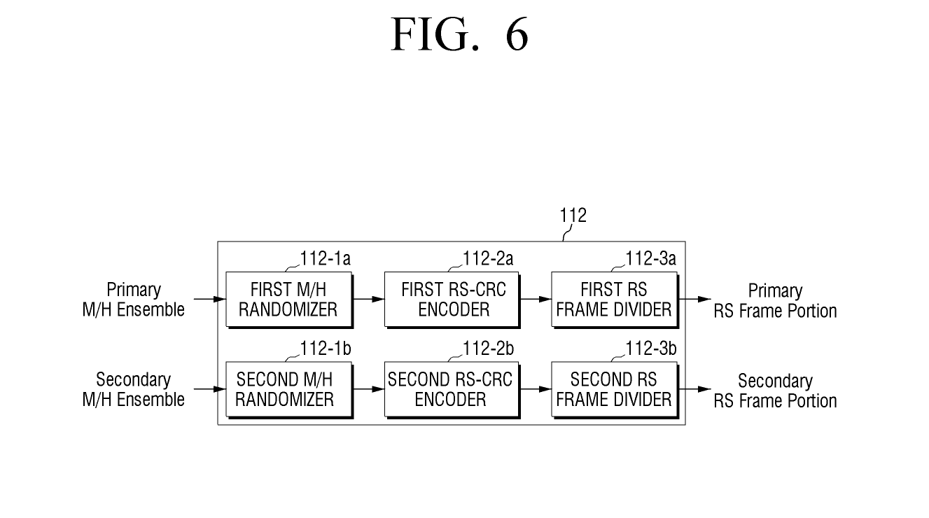

FIG. 6 is a block diagram illustrating an example of an RS frame encoder configuration which may be embodied in one of each of the RS frame encoders 112-1˜112-M. According to FIG. 6, the frame encoder 112 includes a plurality of M/H randomizers 112-1a, 112-1b, RS-CRC encoders 112-2a, 112-2b, and RS frame dividers 112-3a, 112-3b.

When the primary M/H ensemble and secondary M/H ensemble are input from the input demux 111, each M/H randomizer 112-1a, 112-1b performs randomization, and the RS-CRC encoders 112-2a, 112-2b RS-CRC encode the randomized data. The RS frame dividers 112-3a, 112-3b appropriately divide the data to be block coded and output the same to the output mux 113 so that the block processor 120 disposed in the rear end of the frame encoder 110 can be appropriately block coded. The output mux 113 appropriately combines and muxes each frame portion so that the block processor 120 can perform the block coding, and outputs the same to the block processor 120.

The block processor 120 codes the stream output from the frame encoder 110 in block units, that is, block codes the stream.

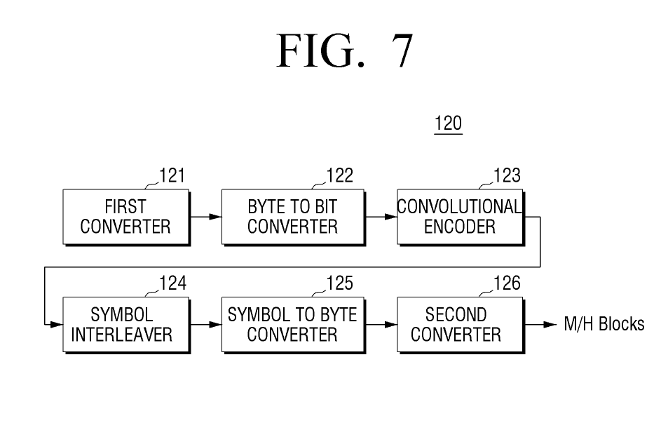

FIG. 7 is a block diagram illustrating an example of a configuration of a block processor 120.

According to FIG. 7, the block processor 120 includes a first converter 121, byte-to-bit converter 122, convolutional encoder 123, symbol interleaver 124, symbol-to-bite converter 125, and second converter 126.

The first converter 121 converts the RS frame input from the frame encoder in block units. That is, the first converter 121 combines the mobile data inside the RS frame according to the predetermined block mode, and outputs the SCCC (Serially Concatenated Convolutional Code) block.

For example, when the block mode is “00”, one M/H block becomes one SCCC block.

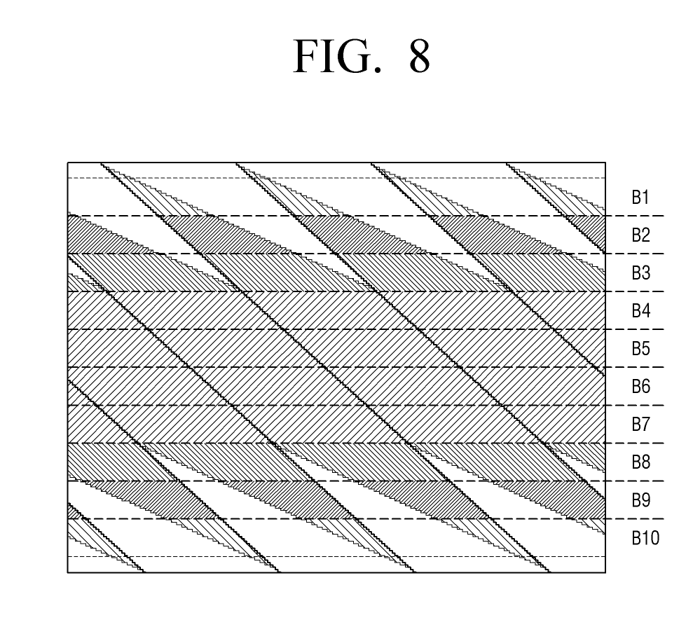

FIG. 8 is a view illustrating a state of an M/H block where mobile data is divided in block units. With reference to FIG. 8, one mobile data unit, for example an M/H group, may be divided into 10 blocks B1˜B10. When the block mode is “00”, each of the blocks B1˜B10 are output as an SCCC block. Meanwhile, when the block mode is “01”, two M/H blocks are combined as one SCCC block and are output. A combination pattern may be set in various ways. For example, B1 and B6 are combined as one to form SCB1, and B2 and B7, B3 and B8, B4 and B9, and B5 and B10 may be combined to form SCB2, SCB3, SCB4, and SCB5. The blocks may be combined in various ways and numbers according to other block modes as well.

The byte-to-bit converter 122 converts the SCCC block from a byte unit to bit unit. This is because the convolutional encoder 123 operates in bit units. Accordingly, the convolutional encoder 123 convolutional encodes the converted data.

Next, the symbol interleaver 124 performs symbol interleaving. A symbol interleaving may be performed in the same way as the block interleaving. The symbol interleaved data are converted into byte units by the symbol-to-byte converter 125, and then reconverted into M/H block units by the second converter 126, and are output.

The group formatter 130 receives the stream processed in the block processor 120 and formats the stream in group units. More specifically, the group formatter 130 puts the data output from the block processor 120 in an appropriate location inside the stream, and adds base data, signaling data, initial data, etc. Besides, the group formatter 130 also performs a function of adding normal data, MPEG-2 header, a place holder byte for non-systematic RS parity etc., and a dummy byte for adjusting the group format, etc.

Signaling data refers to various types of information used in processing a transport stream. Signaling data may be appropriately processed by a signaling encoder 150, and be provided to the group formatter.

In order to transmit mobile data, a Transmission Parameter Channel (TPC) and Fast Information Channel (FIC) may be used. TPC is for providing various parameters such as various FEC (Forward Error Correction) mode information and M/H frame information, etc., and FIC is for obtaining quick service of a receiver including crosslayer information between a physical hierarchy and superior hierarchy. When such TPC information and FIC information are provided to the signaling encoder 150, the signaling encoder 150 appropriately processes the provided information and provides the same as signaling data.

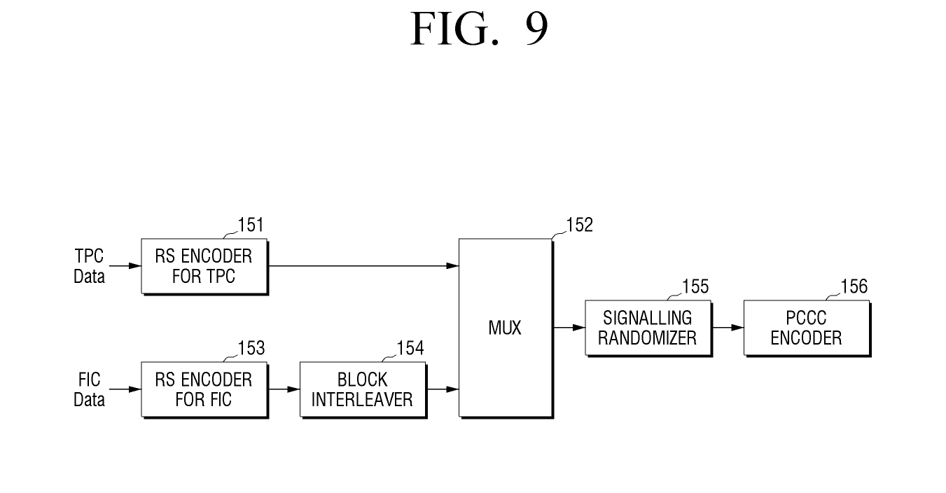

FIG. 9 is a block diagram illustrating an example of a configuration of a signaling encoder 150.

According to FIG. 9, the signaling encoder 150 includes an RS encoder for TPC use 151, mux 152, RS encoder for FIC use 153, block interleaver 154, signaling randomizer 155, and PCCC encoder 156. The RS encoder 151 for TPC use RS encodes the TPC data being input and forms a TPC code word. The RS encoder 153 for FIC use and block interleaver 154 RS encodes or block interleaves the data for FIC use being input and forms an FIC code word. The mux 152 disposes the FIC code word next to the TPC code word to form a sequence. The formed sequence is randomized in the signaling randomizer 155, PCCC (Parallel Concatenated Convolutional Code) coded by the PCCC encoder 156 and is output to the group formatter 130 as signaling data.

As aforementioned, base data refers to a sequence that both the digital broadcast transmitter and the digital broadcast receiver know. The group formatter 130 may insert base data in an appropriate location so that the base data may be disposed in an appropriate location on the stream after it is interleaved inside the exciter 400. For example, the group formatter 130 may insert base data in an appropriate location so that the base data can be disposed in the B area in the B) stream structure of FIG. 1. The group formatter 130 may determine the location where the base data is to be inserted considering an interleaving rule.

The initialization data refers to data which enables the trellis encoder 450 provided inside the exciter 400 to initialize the inner memories at an appropriate point. A more detailed explanation thereof will be made in the description of the exciter 400.

The group formatter 130 may include a group format configuration (not illustrated) which inserts various areas and signals inside the stream and forms the stream in a group format and a data deinterleaver which deinterleaves the stream formed in a group format.

The data interleaver rearranges the data disposed in the rear end of the stream received at the interleaver 430. The stream deinterleaved in the data deinterleaver may be provided to the packet formatter 140.

The packet formatter 140 may remove various place holders provided in the stream from the group formatter 130, and may add the MPEG header having PID which is a packet ID of the mobile data. Accordingly, the packet formatter 140 outputs a predetermined number of packet units of streams at every group. For example, the packet formatter 140 may output 118 TS packets.

As such, the data preprocessor 100 is embodied in various configurations, and forms mobile data in appropriate formats. Especially, in the case of providing a plurality of mobile services, each configurative element included in the data preprocessor may be embodied in plural numbers.

The mux 200 muxes the normal stream processed in the normal processor 320 and the stream for mobile use processed in the data preprocessor 100, and forms a transport stream. The transport stream output from the mux 200 may have a format including normal data and mobile data, and further, including base data for improving receiving quality.

The exciter 400 performs encoding, interleaving, trellis encoding, and modulation on the transport stream formed in the mux 200, and outputs the result. In some cases, the exciter 400 may be called a data postprocessor.

According to FIG. 4, the exciter 400 includes a randomizer 410, RS encoder 420, interleaver 430, parity replacer 440, trellis encoder 450, RS reencoder 460, sync mux 470, pilot inserter 480, 8-VSB modulator 490, and RF upconverter 495.

The randomizer 410 randomizes the transport stream output from the mux 200. The randomizer 410 may perform the same functions as the randomizer according to the ATSC standard.

The randomizer 410 may perform an XOR operation on the MPEG header of mobile data and the entire normal data with a PRBS (Pseudo Random Binary Sequence) of a maximum length of 16 bits, without performing an XOR operation regarding the payload byte of mobile data. However, in this case, the PRBS generator may continue shifting of the shift register. That is, the randomizer 410 bypasses regarding the payload byte of the mobile data.

The RS encoder 420 performs an RS encoding on the randomized stream.

More specifically, when a portion corresponding to the normal data is input, the RS encoder 420 performs a systematic RS encoding in the same method as the conventional ATSC system. That is, the RS encoder 420 adds a parity of 20 bytes to each end portion of the packets of 187 bytes. When a portion corresponding to the mobile data is input, the RS encoder 420 performs a non-systematic RS encoding. In this case, the RS FEC data of 20 bytes obtained through the non-systematic RS encoding is disposed in a predetermined parity byte location inside each mobile data packet. Accordingly, it is possible to have compatibility with a receiver of the conventional ATSC standard.

The interleaver 430 interleaves the stream encoded in the RS encoder 420. The interleaving may be performed in the same method as a conventional ATSC system. That is, the interleaver 430 may be embodied in a configuration where the interleaver 430 performs data writing and reading as the interleaver 430 sequentially selects a plurality of paths consisting of a different number of shift registers using a switch, and thus, interleaving is performed as many times as the number of shift registers on those paths.

The parity replacer 440 is a component which corrects a changed parity as memory initialization is performed at the trellis encoder 450 at the rear end.

That is, the trellis encoder 450 receives the interleaved stream and performs trellis encoding. Generally, 12 trellis encoders are used. Accordingly, a demux which divides the stream into 12 independent streams and inputs the divided stream into each trellis encoder, and a mux which combines the streams trellis encoded in each trellis encoder into one stream, may be used.

Each trellis encoder uses a plurality of internal memories to perform a trellis encoding in a method of performing logic operation on a newly input value and a value prestored in an inner memory.

As aforementioned, base data may be included in the transport stream. Base data is a known sequence that both the digital broadcast transmitter and the digital broadcast receiver commonly know, and the digital broadcast receiver may check the state of the received base data and determine the degree of error correction. As such, the base data must be transmitted in the state known by the receiver. However, since it is not possible to know the value stored in the internal memory provided inside the trellis encoder, there is a need to initialize the value to a particular value before the base data is input. Accordingly, the trellis encoder 450 performs memory initialization prior to the trellis encoding of the base data. A memory initialization is called a trellis reset.

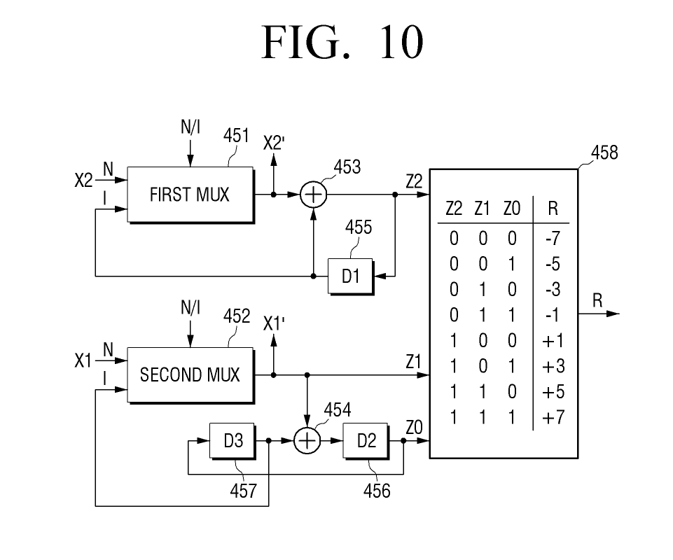

FIG. 10 illustrates an example of a configuration of components inside the trellis encoder 450.

According to FIG. 10, the trellis encoder includes first and second muxes 451, 452, first and second adders 453, 454, first to third memories 455, 456, 457, and a mapper 458.

The first mux 451 receives a value I stored in data N and first memory 455 inside the stream, and outputs a value, that is, N or I, according to the control signal N/I. More specifically, a control signal enabling I to be selected when a value corresponding to an initialization data section is applied, and the first mux 451 outputs I. In other sections, N is output. The second mux 452 also outputs I only when the value corresponds to the initialization data section.

Therefore, in the case of the first mux 451, when the value does not correspond to the initialization section, the interleaved value is directly output to the rear end, and the output value is input into the first adder 453 together with the value prestored in the first memory 455. The first adder 453 performs a logical operation, for example, logical exclusive OR on the input values, and outputs the result to Z2. At such a state, when a value corresponding to the initialization data section is applied, the value stored in the first memory 455 is selected by the first mux 451 and is output. Therefore, the same two values are input into the first adder 453, and thus, a logical operation value is always a fixed value. That is, when an exclusive logical operation is performed, 0 is output. The output value of the first adder 453 is input into the first memory 455 as it is, and thus the value of the first memory 455 is initialized to 0.

In the case of the second mux 452, at the initialization data section, the value stored in the third memory 457 is selected by the second mux 452 and is output. The output value is input into the second adder 454 together with a stored value of the third memory 457. The second adder 454 performs a logical operation on the same two input values, and outputs the result to the second memory 456. As aforementioned, since the input value of the second adder 454 is the same, the logical operation value for that same value, for example, when the second adder 454 performs a logical exclusive OR, 0 is input into the second memory 456. Accordingly, the second memory 456 is initialized. The value stored in the second memory 456 is shifted and is stored in the third memory 457. Therefore, when the next initialization data is input, the current value of the second memory 456, that is, 0, is input into the third memory 457, and the third memory 457 is initialized as well.

The mapper 458 receives the output value of the first adder 453, the output value of the second mux 452, and the output value of the second memory 457, maps the result to a symbol value R, and outputs the result. For example, when each of Z0, Z1, Z2 is output as 0, 1, 0, respectively, the mapper 458 outputs a −3 symbol.

Since the RS encoder 420 is located prior to the trellis encoder 450, the value input into the trellis encoder 450 is at a state where a parity has already been added. Therefore, as an initialization is performed and some of the data values are changed in the trellis encoder 450, the parity must be changed as well.

The RS re-encoder 460 uses the X1′, X2′ output from the trellis encoder 450, to change the value of the initialization data section and create a new parity. The RS re-encoder 460 may be referred to as a non-systematic RS encoder.

FIG. 10 illustrates an exemplary embodiment of initializing a memory value to 0, but the memory value may be initialized to a value other than 0.

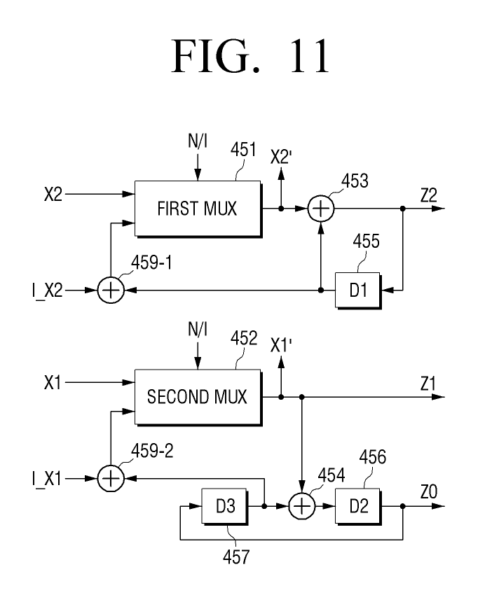

FIG. 11 is a view illustrating another exemplary embodiment of the trellis encoder.

According to FIG. 11, first and second muxes 451, 452, first to fourth adders 453, 454, 459-1, and 459-2, and first to third memories 455, 456, and 457 may be included. Illustration of the mapper 458 is omitted in FIG. 11.

Accordingly, the first mux 451 may output one of the stream input value X2 and the value of the third adder 459-1. In the third adder 459-1, I_X2 and the storage value of the first memory 455 is input. I_X2 refers to the memory reset value input from outside. For example, when it is intended to initialize the first memory 455 to 1, 1 is to be input as I_X2. When the storage value of the first memory 455 is 0, the output value of the third adder 459-1 becomes 1, and the first mux 451 outputs 1. Accordingly, the first adder 453 performs a logical exclusive OR on 1 which is the output value of the first mux 451 and the storage value 0 of the first memory 455 again, and stores the result value to the first memory 455. Consequently, the first memory 455 is initialized to 1.

At the initialization data section, the second mux 452 also selects the output value of the fourth adder 459-2 and outputs the output value. The fourth adder 459-2 also outputs the logical exclusive OR value of the memory reset value I_X1 input from outside and the third memory 457. 1 and 0 are stored in each of the second and third memories 456, 457, respectively, and for example, in a case of initializing the two memories to 1 and 1, respectively, first of all, 1 which is a logical exclusive OR value of 0 which is the value stored in the third memory 457 and 1 which is the I_X1 value is output from the second mux 452. In the second adder 454, a logical exclusive OR is performed on the output 1 with the 0 stored in the third memory 457, and the resulting value 1 is input into the second memory 456. The value 1 which used to be stored in the second memory 456 is shifted to the third memory 457, and the third memory 457 also becomes set to 1. At such a state, when 1 is input to the second I_X1 as well, a logical exclusive OR is performed with 1 which is the third memory 457 value, and the resulting value 0 is output from the second mux 452. When a logical exclusive OR is performed on 0 output from the second mux 452 and 1 which is the value stored in the third memory 457 by the second adder 454, the resulting value 1 is input into the second memory 456, and 1 which used to be stored in the second memory 456 is shifted to the third memory 457 and is stored. Consequently, the second and third memories 456, 457 may be initialized as 1.

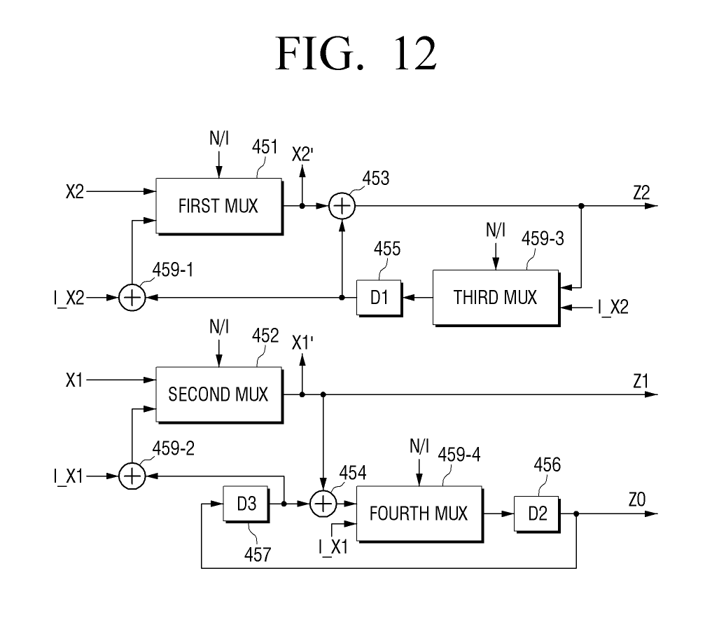

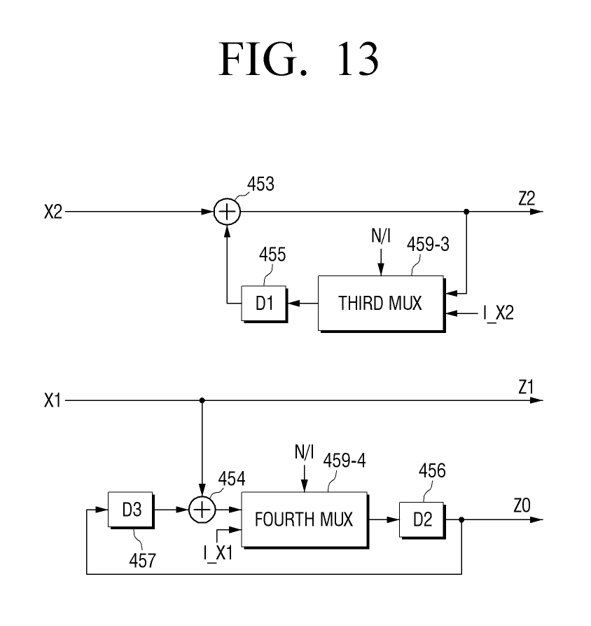

FIG. 12 and FIG. 13 are views illustrating various exemplary embodiments of a trellis encoder.

According to FIG. 12, a trellis encoder may be embodied in a format where the third and fourth muxes 459-3, 459-4 are further included in the structure of FIG. 11. The third and fourth muxes 459-3, 459-4 may output the output of the first and second adders 453, 454 or I_X2 and I_X1 values according to each control signal N/I. Accordingly, the values of the first to third memories 455, 456, 457 may be initialized to intended values.

FIG. 13 illustrates a case where a trellis encoder is embodied in a more simple structure. According to FIG. 13, the trellis encoder may include first and second adders 453, 454, first to third memories 455, 456, 457, and third and fourth muxes 459-3, 459-4. Accordingly, the first to third memories 455, 456, 457 may be initialized according to the I_X1, I_X2 input into each of the third and fourth muxes 459-3, 459-4. That is, according to

FIG. 13, 1_X2 and I_X1 may be directly input into the first memory 455 and second memory 456, and become the first memory 455 value and second memory 456 value.

A more detailed explanation on the operations of a trellis encoder of FIG. 12 and FIG. 13 are omitted.

With reference to FIG. 4 again, for a stream trellis encoded by a trellis encoder 450, a filed sync and segment sync, etc., are added in the sync mux 470.

As aforementioned, in the case where data preprocessor 100 disposes and uses data for mobile use regarding the packets allocated to the existing normal data as well, the data preprocessor 100 must notify the receiver that new data for mobile use exists. The fact that new data for mobile use exists may be notified in various ways, including a method of using a field sync. A detailed explanation thereof will be made hereinbelow.

The pilot insertor 480 inserts a pilot into the transport stream processed at the sync mux 470, and the 8-VSB modulator 490 performs modulation in the 8-VSB modulation method. FR upconverter 495 converts the modulated stream into a superior RF band signal for transmitting the modulated stream, and the converted signal is transmitted to an antenna.

As such, the transport stream may be transmitted while containing normal data, data for mobile use, and base data.

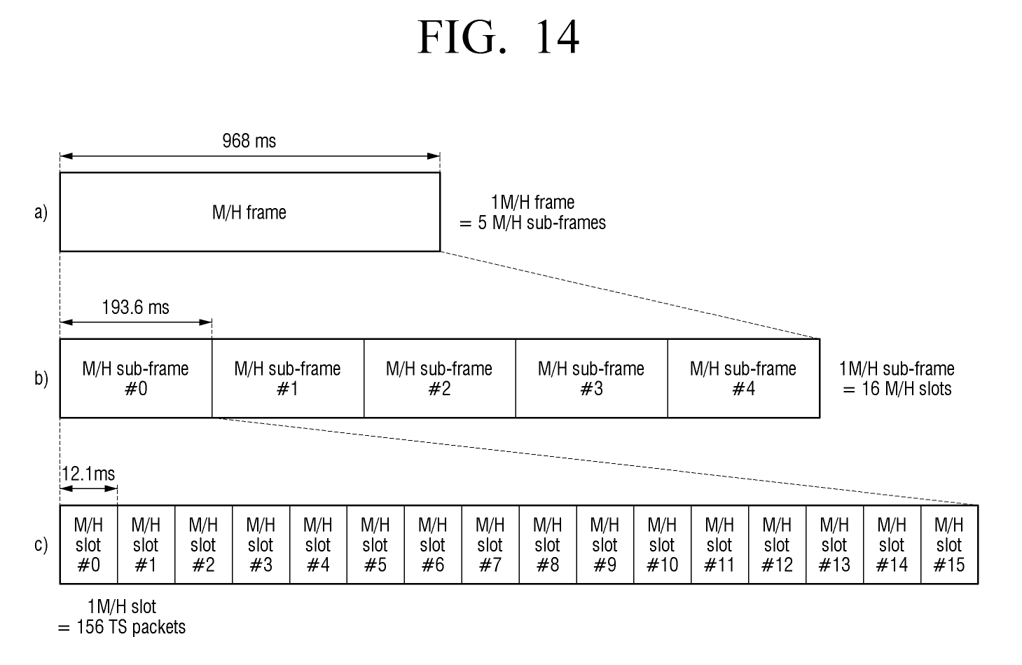

FIG. 14 is a view for explaining a data frame for mobile use of a transport stream, that is, a unit structure of M/H frame. According to a) of FIG. 14, one M/H frame may have a size of a total of 968 ms in time units, and as illustrated in b) of FIG. 14, one M/H may be divided into 5 sub frames. One sub frame may have a time unit of 193.6 ms. In addition, as illustrated in c) of FIG. 14, each sub frame may be divided into 16 slots. Each slot has a time unit of 12.1 ms, and may include a total of 156 transport stream packets. As aforementioned, 38 packets of the transport stream packets are allocated to normal data, and thus, a total of 118 packets are allocated to mobile data. That is, one M/H group consists of 118 packets.

At such a state, the data preprocessor 100 disposes mobile data and base data, etc., regarding the packets allocated to normal data as well, thereby increasing transmission efficiency of mobile data, and improving receiving performance.

[Various Exemplary Embodiments of the Changed Transport Stream]

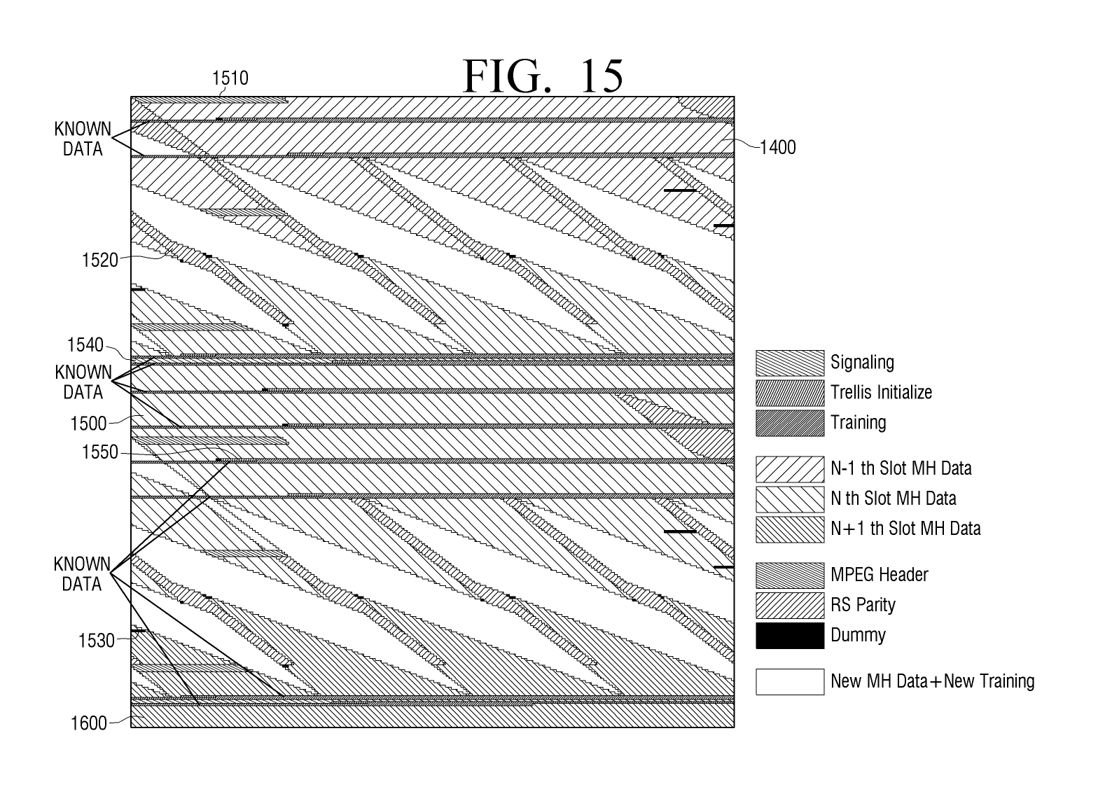

FIGS. 15 to 21 are views illustrating a transport stream configuration according to various exemplary embodiments.

FIG. 15 is the most simple changed structure of a stream configuration where interleaving is performed at a state where mobile data is disposed in the packets allocated to the existing normal data, that is, the second area. In the stream of FIG. 15, base data may be disposed together with mobile data at the second area.

Accordingly, in the existing ATSC-MH, it becomes possible to use the portion which had not been used for mobile use, that is, 38 packets, for mobile use as well. In addition, since the second area is used independently from the existing mobile data (that is, first area), it becomes able to provide one or more additional services. In the case of using new mobile data by the same service as the existing mobile data, it is possible to increase the data transmission efficiency.

In the case of transmitting new mobile data and base data as in FIG. 15, it is also possible to notify the receiver whether or not new data for mobile use and base data exist, location thereof, etc., using signaling data or field sync.

Disposition of mobile data and base data may be made by the data preprocessor 100. More specifically, the group formatter 130 inside the data preprocessor 100 may dispose the mobile data and base data regarding the 38 packets as well.

In FIG. 15, it can be seen that at the body area where existing mobile data is gathered, base data of a 6 long training sequence format is disposed. In addition, it can be seen that for the error robustness of the signaling data, the signaling data is disposed between the first and second long training sequence. On the other hand, at the packet portion allocated to the normal data, the base data may be disposed in a dispersed format and not a long training sequence format.

In addition, the hatching area indicated by reference numeral 1510 in FIG. 15 is the MPEG header portion, the hatching area indicated by 1520 is the RS parity area, the hatching area indicated by 1530 is the dummy area, the hatching area indicated by 1540 is signaling data, and the hatching area indicated by 1550 is initialization data. According to FIG. 15, it can be seen that the initialization data is disposed before the base data appears. Reference numeral 1400 indicates N−1th slot M/H data, reference numeral 1500 indicates the Nth slot M/H data, and reference numeral 1600 indicates the N+1th slot M/H data.

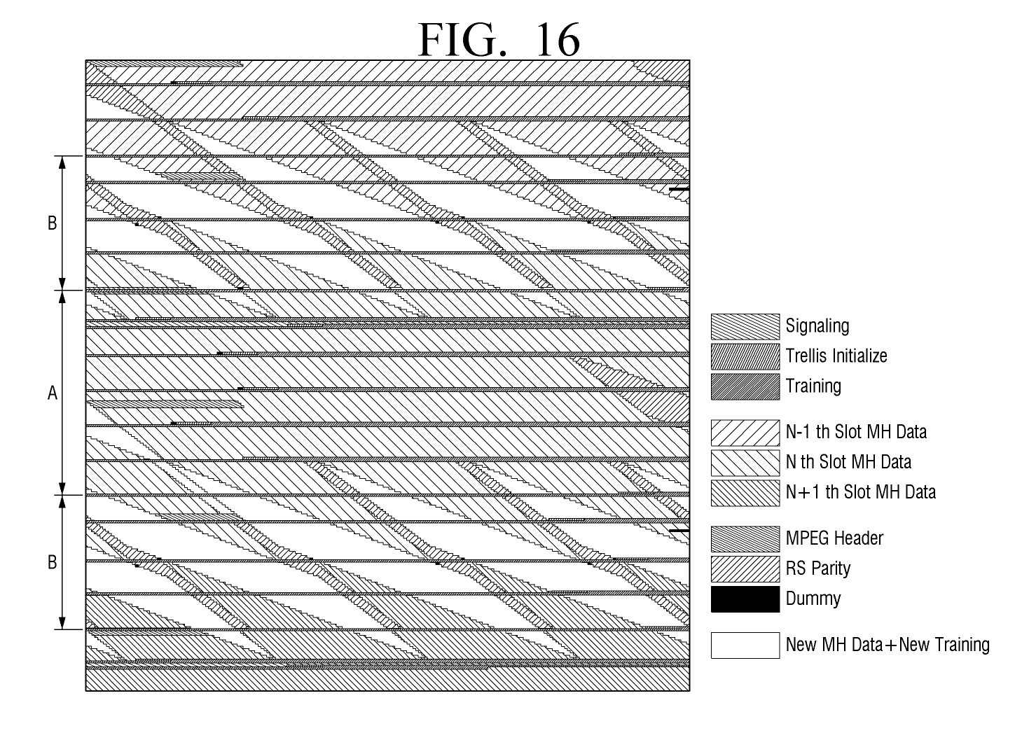

FIG. 16 is a transport stream structure for transmitting mobile data and base data using a portion of the first area allocated to the existing mobile data, together with the packets allocated to normal data, that is, the second area.

According to FIG. 16, in A area, which is the body area where existing mobile data is gathered, base data of a 6 long training sequence format is disposed. At the same time, base data is disposed in a long training sequence format in B area as well. For the base data to be disposed in a long training sequence format in B area, base data is included in not only 38 packet area but also in some packet portions among the 118 packets allocated to existing mobile data. In the remaining area of the 38 packets where base data is not included, new mobile data is disposed. Accordingly, it becomes possible to improve error correction performance regarding B area.

As base data is newly added to a portion of the area for existing mobile data, for compatibility with the existing mobile data receiver, it is possible to add information on the new base data location to the existing signaling data, or perform processing of the header of a packet for existing mobile use where base data is newly inserted in a format that the data receiver for existing mobile use cannot recognize, for example in a null packet format. Accordingly, the existing mobile data receiver does not recognize the newly added base data, and thus an error does not occur.

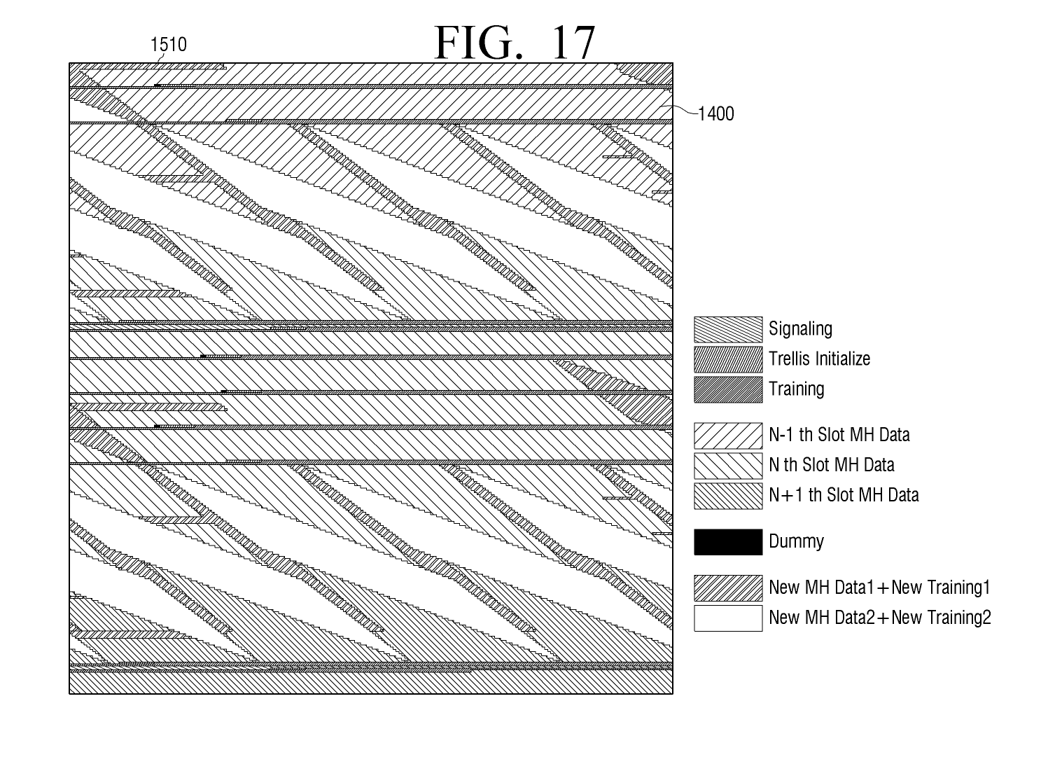

FIG. 17 is a stream configuration in a state where at least one of mobile data and base data is disposed in a location of the MPEG header, RS parity, at least a portion of the dummy, and existing MH data as well.

That is, in comparison with FIG. 15, in FIG. 17, new mobile data and new base data are formed in the MPEG header, RS parity, and a portion of the dummy. The mobile data inserted in these portions, and the data for mobile use inserted in the normal data packets, may be the same data or different data.

New mobile data may be disposed in the entire area including the existing mobile data area as well.

When the stream is formed as in FIG. 17, it is possible to increase the transmission efficiency of mobile data and base data compared to FIGS. 15 and 16. Especially, it is possible to provide a plurality of mobile data.

In the case of forming a stream as in FIG. 17, it is possible to use existing signaling data or field sync, to include new signaling data in the new mobile data area, and notify whether or not new mobile data is included.

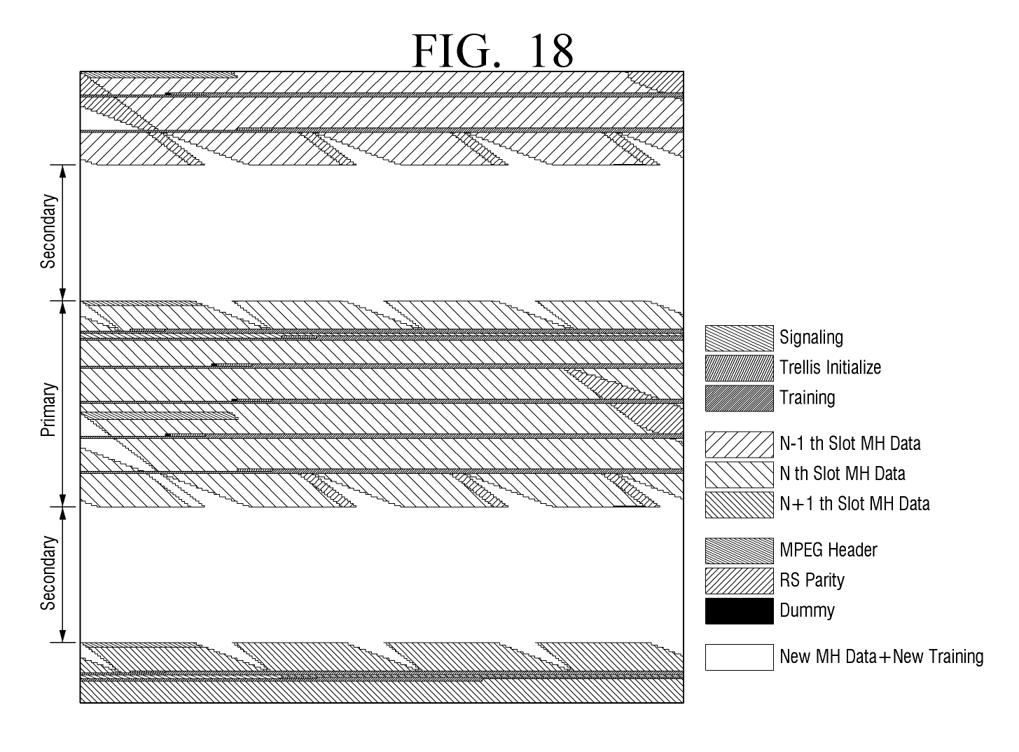

FIG. 18 illustrates a stream where new mobile data and base data is disposed in not only the second area but also in B area, that is, the first area corresponding to the secondary service area.

As illustrated in FIG. 18, the entire stream is divided into a primary service area and secondary service area, and the primary service area may be called a body area, and the secondary service area may be called a head/tail area. As aforementioned, the head/tail area does not include base data, but includes data of different slots, and thus, the performance deteriorates, and base data cannot be disposed in this portion together with new mobile data. Herein, base data may be disposed in, but is not limited to being disposed in, a long training sequence format just as the body area. Base data may be disposed in a dispersed format or in both a long training sequence and dispersed type sequence format.

As the existing mobile data portion is used as a new mobile data area, it is possible to configure the header of the packets where new mobile data or base data is included among the existing mobile data area in a header format not recognizable by the existing receiver, thereby maintaining compatibility with the receiver according to the existing ATSC-MH standard.

Otherwise, the existing signaling data or new signaling data may notify this fact.

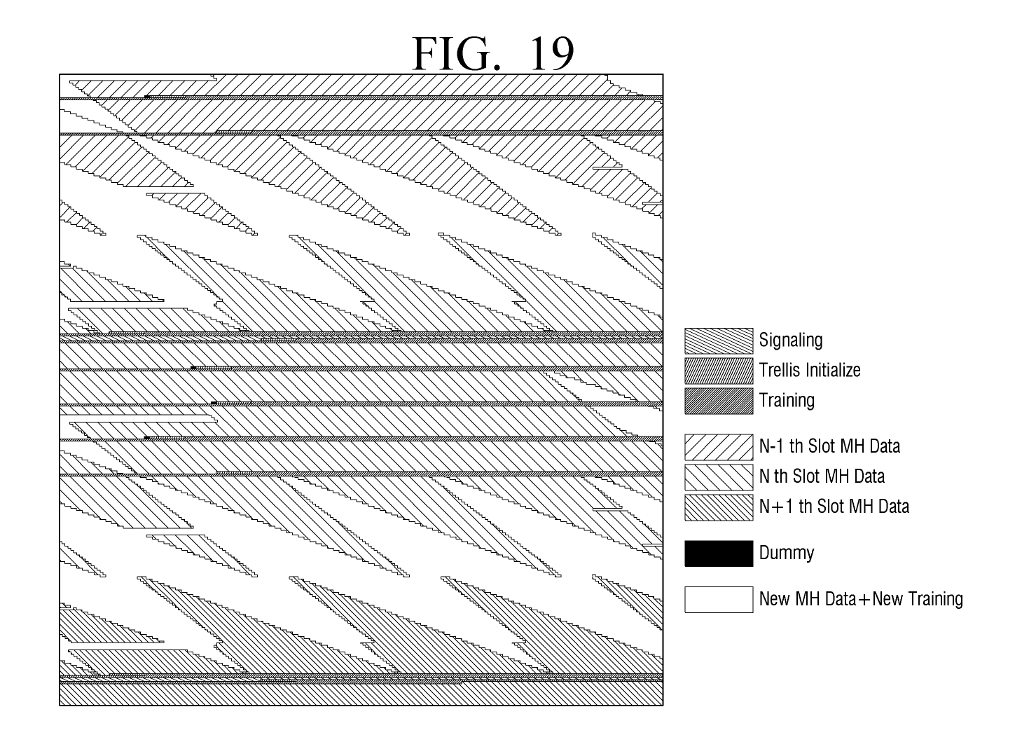

FIG. 19 illustrates an example of a transport stream for transmitting new mobile data and base data using all of the conventional normal data area, MPEG header, RS parity area, at least a portion of the dummy of the existing mobile data, etc. There is a difference between FIG. 17 and FIG. 19 in that FIG. 17 illustrates a case of transmitting new mobile data which is different from the new mobile data disposed in the normal data area, but FIG. 19 illustrates a case of transmitting new mobile data using all of the normal data area and the aforementioned areas.

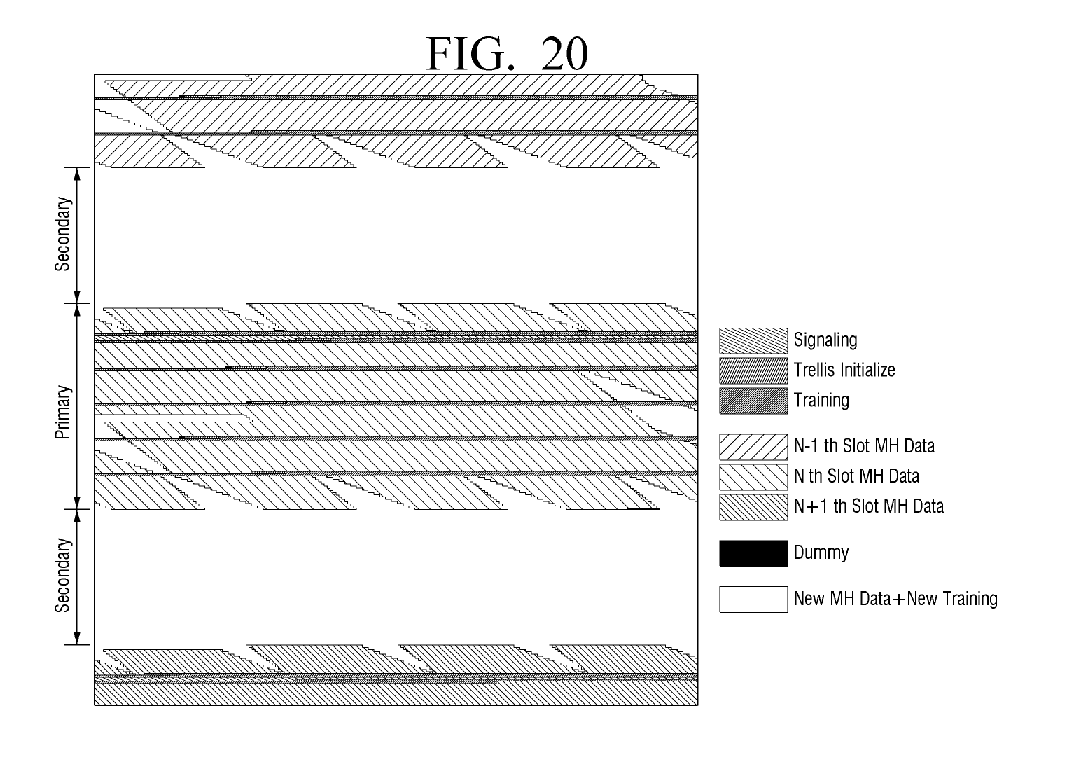

FIG. 20 illustrates an example of a transport stream in the case of transmitting new mobile data and base data using the entirety of B area, normal data area, MPEG header, RS parity area, and at least a portion of the dummy of the existing mobile data.

Similarly with the aforementioned case, it is desirable to make the portion where new mobile data and base data are included not recognizable for compatibility with the existing receiver.

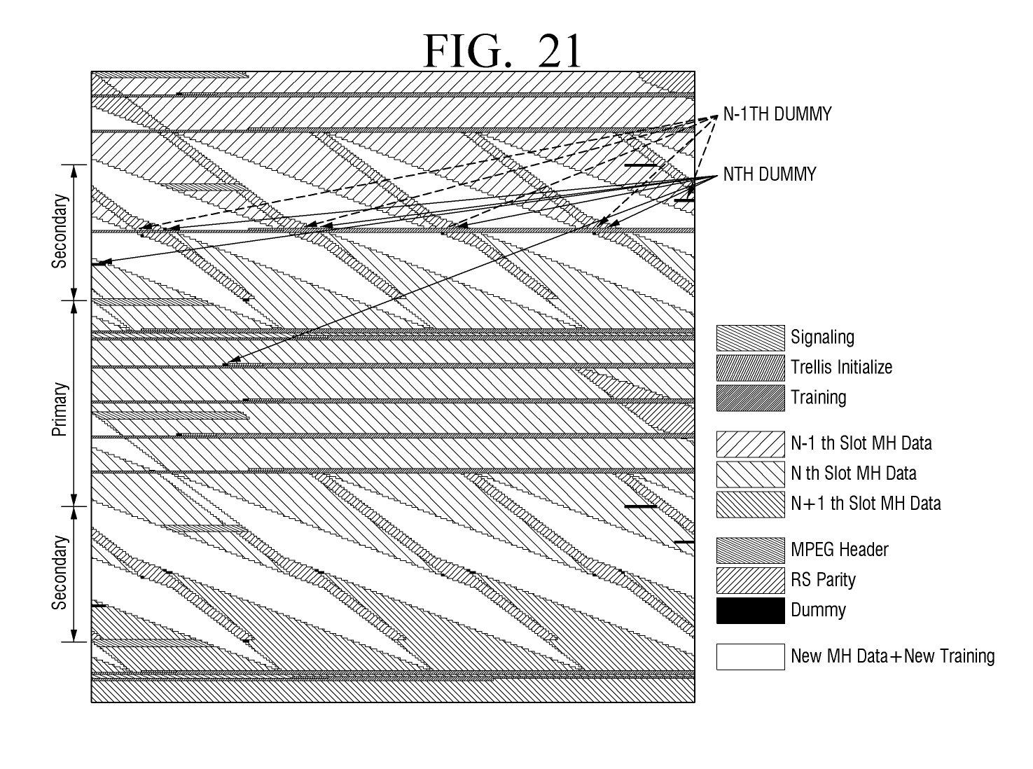

FIG. 21 illustrates a configuration of a transport stream where the dummy of the area used in the existing mobile data is replaced with a parity or a new mobile data area, and the replaced dummy and normal data area is used to dispose mobile data and base data. In FIG. 21, a dummy of N−1 slot and a dummy of N slot are illustrated.

As aforementioned, FIGS. 15 to 21 illustrate a stream configuration after interleaving. The data preprocessor 100 disposes mobile data and base data in an appropriate location so as to form a stream configuration as in FIGS. 15 to 21 after interleaving.

More specifically, the data preprocessor 100 disposes the normal data area, that is mobile data packets inside the 38 packets according to a predetermined pattern, on the stream configuration as in a) of FIG. 1. In this case, the mobile data may be disposed in the entirety of the pay load of the packets or in a portion inside the packets. In addition, the mobile data may be disposed not only in the normal data area but also in the area disposed in the location corresponding to the head or tail after interleaving among the existing mobile area.

The base data may be disposed inside each mobile data packet or normal data packet. In this case, in A) of FIG. 1, the base data may be disposed sequentially in a vertical direction or by a certain distance so that that base data after interleaving can have a format of a long training sequence or a similar long training sequence heading in a horizontal direction.

In addition, the base data may be disposed in a dispersed format besides the aforementioned long training sequence. Hereinbelow is an explanation on various examples of a disposition format of base data.

[Disposition of Base Data]

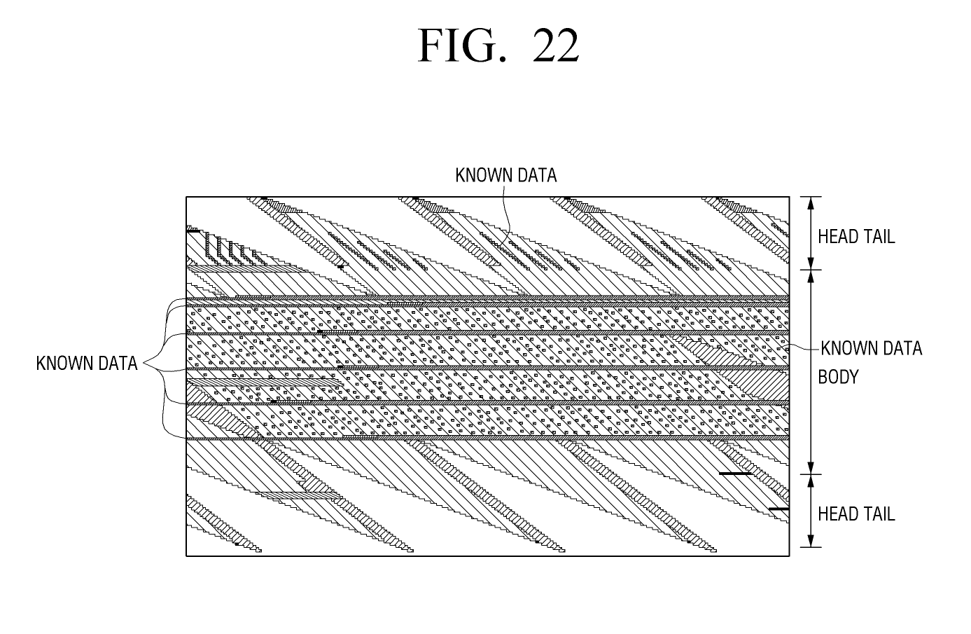

As aforementioned, base data is disposed in an appropriate location by the group formatter 130 inside the data preprocessor 100, and is then interleaved together with the stream by the interleaver 430 inside the exciter 400. FIGS. 22 to 28 are views for explaining a base data disposition method according to various exemplary embodiments.

FIG. 22 illustrates a state where base data is additionally disposed in the cone shape portion inside the head/tail area as the dispersed type base data is disposed together with the existing long training sequence in the body portion. As such, as base data is newly added while maintaining conventional base data, it becomes possible to improve the sync and channel assumption performance and equalization function of the receiver.

The disposition of base data as illustrated in FIG. 22 is performed by the group formatter 130 as aforementioned. The group formatter 130 may determine the location where the base data will be inserted considering the interleaving rule of the interleaver 430. The interleaving rule may differ according to various exemplary embodiments, but when an interleaving rule is known, the group formatter 130 may appropriately determine the base data location. For example, when base data is inserted in certain sizes in a portion of the pay load per 4 packets or in a separately provided field, it is possible to obtain base data disposed in a certain pattern by the interleaving.

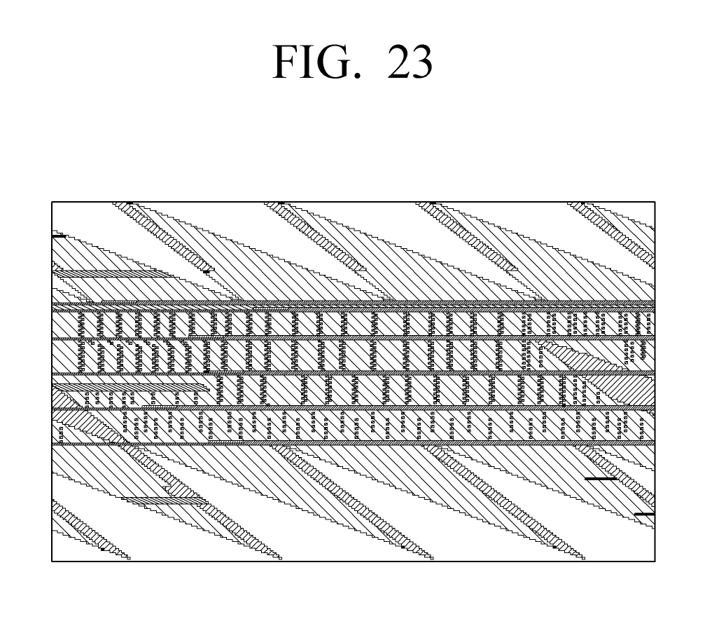

FIG. 23 is a stream configuration illustrating another example of a method for inserting base data.

According to FIG. 23, it can be seen that dispersed base data of the cone area is not disposed, but the disposed base data is disposed together with the long training sequence only in the body area.

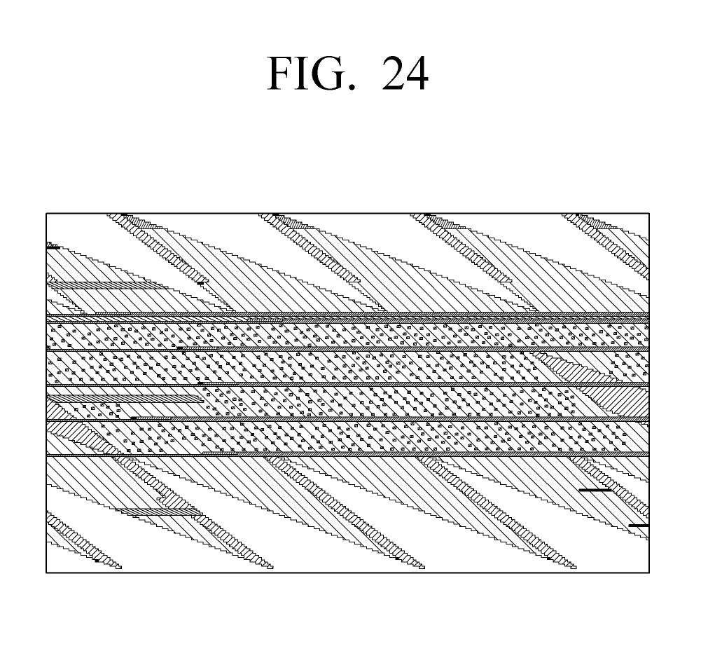

Next, FIG. 24 is a configuration of a stream where the length of the long training sequence is reduced as compared to the stream shown in FIG. 23 while the dispersed base data is disposed in a number as many as the reduced number. Accordingly, the data efficiency is kept the same, while improving the Doppler tracking performance.

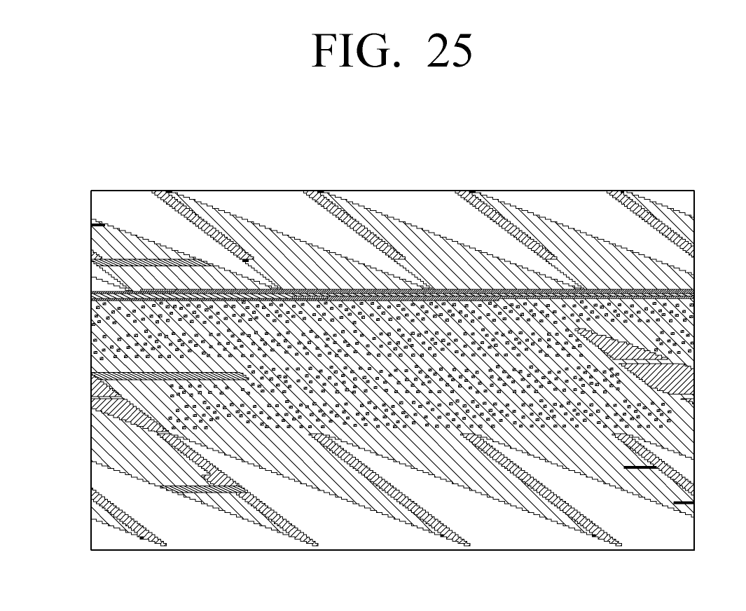

FIG. 25 is a stream configuration of another method of inserting base data.

According to FIG. 25, among the total 6 long training sequences inside the body area, only the first sequence is maintained, while the rest are replaced by dispersed base data. Accordingly, it becomes possible to maintain the initial sync and channel performance by the first long training sequence where the body area starts while improving the Doppler tracking performance.

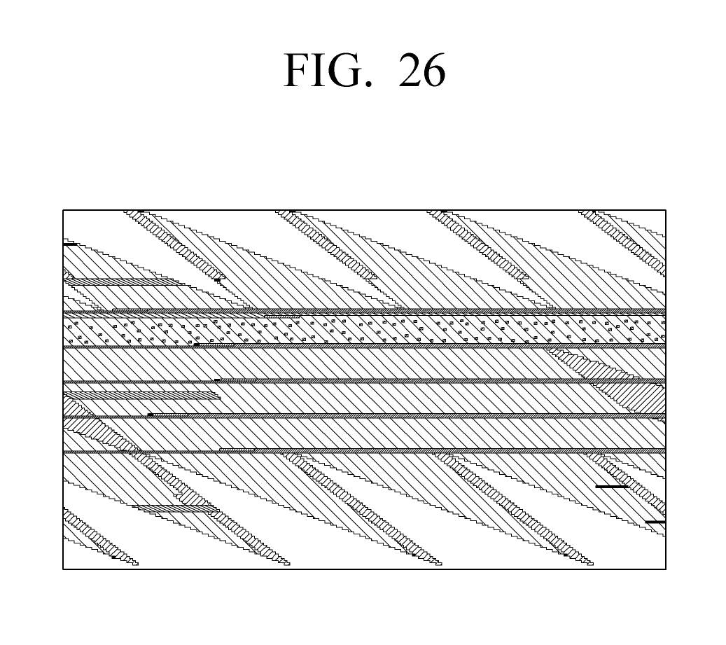

FIG. 26 is a stream configuration of an example of another method of inserting base data. According to FIG. 26, among the total 6 long training sequences, the second sequence is replaced by dispersed base data.

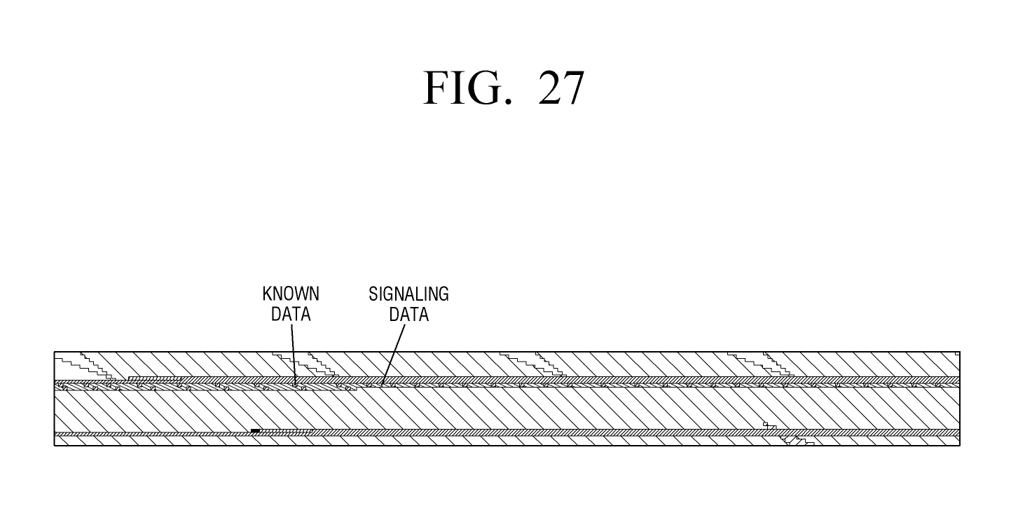

FIG. 27 illustrates a case where the replaced base data of the stream configuration of FIG. 26 and signaling data are alternately disposed.

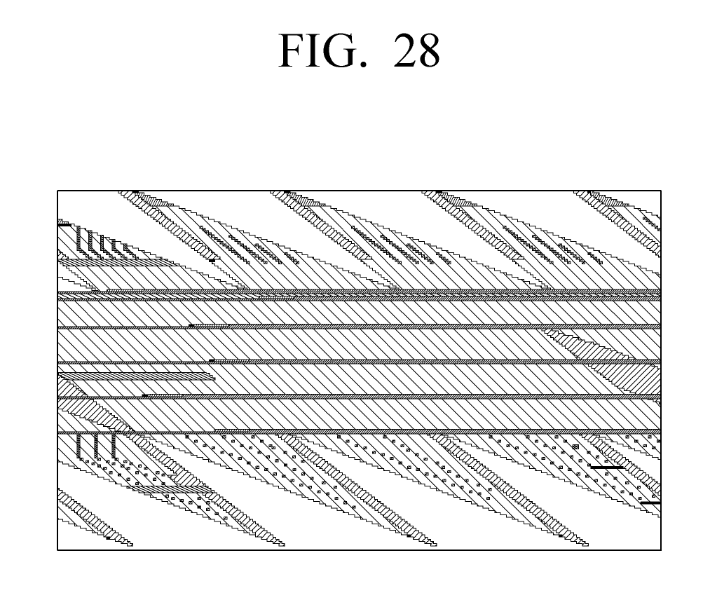

FIG. 28 illustrates a stream configuration where dispersed base data is added in not only the head area but also in the tail area.

As such, base data may be disposed in various formats.

In the case of newly allocating mobile data to the packets where normal data is allocated, the allocated pattern may be changed in various ways. Hereinbelow, a configuration of a transport stream containing mobile data disposed in various ways according to modes is described.

[Disposition of Mobile Data]

The data preprocessor 100 checks the setting state of a frame mode. The frame mode may be provided in various ways. For example, there may be provided a first frame mode for using the packets allocated to normal data and using only the packets allocated to existing mobile data as mobile data, and a second frame mode for using at least a portion of the packets allocated to normal data as mobile data. Such a frame mode may be set considering the intentions of the digital broadcast transmitting operator and transceiving environment.

When it is determined that a first frame mode is set for disposing normal data in the entirety of the packets allocated to normal data, the data preprocessor 100 disposes mobile data only in the packets allocated to mobile data in the conventional ATSC-MH method.

On the other hand, when it is determined that a second frame mode is set, the data preprocessor 100 determines the setting state of the mode again. A mode refers to a setting made regarding which pattern the mobile data is to be disposed in and how many packets in the packets allocated to the normal data are in the second area. Various modes may be provided according to the exemplary embodiments.

More specifically, a mode may be set as one of a mode of disposing mobile data only in a portion of the entirety of packets allocated to normal data, a mode of disposing mobile data in the entirety of the packets allocated to normal data, and an incompatibility mode of disposing mobile data so far as the RS parity area and header area provided for compatibility with the receiver for receiving normal data while disposing mobile data in the entirety of packets allocated to normal data. In this case, a mode of disposing mobile data regarding only a portion of the entirety of packets may be set differently depending on whether or not it is a mode that utilizes the entirety of the pay load area for mobile data, or a mode that utilizes only a portion of the pay load area for the mobile data.

More specifically, in the case where the packets corresponding to the second area allocated to normal data are 38 packets, the following modes may be set:

1) a first mode disposing new mobile data in a total of 11 packets among the 38 packets allocated to normal data,

2) a second mode disposing new mobile data in a total of 20 packets among the 38 packets allocated to normal data,

3) a third mode disposing new mobile data in a total of 29 packets among the 38 packets allocated to normal data,

4) a fourth mode disposing new mobile data in the entirety of the 38 packets allocated to the normal data, and

5) a fifth mode of disposing new mobile data in the entirety of the 38 packets allocated to normal data, and an area corresponding to the MPEG header and parity among the areas allocated to existing mobile data.

As aforementioned, the fifth mode may be referred to as an incompatibility mode, and the first to fourth modes may be referred to as compatibility modes, and the type of compatibility mode and the number of packets in each mode may be changed in various ways.

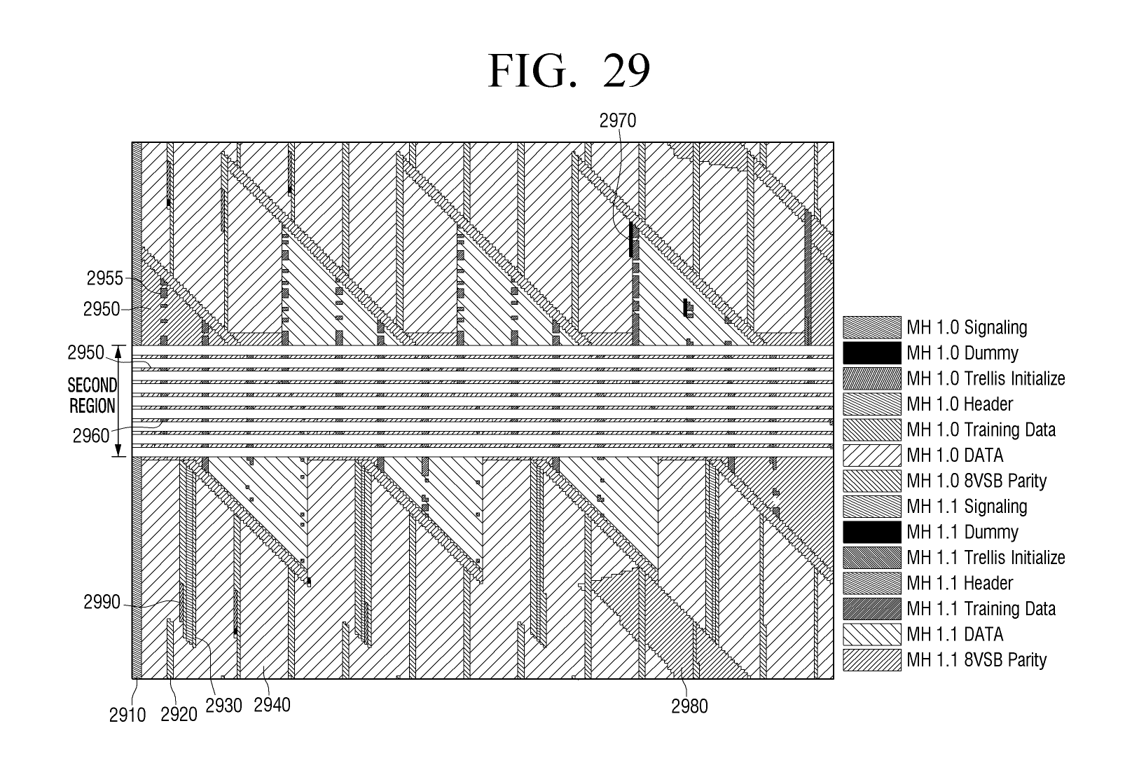

FIG. 29 is a stream configuration of a state where the group formatter 130 disposed mobile data and base data according to the first mode in an exemplary embodiment of transmitting new mobile data using a second area and head/tail area.

According to FIG. 29, it can be seen that new mobile data 2950 and base data 2960 are disposed in a predetermined pattern inside the second area, and that new mobile data and base data are disposed in the portion 2950 corresponding to the head/tail area as well besides the second area.

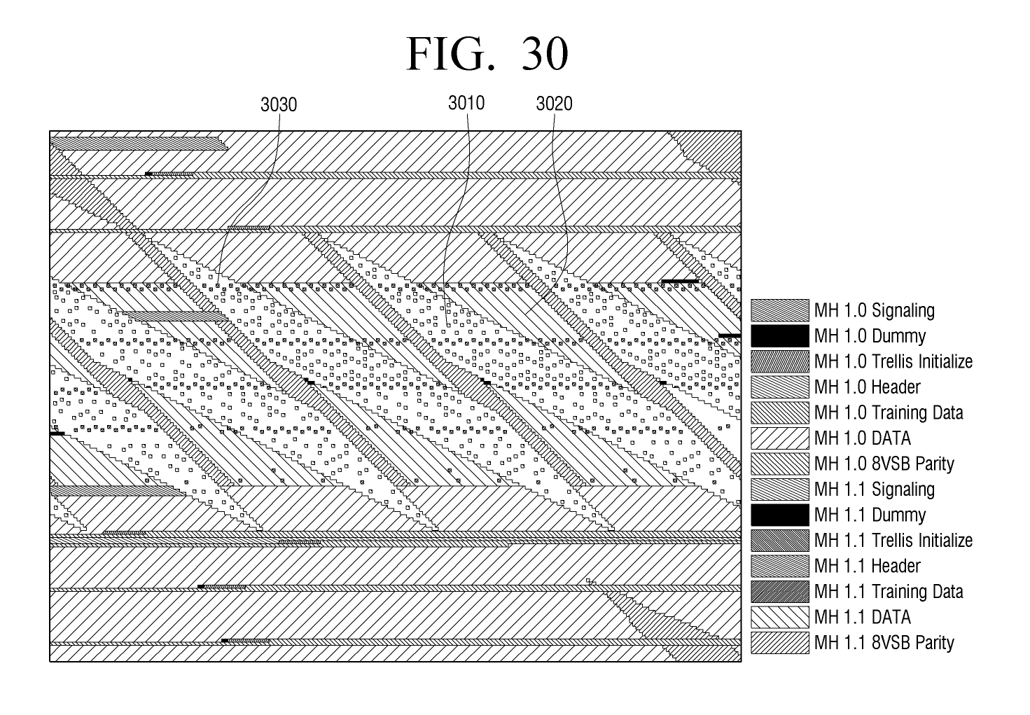

In addition, it can be seen that the MPEG header 2910, base data 2920, signaling data 2930, existing mobile data 2940, and dummy 2970, etc., are disposed in a vertical direction on the stream. When the empty space inside the second area is filled with normal data and then encoding and interleaving are performed, a stream configuration shown in FIG. 30 is created.

FIG. 30 is a stream configuration after interleaving at mode 1.

According to FIG. 30, new mobile data 3010 and base data 3030 are disposed in a portion of the packet area which used to be allocated to normal data. Especially, base data is discontinuously listed inside the second area, thereby forming a long training sequence similar to the long training sequence of the body area.

In FIG. 29, the mobile data 3020 which used to be disposed in the head/tail area corresponds to the mobile data 3020 disposed in the head/tail area in FIG. 30, and base data 2955 which used to be disposed together with the mobile data 2950 forms base data 3030 of a similar long training sequence format together with the base data inside the second area in FIG. 30.

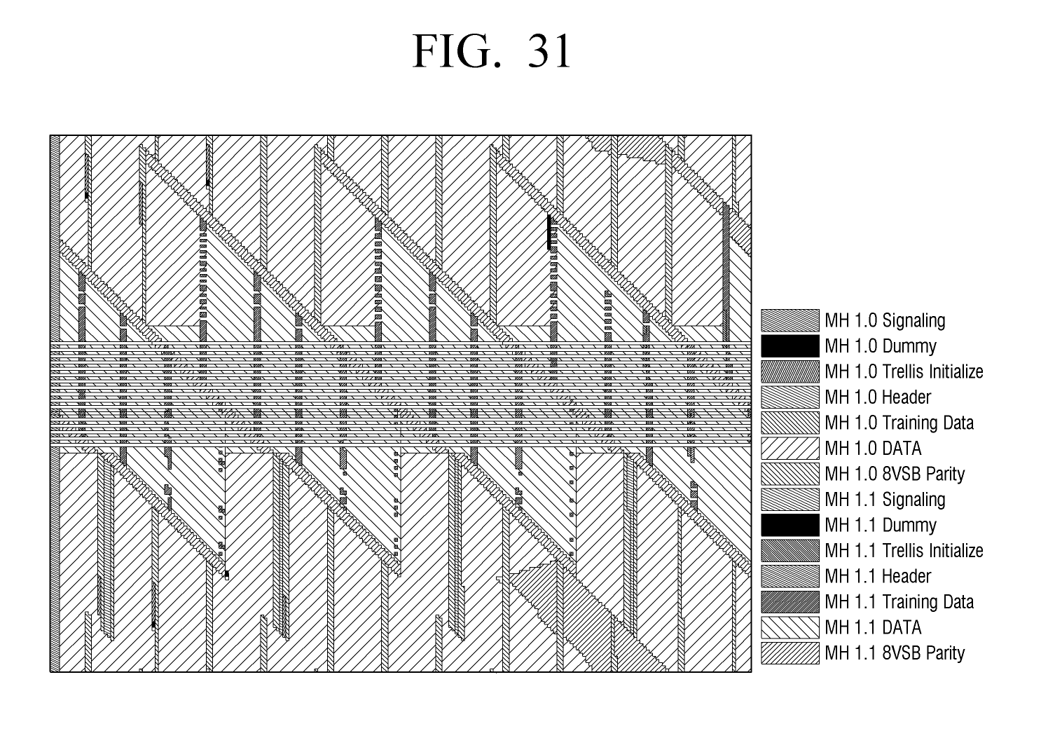

FIG. 31 is a stream configuration of a state where the group formatter 130 disposes mobile data and base data according to the second mode in an exemplary embodiment of transmitting new mobile data using the second area and head/tail area.

FIG. 31 illustrates a state where the ratio of mobile data included in the second area has increased compared to FIG. 29. Compared to FIG. 29, it can be seen that in FIG. 31, the portion where mobile data and base data accounts for has increased.

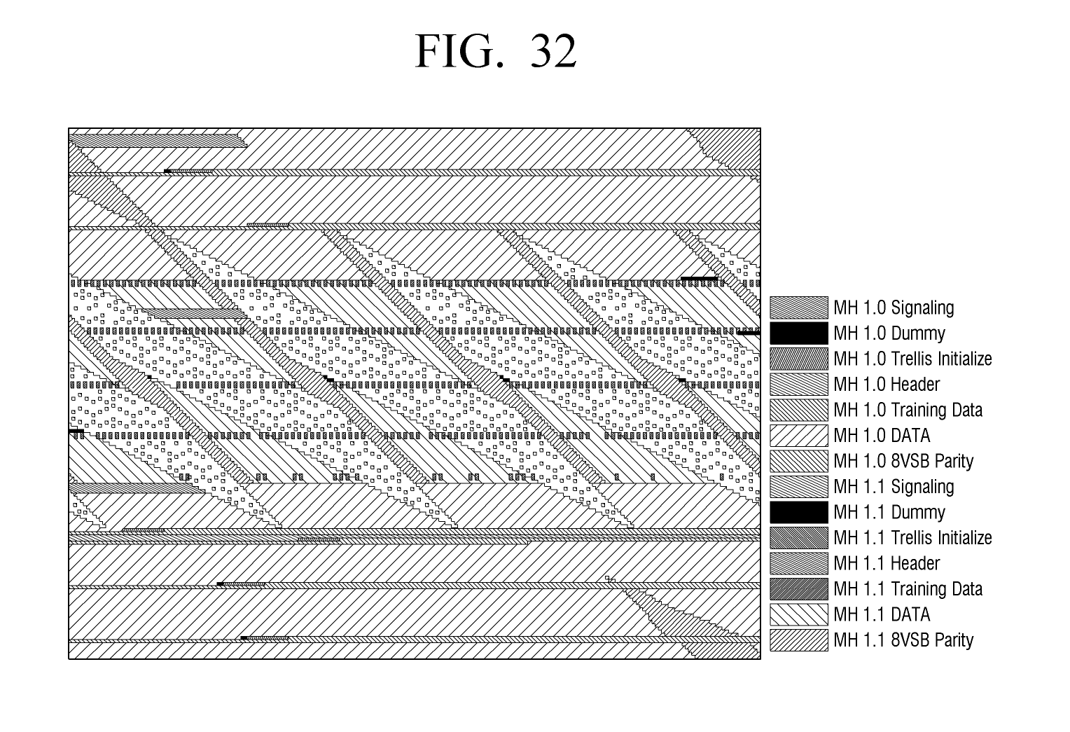

FIG. 32 is a state where the stream of FIG. 31 is interleaved. According to FIG. 32, the base data inside the second area forms a similar long training sequence more finely than the base data inside the second area of FIG. 30.

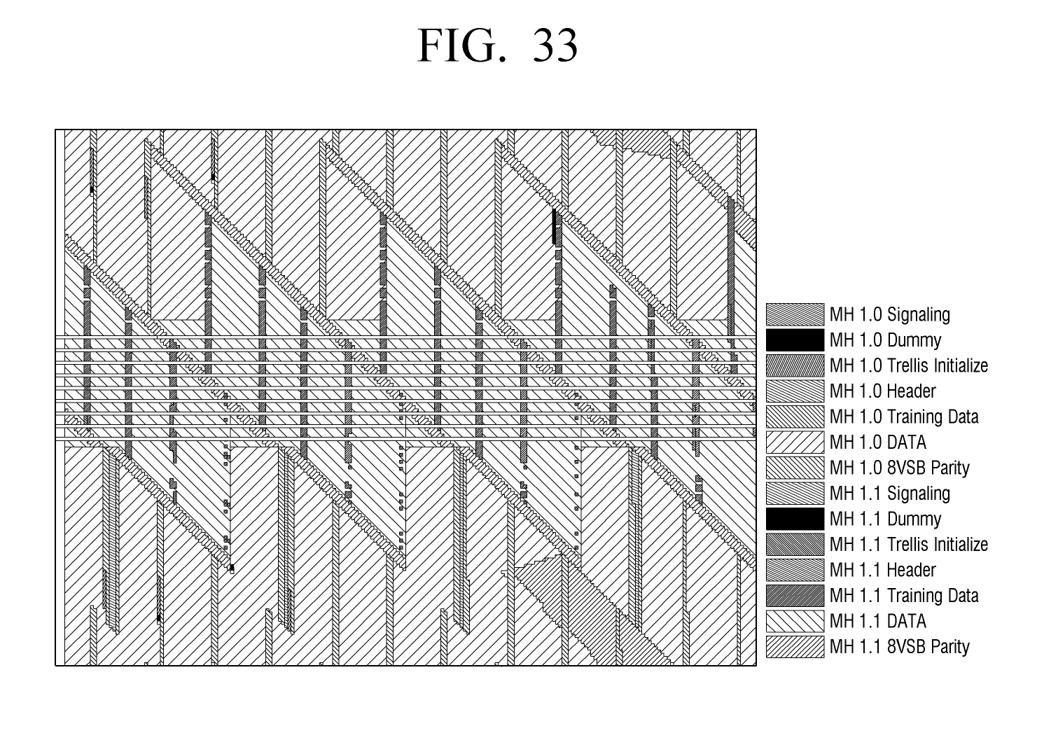

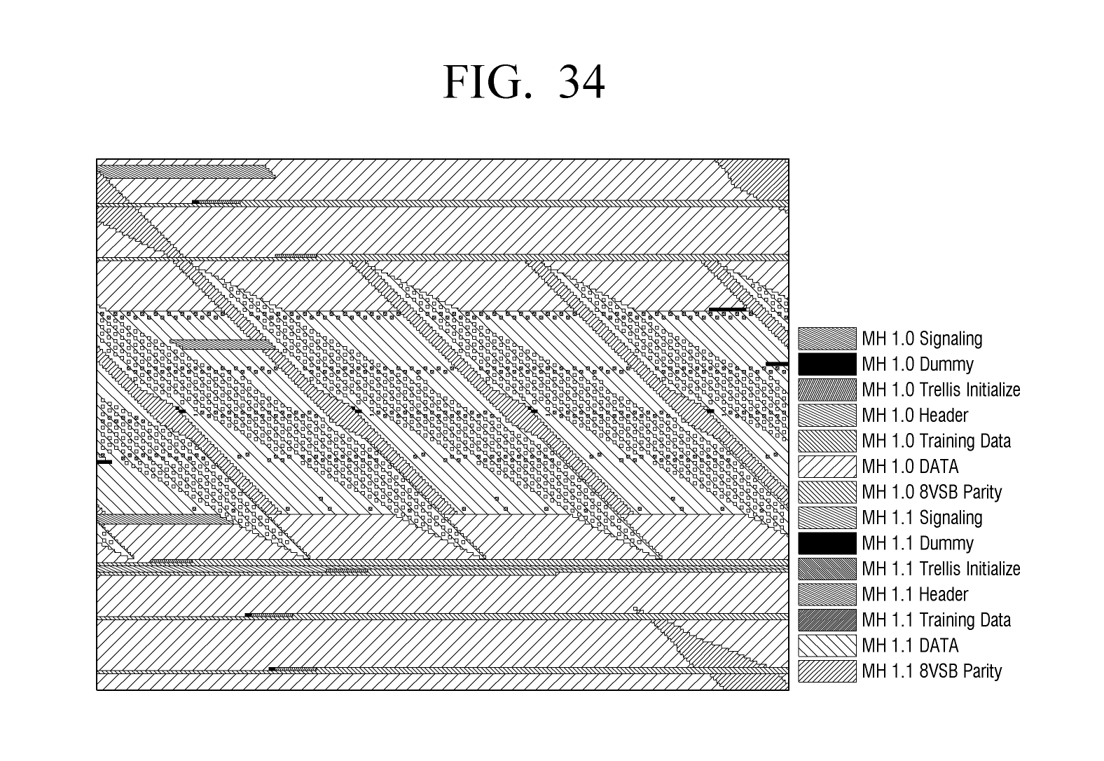

FIG. 33 is a stream configuration of a state where the group formatter 130 disposed mobile data and base data according to a third mode in an exemplary embodiment of transmitting new mobile data using the second area and head/tail area. In addition, FIG. 34 is a state where the stream of FIG. 34 is interleaved.

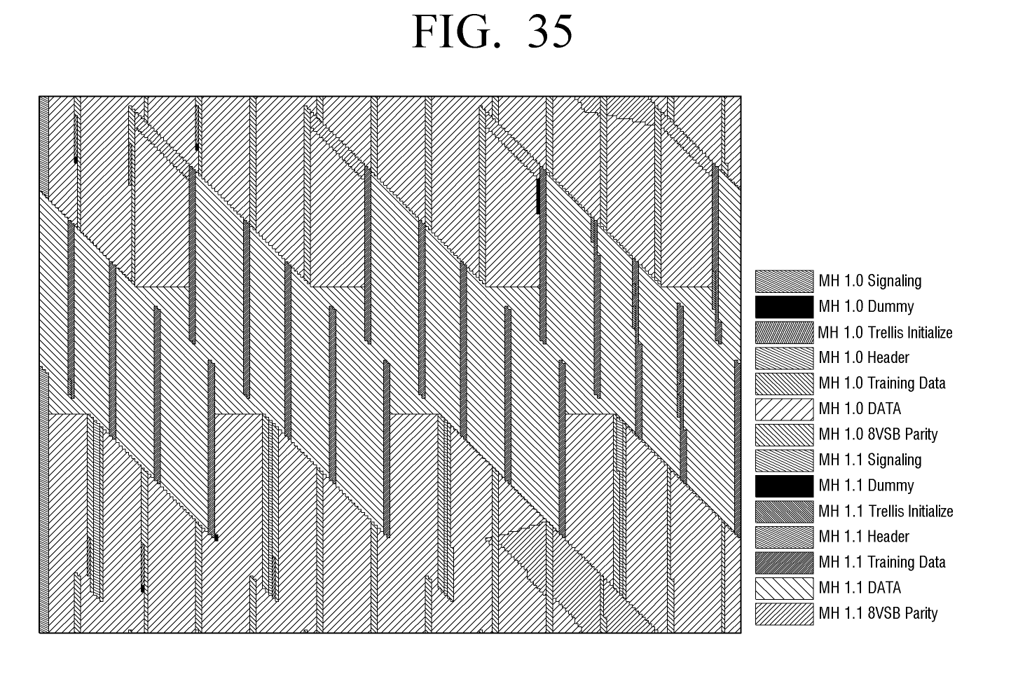

FIG. 35 is a stream configuration according to a fourth mode using the entirety of a normal data area in an exemplary embodiment capable of using the entirety of packets allocated to normal data and all the packet areas allocated to existing mobile data corresponding to the head/tail area.

According to FIG. 35, in the second area and the surrounding area thereof, base data is disposed in a vertical direction, and the remaining portion is filled with new mobile data.

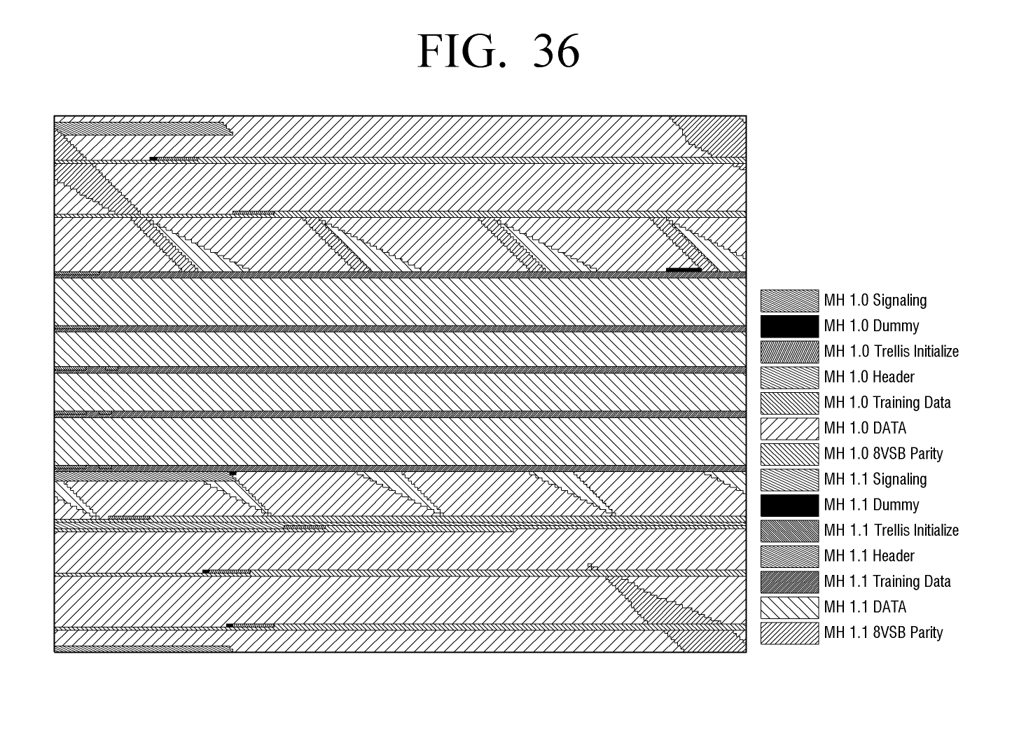

FIG. 36 illustrates a state where the stream of FIG. 35 is interleaved. According to FIG. 36, the entirety of the head/tail area and the normal data area is filled with new mobile data and base data, and especially, the base data is disposed in a long training sequence format.

In these areas, the base data may be inserted little by little repeatedly in a plurality of pattern periods, and thus, may become dispersed type base data after interleaving.

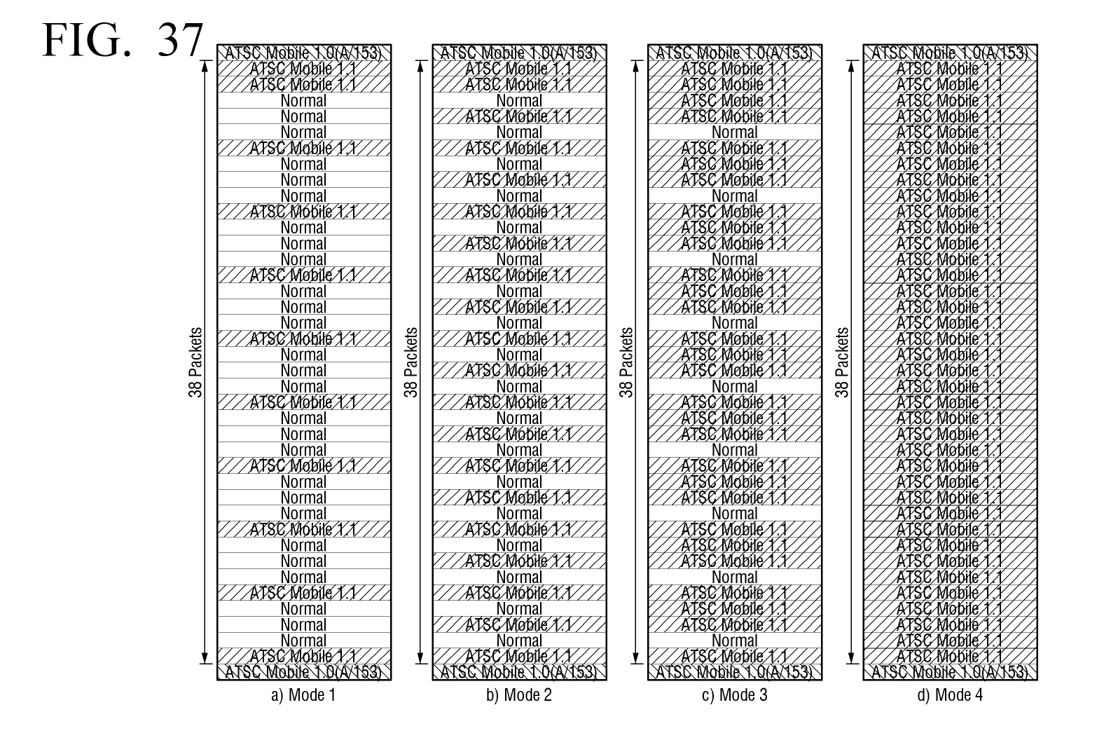

FIG. 37 is a view for explaining a method of inserting new mobile data into the packets allocated to the second area, that is, packets allocated to normal data (for example, 38 packets), in various modes. Hereinbelow, for convenience of explanation, new mobile data is called ATSC mobile 1.1 data (or 1.1 version data), and existing mobile data is called ATSC mobile 1.0 data (or 1.0 version data).

First of all, in the case of a) of FIG. 37 (first mode), at a state where 1.1 version data is disposed one by one in the first and final packet, one 1.1 packet and three normal data packets may be inserted such that they are repeatedly disposed regarding the packets therebetween. Accordingly, a total of 11 packets may be used to transmit 1.1 version data, that is, new mobile data.

Next, in the case of b) of FIG. 37 (second mode), in the same manner as above, 1.1 version data may be disposed in each first and final packet as aforementioned, and one 1.1 packet and one normal data packet may be inserted such that they are alternately and repeatedly disposed in the packets between each first and final packet.

Accordingly, 20 packets may be used in transmitting 1.1 version data, that is new mobile data.

Next, in the case of c) of FIG. 37 (third mode), in the same manner as above, 1.1 version data may be disposed in each first and final packet, and three 1.1 packets and one normal data packet may be inserted such that they are repeatedly disposed in the packets between each first and final packet.

Next, in the case of d) of FIG. 37 (fourth mode), all packets corresponding to the second area may be used in transmitting 1.1 version data.

Herein, the fourth mode may be embodied in a compatibility mode of using all packets corresponding to the second area in transmitting 1.1 version data or in an incompatibility mode where not only all packets corresponding to the second area but also the MPEG header and parity area provided for compatibility with the receiver for normal data use are filled with 1.1 version data. Otherwise, the incompatibility mode may be provided as a separate fifth mode.

In the aforementioned classification of modes, it has been explained that the cases where 1/4, 2/4, 3/4, and 4/4 of the packets among the entire packets of the second area which are used in mobile data transmission may correspond to each of the first to fourth modes, but as in FIG. 37, since the total number of packets is 38, which is not a multiple number of 4, it is possible to fix some of the packets for transmission of new mobile data or normal data, and classify the modes by classifying the remaining packets in the above ratios. That is, according to a), b), and c) of FIG. 37, 1.1 data may be included in 1/4, 2/4, and 3/4 ratios regarding the remaining 36 packets besides the number of predetermined packets among 38 packets.

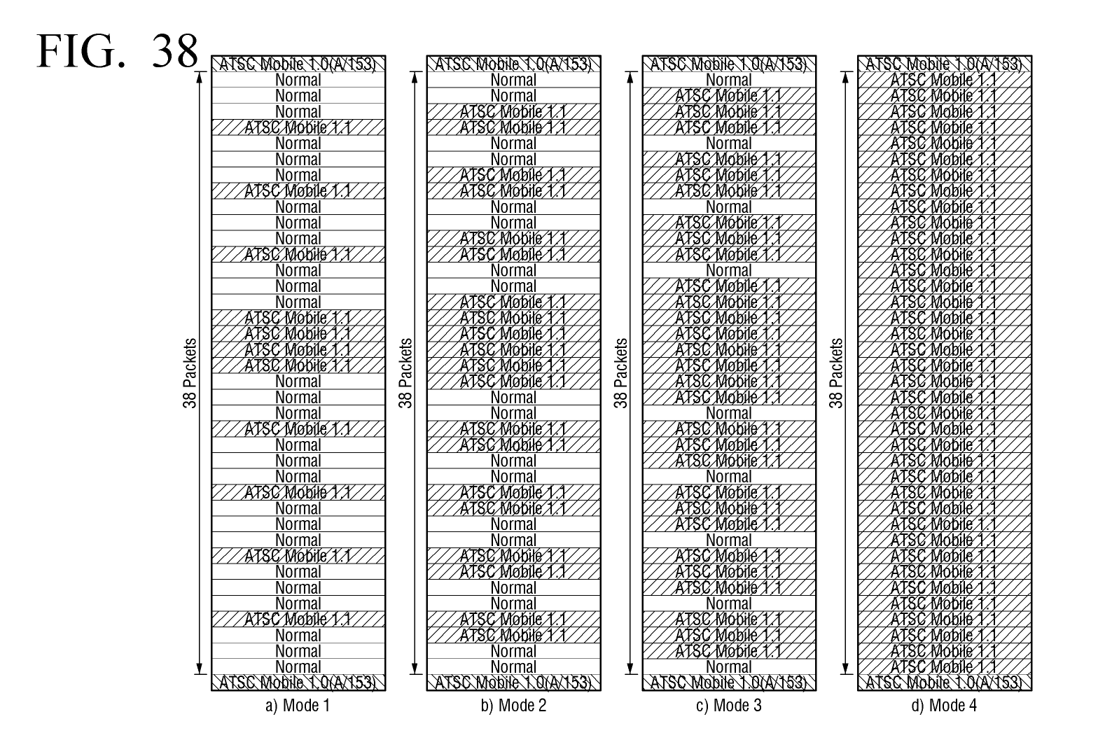

FIG. 38 is a view for explaining a mobile data disposition pattern in other modes.

According to FIG. 38, two 1.1 version data are disposed in a central packet based on the location on the stream among the entirety of the packets inside the second area, that is, among 38 packets, and in the other packets, 1.1 version data and normal data are disposed according to the determined ratios in each mode.

That is, in a) of FIG. 38 (first mode), regarding the remaining packets besides the two central packets, in the upper side, two normal data packets and two 1.1 version data packets are repeated, while in the lower part, two 1.1 version data packets and two normal data packets are repeated.

Next, in c) of FIG. 38 (third mode), regarding the remaining packets besides the two central packets, in the upper side, one normal data packet and three 1.1 version data packets are repeated, while in the lower side, three 1.1 version data packets and one normal data packet is repeated.

In d) of FIG. 38 (fourth mode), the entire group of packets are disposed in 1.1 version data, which becomes the same format as the fourth mode of FIG. 37.

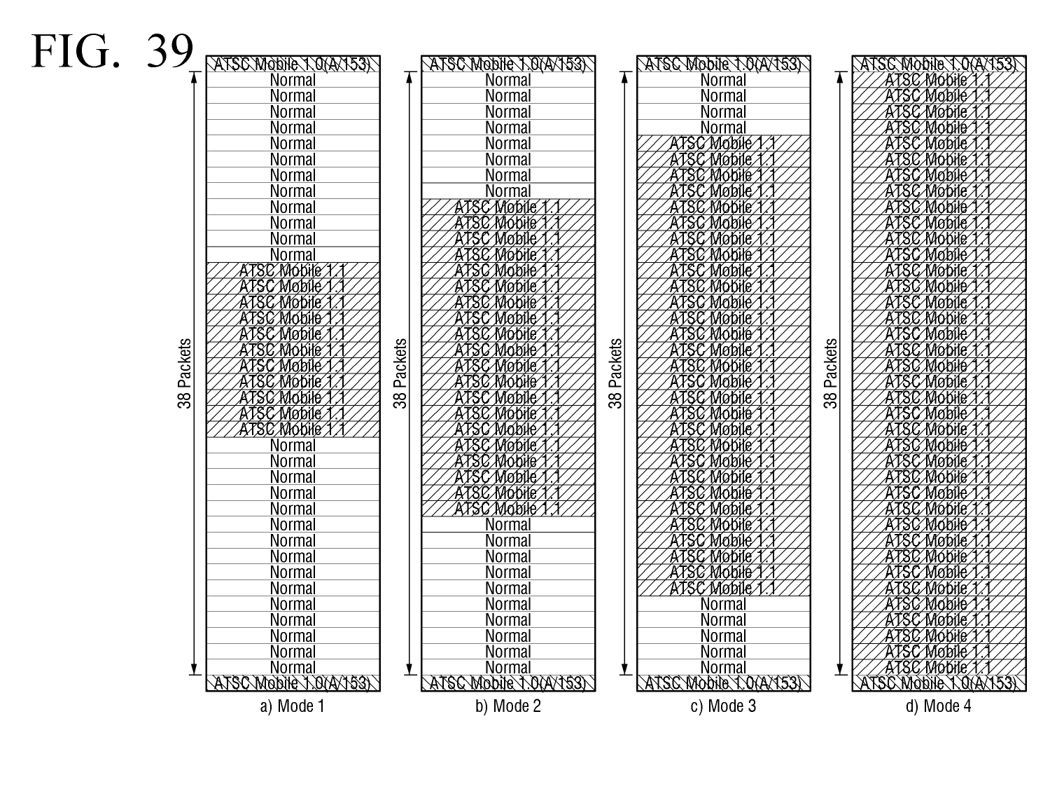

Next, FIG. 39 illustrates an exemplary embodiment where 1.1 version data is sequentially disposed in upper and lower packet directions from the central packet based on the location on the stream.

That is, in a) of FIG. 39 (first mode), 11 packets from the center among the entire group of packets of the second area are disposed sequentially in upper and lower directions.

Next, b) of FIG. 39 (second mode) is a state where a total of 20 packets from the center are sequentially disposed in upper and lower directions, and c) of FIG. 39 (third mode) is a state where a total of 30 packets from the center are sequentially disposed in an upper and lower directions. Also, d) of FIG. 39 (fourth mode) is a state where the entire group of packets are filled with 1.1 version data.

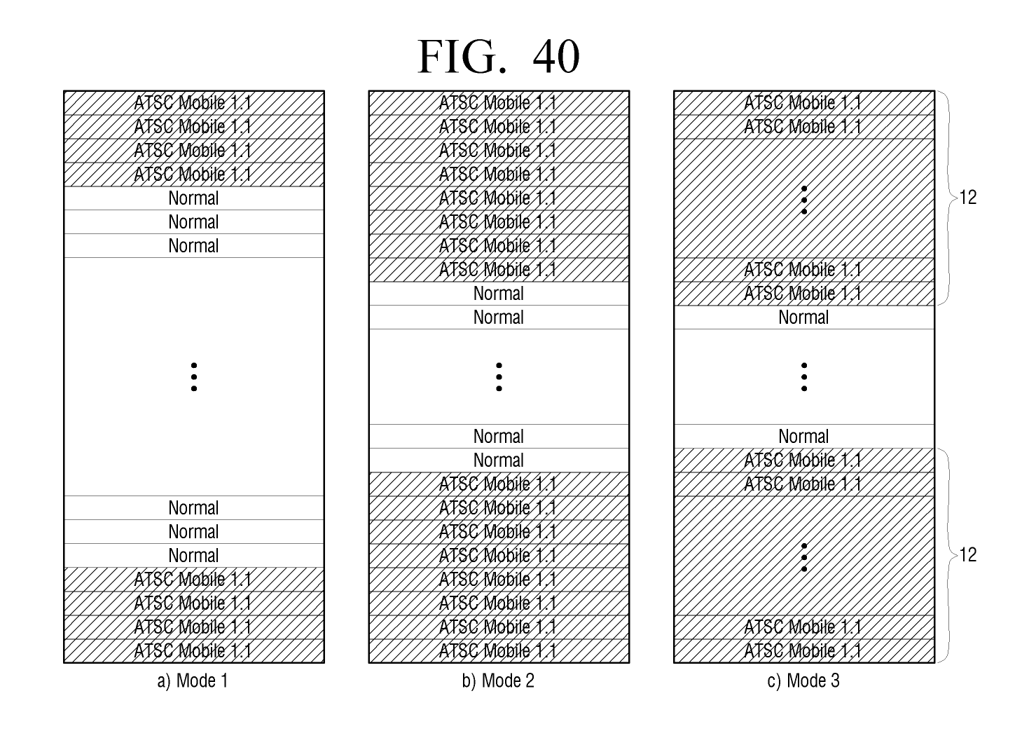

In contrast to FIG. 39, FIG. 40 illustrates a stream configuration according to an exemplary embodiment where mobile data is filled in a central direction from the upper and lower packets. In addition, FIG. 40 illustrates a state where the numbers of new mobile data packets in the first to fourth modes are set differently from the numbers in the aforementioned various exemplary embodiments.

That is, in a) of FIG. 40 (first mode), four 1.1 version data packets are disposed in a lower direction from the upper packets, and four 1.1 version data packets are disposed in an upper direction from the lower packets. That is, FIG. 40 illustrates a case where a total of 8 1.1 version data packets are disposed.

Next, in b) of FIG. 40 (second mode), eight 1.1 version data packets are disposed in a lower direction from the upper packets, and eight 1.1 version data packets are disposed in an upper direction from the lower packets. That is, a total of sixteen 1.1 version data packets are disposed.

Next, in c) of FIG. 40 (third mode), twelve 1.1 version data packets are disposed in a lower direction from the upper packets, and twelve 1.1 version data packets are disposed in an upper direction from the lower packets. That is, a total of twenty four 1.1 version data packets are disposed.

The remaining packets are filled with normal data. The packet pattern in the fourth mode is the same as in FIGS. 37, 38, and 39, and thus illustration of this packet pattern in FIG. 40 is omitted.

There is no illustration in FIGS. 37 to 49 about insertion of base data, but base data may be inserted in a portion area of the packets such as mobile data, or may be inserted into a portion area of a separate packet or the entirety of the pay load area. The method of inserting base data has already been explained hereinabove and thus an illustration thereof is omitted in FIGS. 37 to 40.

In addition, in the case of the fifth mode, which is an incompatibility mode, new mobile data is additionally filled in the RS parity area and header area inside existing mobile data area and not the normal data area, and thus no further illustration thereof is made in FIGS. 37 to 40.

In addition, the fifth mode may be provided as a new mode separately from the fourth mode, but the fourth mode or fifth mode may be combined to the first to third modes, to be embodied as a total of four modes.

That is, the aforementioned FIGS. 37 to 40 illustrate a method of inserting new mobile data in the packets allocated to the second area, that is, normal data (for example, 38 packets) in various modes. In FIGS. 37 to 40, the method of disposing new mobile data in the packets allocated to normal data may change as in the first mode to fourth mode as aforementioned. Herein, the fourth mode may be embodied in a mode of filling only the entirety of 38 packets with new mobile data, or in a mode of filling an RS parity area and a header area as well as in addition to the 38 packets with new mobile data. Otherwise, as aforementioned, the mode may include all first to fifth modes.

Supposing a mode for determining the number of packets to allocate new mobile data among the 38 packets and determining how to configure the block inside the M/H group is a scalable mode, in FIG. 37, the modes may be defined as a) scalable mode 00, b) scalable mode 01, c) scalable mode 10, and d) scalable mode 11, using a two bit signaling field. Herein, even if all of the 38 packets are allocated to new mobile data as in d) of FIG. 37, 118 packets of existing mobile data area and 38 packets where new mobile data is allocated may form one M/H group.

In this case, depending on how a block is configured inside this group, two scalable modes may be defined. For example, assuming a case where the transmission data rate of 19.4 Mbps is allocated to mobile data, and a case where the transmission data rate of 19.4 Mbps is not allocated to mobile data, it can be seen that M/H groups having different block configurations may occur even when 38 packets inside one slot are all allocated to mobile data as in FIG. 37.

In this case, depending on how the blocks are configured inside this group, two scalable modes may be defined. For example, assuming a case where a transmission data rate of 19.4 Mbps is allocated to mobile data, and a case where the transmission data rate of 19.4 Mbps is not allocated to mobile data, as in FIG. 37, even when 38 packets inside one slot are all allocated to mobile data, M/H groups having different block configurations may occur.

First of all, the case where the existing transmission data rate of 19.4 Mbps is allocated to mobile data is a case where the normal data rate is 0 Mbps, corresponding to a case where a broadcast operator provides services considering only the receiver receiving mobile data and not considering the receiver receiving normal data. In this case, it is possible to define an area where there exists a placeholder for the MPEG header and RS parity which was left for compatibility with the receiver receiving existing normal data as an area for mobile data, and increase the transmission capacity of mobile data up to about 21.5 Mbps.

Allocating the transmission data rate of 19.4 Mbps to mobile data results in each of 156 packets of M/H slots configuring the M/H frame being allocated to mobile data, thereby resulting in a case where 16 slots inside each M/H sub-frames are set as scalable mode 11. In this case, the 38 packets which constitute the normal data area may all be filled with mobile data, and a block SB5 corresponding to an area where there exists a placeholder for the MPEG header and RS parity existing in the body area may be derived. When 16 slots inside the M/H sub-frame are all set as scalable mode 11 and the RS frame mode is 00(single Frame mode), there does not exist an additional SB5 lock, and the placeholder corresponding to SB5 is absorbed to M/H blocks B4, B5, B6 and B7. When 16 slots inside the M/H sub-frame are all set as scalable mode 11, and the RS frame mode is 01 (Dual Frame Mode), the placeholder located in SB5 forms block SB5. Mobile data is filled in the placeholder area for RS parity existing in the head/tail area besides the body area, and is absorbed to a block where the segment where the placeholder for RS parity belongs to. The placeholder located in the corresponding segments of M/H block B8 and B9 is absorbed to SB1. The placeholder located in the first 14 segments of the M/H block B10 is absorbed to SB1. The placeholder located in the last 14 segments of the M/H block B1 of a subsequent slot is absorbed to SB3. The placeholder located in the corresponding segment of the M/H block B2 and B3 of the subsequent slot is absorbed to SB4. As in the aforementioned FIG. 20, it can be seen that in the group format after interleaving, an area for an MPEG header and RS parity does not exist.

A case where a transmission data rate less than the transmission data rate of 19.4 Mbps is allocated to mobile data is a case where the normal data rate is not 0 Mbps, which is when the broadcast operator provides services considering both the receiver receiving normal data and the receiver receiving mobile data. In this case, in order to maintain compatibility with the receiver receiving the existing normal data, an MPEG header or RS parity cannot be redefined as mobile data, but must be transmitted as it is. That is, even if new mobile data is filled in only in a portion of the 38 packets or new mobile data is filled in the entirety of the 38 packets, the MPEG header and RS parity area is not filled with new mobile data, as in the aforementioned compatibility mode. Therefore, even when the 38 packets which constitute a normal data area are all filled with mobile data, a block SB5 corresponding to the area where there exists an MPEG header and RS parity existing in the body area cannot be derived.

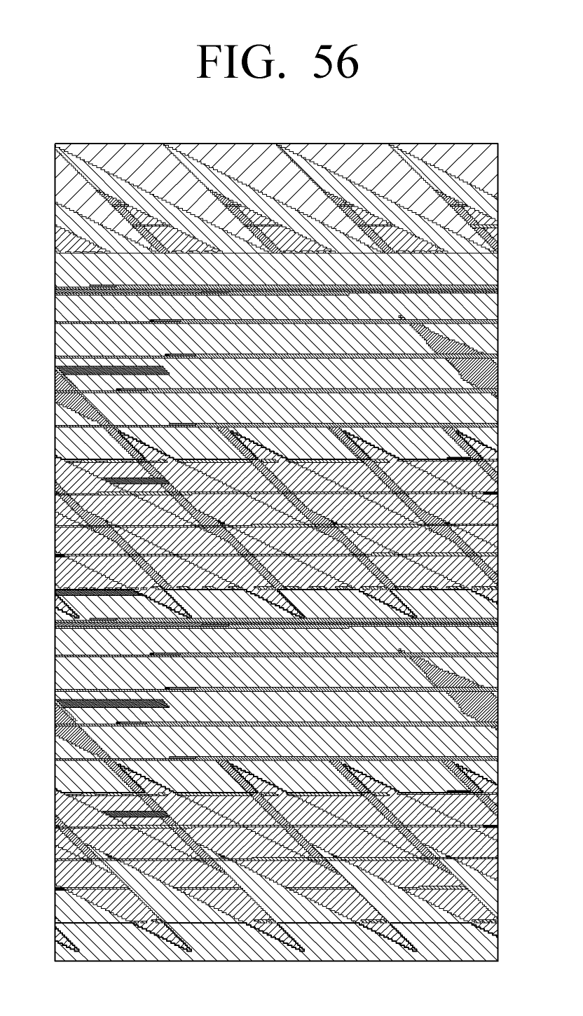

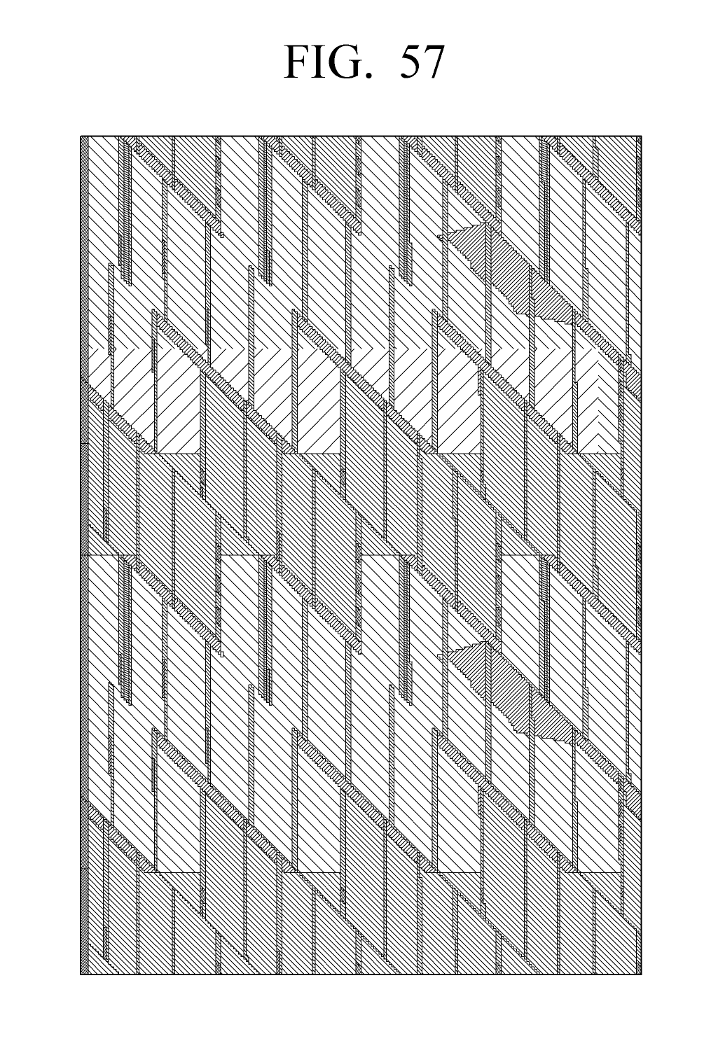

FIG. 57 is a packet unit group format before interleaving considering compatibility when the 38 packets which constitute the normal data area are all filled with mobile data. As in d) of FIGS. 37 to 40, all 38 packets are allocated by mobile data, but it can be seen that as in FIG. 56, in the segment unit group format after interleaving, an area where there exists an MPEG header and RS parity is maintained and a block SB5 is not derived. Such a group format may be defined as a group format corresponding to scalable mode 11, or the fourth mode. Otherwise, the fourth mode where only the 38 packets are filled with new mobile data considering compatibility may be called a scalable mode 11a.

In the case where the incompatibility mode, that is the scalable mode 11, is used, it cannot be used together with t slot where new mobile data is filled with another mode. That is, the total slots, that is 0 to 15^{th} slots, must all be filed with new mobile data according to scalable mode 11. On the other hand, the first to fourth modes may not be combined with one another and used.

As such, the normal data area of each slot may be filled with mobile data in various formats. Therefore, the format of the slot may change according to the frame mode and setting state of the mode.

As aforementioned, when four modes are provided, each slot where mobile data is disposed in modes 1 to 4 may be called the first type to fourth type slots

The digital broadcast transmitter may form a same type of slot per slot, or alternatively, the digital broadcast transmitter may form a stream such that different types of slots are repeated.

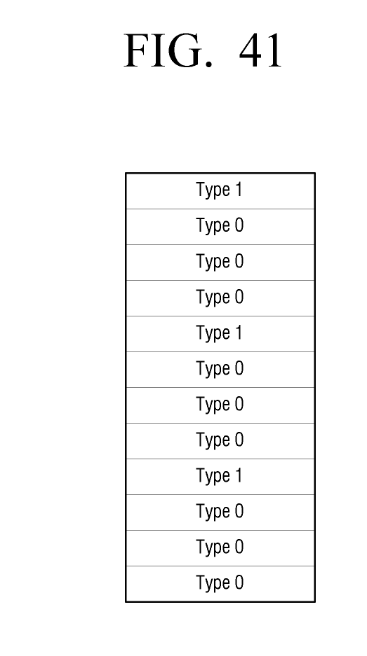

That is, as in FIG. 41, the data preprocessor 100 may dispose mobile data such that one first type slot and three 0 type slots are repeatedly disposed. The 0 type slot may be a slot where normal data is allocated to the packets allocated to the normal data.

Such a slot type may be defined using existing signaling data, for example a certain portion of TPC or FIC.

Meanwhile, as aforementioned, in a state where the frame mode is set as 1, the mode may be set to be one of a plurality of modes such as from first to fourth mode. Herein, the fourth mode may be the aforementioned scalable mode 11 or scalable mode 11a. Otherwise, the mode may be one of 5 modes including all scalable modes 11 and 11a. Otherwise, the mode may be classified as at least one compatibility mode and incompatibility mode, which is scalable mode 11.

In an example where the mode is embodied in a case including first to fourth modes, the slot corresponding to each mode may be called 1-1, 1-2, 1-3, and 1-4 type slot.

That is, a 1-1 type slot refers to a slot where 38 packets are allocated to a first mode, a 1-2 type slot refers to a slot where 38 packets are allocated to a second mode, and 1-4 type slot refers to a slot where 38 packets are allocated to a fourth mode.

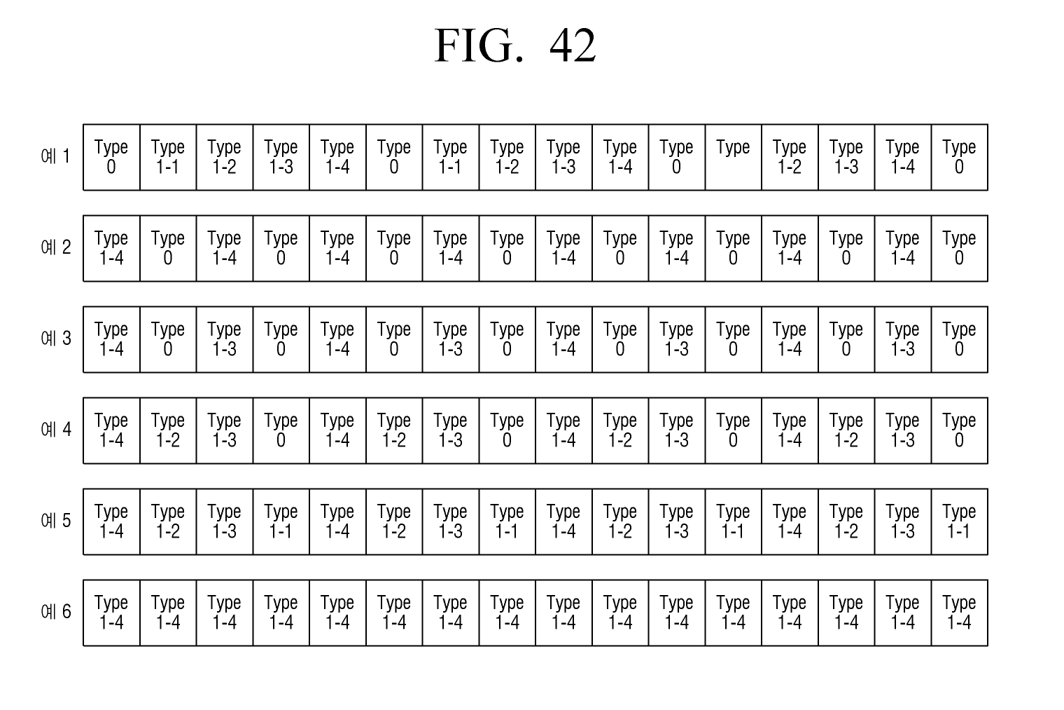

FIG. 42 illustrates examples of streams where such various types of slots are repeatedly disposed.

Example 2 of FIG. 42 illustrates a stream where a 1-4 type slot and a 0 type slot are alternately repeated. As aforementioned, the fourth mode is a mode where the entirety of the normal data area is filled with mobile data, and thus, example 2 refers to a situation where a slot in which the entire normal data area is used for mobile data and a slot used for normal data are alternately repeated.

Besides, various types of slots may be repeatedly disposed in various ways as shown in examples 3, 4, and 5. Especially, there may be a case where the entirety of the slots is unified in one type and a stream is formed as in example 6.

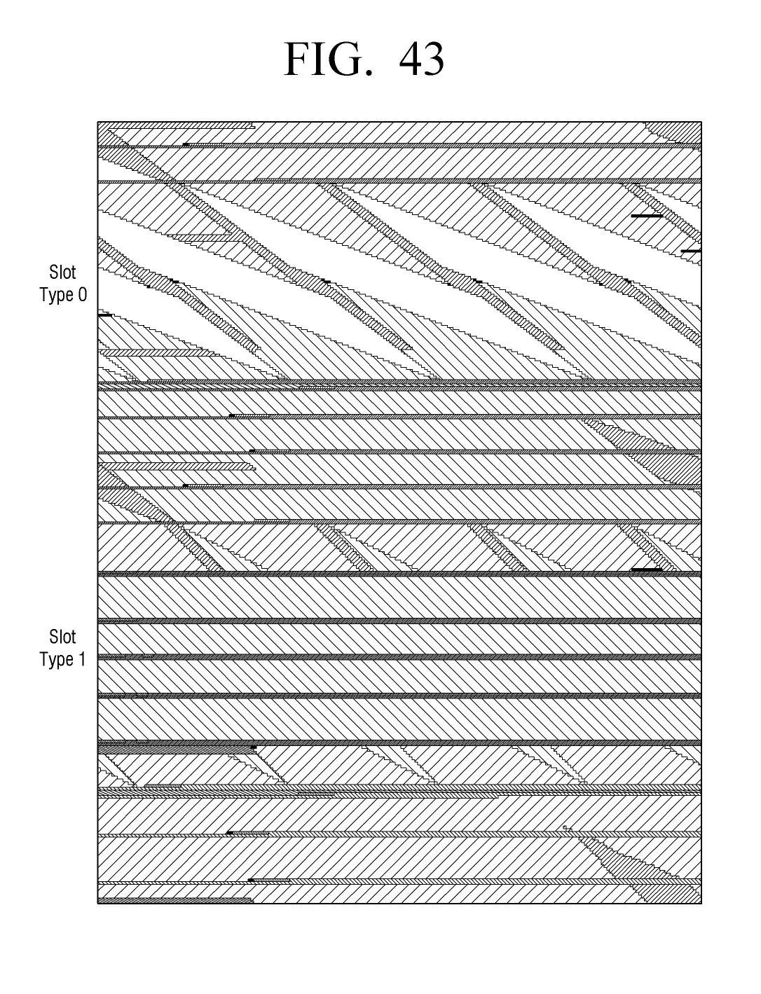

FIG. 43 is a view illustrating a stream configuration according to example 2 of FIG. 42. According to FIG. 43, in the 0 type slot, a normal data area is used for normal data use itself, but in the first type slot, the entire normal data area is used as mobile data, and at the same time, base data is disposed in a long training sequence format. As such, the slot format may be embodied in various ways.

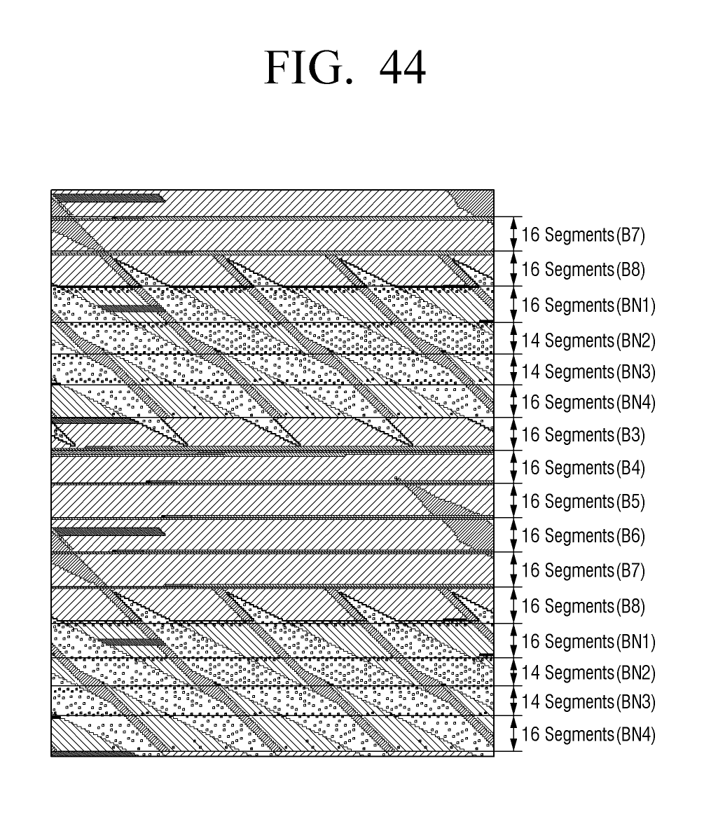

FIGS. 44 to 47 are stream configurations for explaining a block allocation method in modes 1 to 4. As aforementioned, the first area and second area may be classified in a plurality of blocks.

The data preprocessor 100 may perform block coding in one block or a plurality of block combination units according to the predetermined block mode.

FIG. 44 illustrates block classification in a first mode. According to FIG. 44, the body area is classified as B3-B8, and the head/tail area is classified as BN1 to BN4.

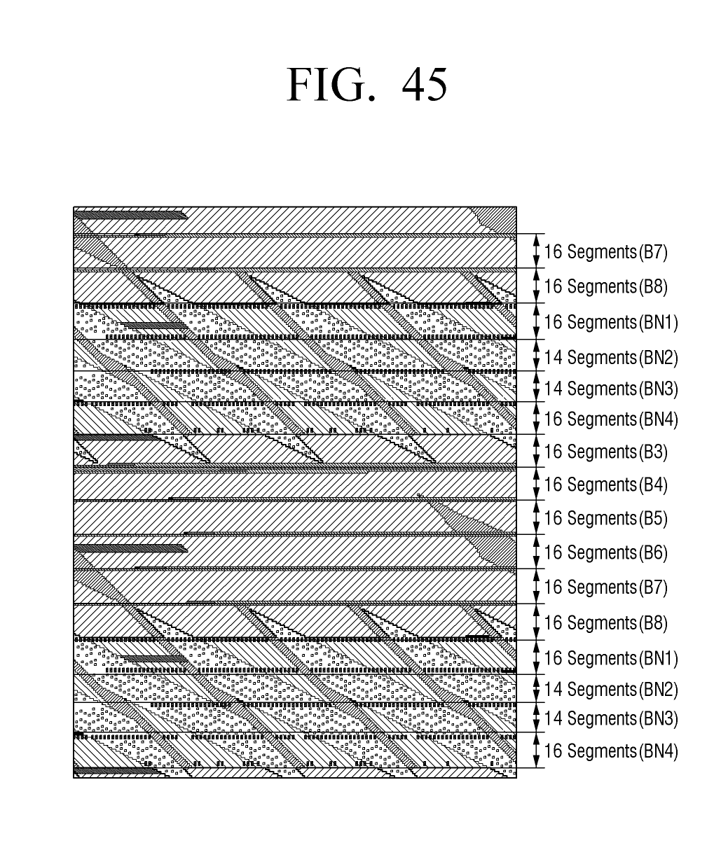

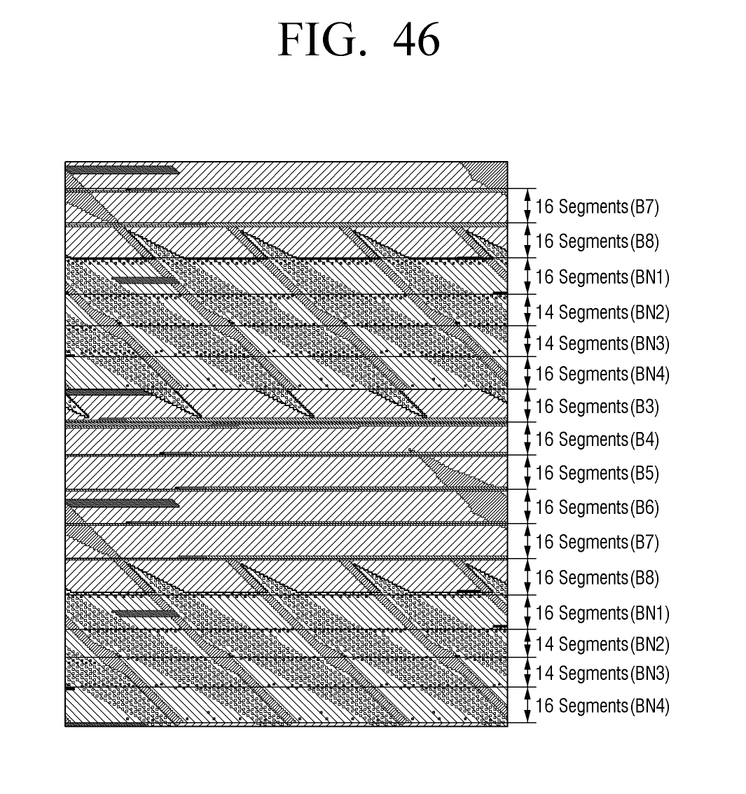

FIGS. 45 and 46 illustrate block classification in a second mode and a third mode. As in FIG. 44, the body area and head/tail area are classified in a plurality of blocks.

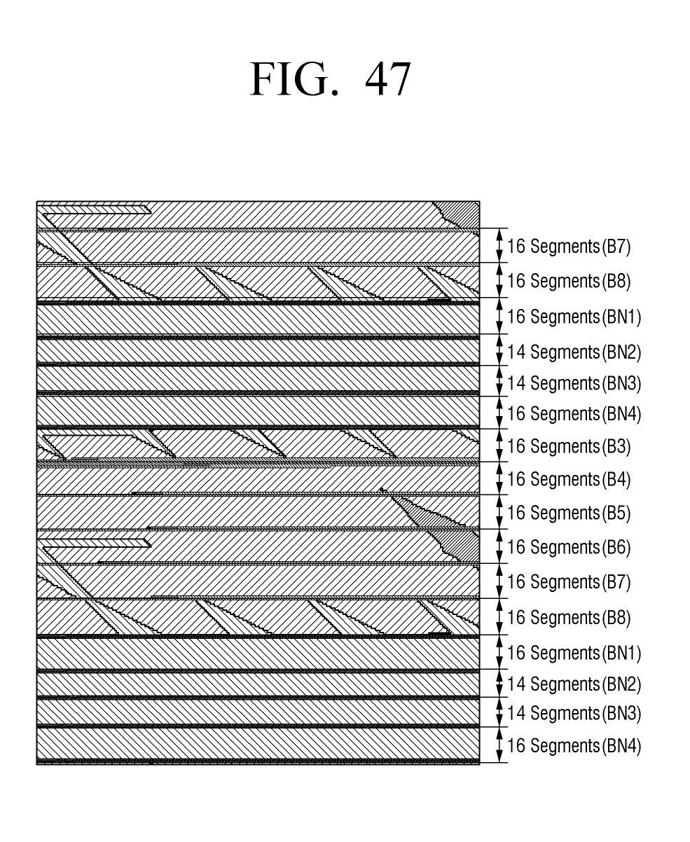

FIG. 47 illustrates a block classification in a fourth mode where the head/tail area is completely filled with mobile data. As the normal data area is completely filled with mobile data, the normal data is not necessary, and thus, in FIG. 47, these portions as defined as BN5. The BN5 portion is filled with new mobile data in the incompatibility mode, and is used for header and parity use in the compatibility mode. As such, compared to FIGS. 44 to 46, in FIG. 47, the head/tail area is classified as BN1 to BN 5.

As aforementioned, the block processor 120 of the data preprocessor 100 converts the RS frame in block units and then processes the same. That is, as illustrated in FIG. 7, the block processor 120 includes the first converter 121, and the first converter 121 combines the mobile data inside the Rs frame according to the predetermined block mode, and outputs the SCCC (Serially Concatenated Convolutional Code) block.

The block mode may be set in various ways.

For example, when the block mode is set as 0, each block, that is BN1, BN2, BN3, BN4, BN5, etc., are output as one SCCC block, becoming a unit of SCCC coding.

When the block mode is set as 1, the blocks are combined to form SCCC blocks. More specifically, BN1+BN3 becomes SCBN1, BN2+BN4 becomes SCBN2, and BN5 becomes SCBN3.

Besides the mobile data disposed in the second area, the existing mobile data disposed in the first area may also be combined in one or a plurality thereof and then block encoded. This is the same as the conventional ATSC-MH, and thus, an explanation thereof is omitted.

Information on the block mode may be disclosed in the existing signaling data or included in an area provided in the new signaling data, and be notified to the receiver side. The receiver side checks the information on the notified block mode, appropriately encodes the same, and restores the original stream.

Meanwhile, as aforementioned, the data to be block encoded may be combined to form the RS frame. That is, the frame encoder 110 inside the data preprocessor 100 appropriately combines each frame portion so as to be appropriately block encoded by the block processor 120, and creates the RS frame.

More specifically, SCBN1 and SCBN2 are combined to form RS frame 0, and SCBN3 and SCBN4 are combined to form RS frame 1.

Otherwise, SCBN1, SCBN2, SCBN3, and SCBN4 may be combined to form RS frame 0, and SCBN5 may form RS frame 1.

Otherwise, SCBN1+SCBN2+SCBN3+SCBN4+SCBN5 may be formed as one RS frame.

Besides, the blocks corresponding to the existing mobile data and the newly added blocks (SCBN1˜SCBN5) may be combined to form an RS frame.

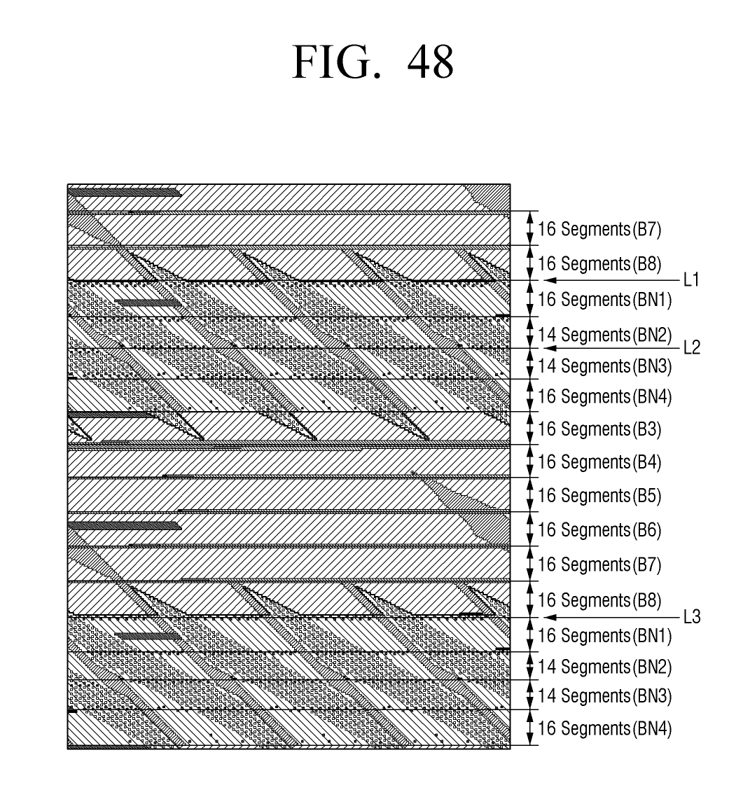

FIG. 48 is a view for explaining various other methods for defining the starting point of an RS frame. According to FIG. 48, a transport stream is classified into a plurality of blocks. In the conventional ATSC-MH, the RS frame was classified between BN2 and BN3. However, as disclosed in the present disclosure, as the mobile data and base data are inserted into the normal data area, the starting point of an RS frame may be differently defined.

For example, it is possible to start the RS frame based on the boundary between BN1 and B8, or start the RS frame based on the boundary between BN2 and BN3 similarly with the current reference point, or start the RS frame based on the boundary between B8 and BN1. The starting point of the RS frame may be differently defined according to the combination state of the block coding.

The configuration information of the aforementioned RS frame may be included in the area provided in the existing signaling data or new signaling data and be provided to the receiver side.

As aforementioned, since new mobile data and base data are inserted into the area allocated to the original normal data and the area allocated to the existing mobile data, various types of information are used to notify such a fact to the receiver side. Such information may be transmitted using the reserve bit inside the TPC area of the existing ATSC-MH standard, or a signaling data area may be newly obtained, and new signaling data may be transmitted through that area. The newly provided signaling area should be at the same location in all modes, and thus, it is located in the head/tail portion.

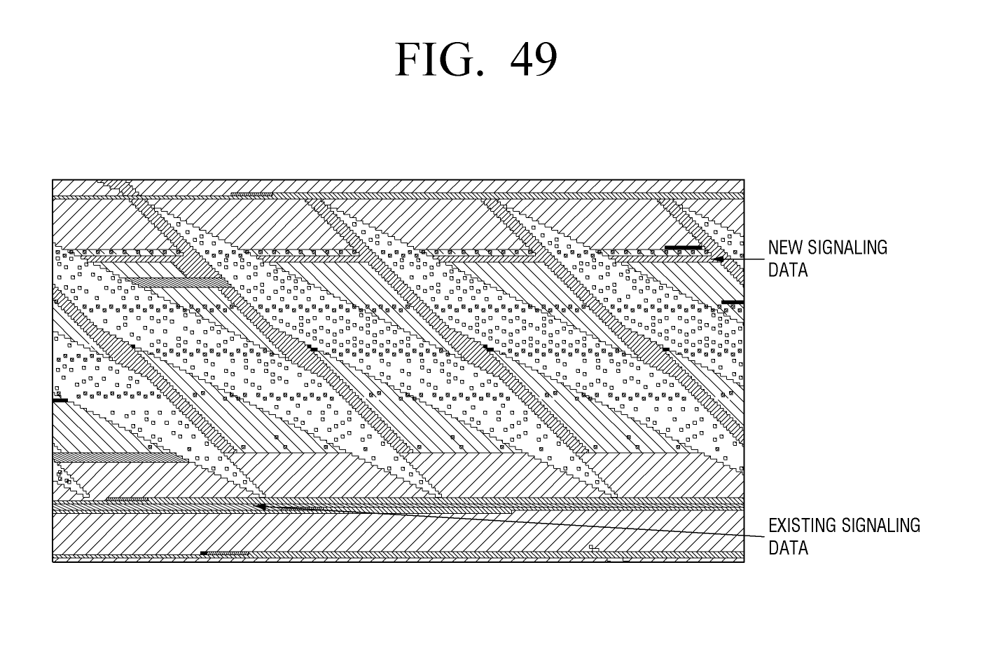

FIG. 49 is a stream configuration of the existing signal data disposition location and a new signaling data disposition location.

According to FIG. 49, the existing signaling data is disposed between the long training sequence of the body area, and the new signaling data is disposed inside the head/tail area. The new signaling data encoded in the signaling encoder 150 is inserted by the group formatter 130 into the predetermined location as the location illustrated in FIG. 49.

The signaling encoder 150 may use a code different from the existing signaling encoder or perform coding with a different code rate and improve the performance.

That is, it is possible to use a method of obtaining an effect such as using a 1/8 rate PCCC code by adding the existing RS code and use a 1/8 PCCC code or use RS+1/4 PCCC code while sending the same data twice.

Meanwhile, as aforementioned, since the base data is included in the transport stream, an initialization of the memory inside the trellis encoder must be performed right before a trellis encoding is made regarding the base data.

In the case where a long training sequence is provided as in mode 4, it is possible to process the corresponding sequence with only one initialization, and thus, there is no significant problem, but in the case where the base data is disposed discontinuously as in the remaining modes, there is a difficulty that an initialization must be performed numerous times. In addition, when the memory is initialized to 0 by the initialization, it becomes difficult to make a symbol such as mode 4.

Considering the above, it is possible to load the trellis encoder memory value (that is, registor value) in mode 4 directly to a trellis encoder without a trellis reset, so as to create a symbol in modes 1 to 3 as well as in mode 4. To this end, it is possible to record and store memory storage values of the trellis encoder in a table format and perform trellis encoding with a value of the location corresponding to the stored table. Otherwise, it is possible to have an additional encoder which operates in mode 4 and utilize the value obtained in that trellis encoder.

As such, it is possible to actively utilize the normal data area and existing mobile data area inside the transmission stream and provide mobile data in various ways. Accordingly, it is possible to provide a more appropriate stream to mobile data transmission compared to the conventional ATSC standard.

[Signaling]

Meanwhile, as new mobile data and base data are added to the transport stream as aforementioned, there is needed a technology of notifying this information to the receiver so as to process these data. A notification may be made in various ways.

That is, first of all, it is possible to use the data field sync that used to be used for transmission of existing mobile data to notify whether or not new mobile data exists.

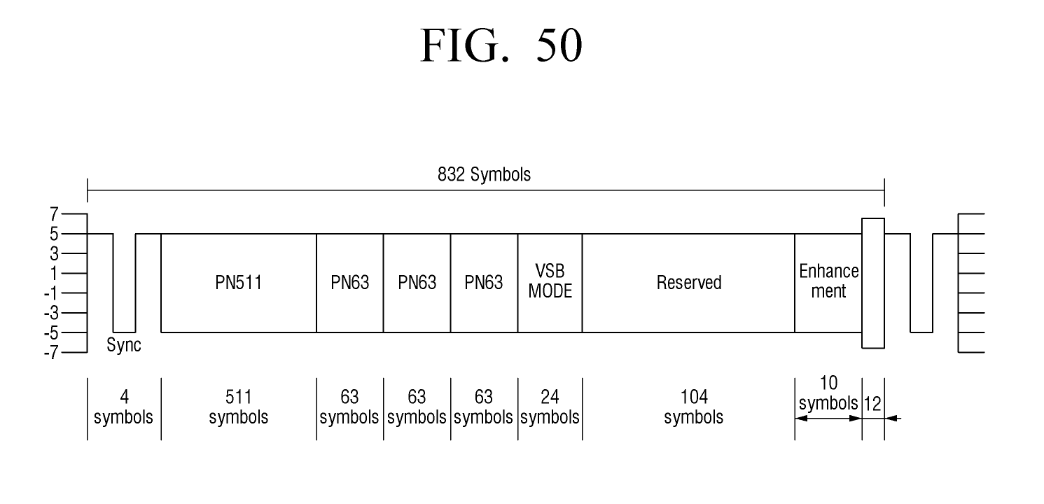

FIG. 50 is a view illustrating an example of a data field sync configuration. According to FIG. 50, the data field sync consists of a total of 832 symbols, of which 104 symbols correspond to a reserve area. In the reserve area, the 83th to 92^{nd} symbol, that is a total of 10 symbols, correspond to the enhancement area.

In the case where only 1.0 version data is included, at an odd number data field, +5 is given to the 85^{th} symbol while −5 is given to the remaining symbols, that is 83, 84, 86-92. An even number data field has the negative (opposite) value of the symbol of the odd number data field (that is − when +, and + when −).

When 1.1 version data is included, in an odd number data field, +5 is given to symbols 85 and 86, and −5 is given to the remaining symbols, that is 83, 84, 87˜92. An even number data field has the negative value of the symbol of the odd number data field. That is, it is possible to notify whether or not 1.1 version data is included using the 86th symbol.

Meanwhile, whether or not 1.1 version data is included may be notified by another symbol inside the enhancement area. That is, it is possible to notify whether or not 1.1 version data is included by giving +5 or other values to one or a plurality of symbols besides 85 symbols. For example, an 87th symbol may be used.

The data field sync may be created by a controller of FIG. 3, a signaling encoder, or a field sync creator (not illustrated) separated provided and then provided in a sync mux 470 of FIG. 4, and be muxed to the stream by the sync mux 470.

As a second method, it is possible to notify whether or not 1.1 version data exists using TPC. TPC is made by a syntax as in the following list.

TABLE 1

| | | |
|---|---|---|
| | No. of | |
| Syntax | Bits | Format |

TPC_data {

| | | |
|---|---|---|
| sub-frame_number | 3 | uimsbf |
| slot_number | 4 | uimsbf |
| parade_id | 7 | uimsbf |
| starting_group_number | 4 | uimsbf |
| number_of_groups_minus_1 | 3 | uimsbf |
| parade_repetition_cycle_minus_1 | 3 | uimsbf |
| rs_frame_mode | 2 | bslbf |
| rs_code_mode_primary | 2 | bslbf |
| rs_code_mode_secondary | 2 | bslbf |
| sccc_block_mode | 2 | bslbf |
| sccc_outer_code_mode_a | 2 | bslbf |
| sccc_outer_code_mode_b | 2 | bslbf |
| sccc_outer_code_mode_c | 2 | bslbf |
| sccc_outer_code_mode_d | 2 | bslbf |
| fic_version | 5 | uimsbf |
| parade_continuity_counter | 4 | uimsbf |
| total_number_of_groups | 5 | uimsbf |
| reserved | 21 | bslbf |
| tpc_protocol_version | 5 | bslbf |

}

As in table 1, a reserved area exists in the TPC information. Therefore, it is possible to signal whether or not mobile data is included in the packets allocated to the normal data, that is, in the packets of the second area, its location, whether or not new base data is added, the added location of the base data, etc., using one or a plurality of bits inside the reserved area.

The information that can be inserted may be expressed as below.

TABLE 2

| Necessary fields | Bits(changeable) |
|---|---|
| 1.1 frame mode | 3 |
| 1.1 mobile mode | 2 |
| 1.1 SCCC block mode | 2 |
| 1.1 SCCCBM1 | 2 |
| 1.1 SCCCBM2 | 2 |
| 1.1 SCCCBM3 | 2 |
| 1.1 SCCCBM4 | 2 |
| 1.1 SCCCBM5 | 2 |

In table 2, 1.1 frame mode is information for commanding whether to use the packets allocated to the normal data directly for normal data, or to use for new mobile data, that is, 1.1 version data.

1.1 mobile mode is information for showing in which pattern mobile data will be disposed in the packets allocated to the normal data. That is, it is possible to use 2 bits to write one of “00”, “01”, “10”, and “11” to write one of 4 modes of the first to fourth modes. Accordingly, the stream may be disposed in various formats as in FIGS. 29, 31, 33, 35, 37, 38, 39, and 40, and the receiver side may check the mobile mode information and check the disposition location of mobile data.

1.1 SCCC block mode is information showing the block mode on 1.1 version data. 1.1 SCCCBM1˜SCCCBM5 is information showing coding units of data for 1.1 version use.

Besides the information disclosed in table 2, various types of information may be additionally provided which enables new mobile data to be appropriately detected and decoded by the receiver side, and the number of bits allocated to each type of information may be changed when necessary. In addition, the location of each field may be disposed in a different order from table 2.

A notification may be made through FIC information so that the digital broadcast receiver which received a stream containing new mobile data can recognize whether or not new mobile data is included.

That is, the receiver for 1.1 version use which receives and processes new mobile data must be capable of processing 1.0 service information and 1.1 service information at the same time, whereas the receiver for 1.0 version use must be capable of disregarding 1.1 service information.

Accordingly, it is possible to change the existing FIC segment syntax, to obtain an area for notifying whether or not 1.1 version data exits.

The syntax of an existing FIC segment may be configured as in the table below.

TABLE 3

| | | |
|---|---|---|
| | No. of | |
| Syntax | Bits | Format |

FIC_segment_header( ) {

| | | |
|---|---|---|
| FIC_segment_type | 2 | uimsbf |
| reserved | 2 | ‘11’ |
| FIC_chunk_major_protocol_version | 2 | uimsbf |
| current_next_indicator | 1 | bslbf |
| error_indicator | 1 | bslbf |
| FIC_segment_num | 4 | uimsbf |
| FIC_last_segment_num | 4 | uimsbf |

}

The FIC segment as in table 3 may be changed as in table 4 below so as to be able to notify whether or not data for 1.1 version use exists.

TABLE 4

| | | |
|---|---|---|
| | No. of | |
| Syntax | Bits | Format |

FIC_segment_header( ) {

| | | |
|---|---|---|
| FIC_segment_type | 2 | uimsbf |
| current_next_indicator | 1 | bslbf |
| error_indicator | 1 | bslbf |
| FIC_chunk_major_protocol_version | 2 | uimsbf |
| FIC_segment_num | 5 | uimsbf |
| FIC_last_segment_num | 5 | uimsbf |

}

According to table 4, it can be seen that instead of the reserved area, FIC_segment_num and FIC_last_segment_num are each expanded to 5 bits.

In table 4, by adding 01 to the value of FIC_segment_type, it is possible to notify whether or not data for 1.1 version use exists. That is, when FIC_segment_type is set as 01, the receiver for 1.1 version use decodes the FIC information and processes the data for 1.1 version use. In this case, the receiver for 1.1 version use cannot detect FIC information. On the other hand, when FIC_segment_type is defined as a null segment, the receiver for 1.0 version use decodes the FIC information and processes the existing mobile data.

Meanwhile, it is possible not to change the existing FIC syntax, but to maintain the syntax of the FIC chunk while using a portion area, for example a reserved area, to notify whether or not 1.1 version data exists.

More specifically, it is possible to add “MH 1.1 service_status” to the reserve area among the service ensemble loop as in the table below.

TABLE 5

| | | |
|---|---|---|
| | No. of | |
| Syntax | Bits | Format |

FIC_chunk_payload( ){

for(i=0; i<num_ensembles; i++){

| | | |
|---|---|---|
| ensemble_id | 8 | uimsbf |
| reserved | 3 | ‘111’ |
| ensemble_protocol_version | 5 | uimsbf |
| SLT_ensemble_indicator | 1 | bslbf |
| GAT_ensemble_indicator | 1 | bslbf |
| reserved | 1 | ‘1’ |
| MH_service_signaling_channel_version | 5 | uimsbf |
| num_MH_services | 8 | uimsbf |
| for (j=0; j<num_MH_services; j++){ | | |

| | | |
|---|---|---|
| MH_service_id | 16 | uimsbf |

| | | |
|---|---|---|
| MH1.1_service_status | 2 | uimsbf |

| | | |
|---|---|---|
| reserved | 1 | ‘1’ |
| multi_ensemble_service | 2 | uimsbf |
| MH_service_status | 2 | uimsbf |
| SP_indicator | 1 | bslbf |
| } | | |

| | |
|---|---|
| } | |
| FIC_chunk_stuffing( ) | var |

}

According to table 5, it is possible to utilize 2 bits among 3 bits of the reserved area to display MH 1.1_service_status. MH 1.1_service_status may be data indicating whether or not 1.1 version data exists inside the stream.

Otherwise, it is possible to add MH1.1_ensemble_indicator besides MH 1.1_service_status. That is, the syntax of an FIC chunk may be made as in the table below.

TABLE 6

| | | |
|---|---|---|
| | No. of | |
| Syntax | Bits | Format |

FIC_chunk_payload( ){

for(i=0; i<num_ensembles; i++){

| | | |
|---|---|---|
| ensemble_id | 8 | uimsbf |
| MH1.1_ensemble_indicator | 1 | bslbf |

| | | |
|---|---|---|
| reserved | 2 | ‘11’ |

| | | |
|---|---|---|
| ensemble_protocol_version | 5 | uimsbf |
| SLT_ensemble_indicator | 1 | bslbf |
| GAT_ensemble_indicator | 1 | bslbf |
| reserved | 1 | ‘1’ |
| MH_service_signaling_channel_version | 5 | uimsbf |
| num_MH_services | 8 | uimsbf |
| for (j=0; j<num_MH_services; j++){ | | |

| | | |
|---|---|---|
| MH_service_id | 16 | uimsbf |
| MH1.1_service_status_extension | 2 | uimsbf |

| | |
|---|---|
| reserved | ‘1’ |

| | | |
|---|---|---|
| multi_ensemble_service | 2 | uimsbf |
| MH_service_status | 2 | uimsbf |
| SP_indicator | 1 | bslbf |
| } | | |

| | |
|---|---|
| } | |
| FIC_chunk_stuffing( ) | var |

}

According to table 6, 1 bit among the 3 bits of the first reserved area is allocated to MH1.1_ensemble_indicator. MH1.1_ensemble_indicator refers to information on an ensemble which is the service unit of 1.1 version data. In table 6, it is possible to utilize 2 bits among 3 bits of the second reserved area and display MH1.1_service_status_extension.

Otherwise, as in table 7, it is possible to change the ensemble protocol version and utilize the value allocated to the reserved area of 1.0 to display 1.1 in the case of a service for 1.1 version use.

TABLE 7

| | | |
|---|---|---|
| | No. of | |
| Syntax | Bits | Format |

FIC_chunk_payload( ){

for(i=0; i<num_ensembles; i++){

| | | |
|---|---|---|
| ensemble_id | 8 | uimsbf |
| reserved | 3 | ‘111’ |
| ensemble_protocol_version | 5 | uimsbf |
| SLT_ensemble_indicator | 1 | bslbf |
| GAT_ensemble_indicator | 1 | bslbf |
| reserved | 1 | ‘1’ |
| MH_service_signaling_channel_version | 5 | uimsbf |
| num_MH_services | 8 | uimsbf |
| for (j=0; j<num_MH_services; j++){ | | |

| | | |
|---|---|---|
| MH_service_id | 16 | uimsbf |
| reserved | 3 | ‘111’ |
| multi_ensemble_service | 2 | uimsbf |
| MH_service_status | 2 | uimsbf |
| SP_indicator | 1 | bslbf |
| } | | |

| | |
|---|---|
| } | |
| FIC_chunk_stuffing( ) | var |

}

Otherwise, as in table 8, it is possible to transmit signaling data in a method of changing the ensemble loop header extension length among the syntax fields of the FIC chunk header, and adding ensemble extension of the syntax field of the FIC chunk pay load, and adding MH1.1_service_status to service loop reserved 3 bits of the syntax of an FIC chunk pay load.

TABLE 8

| | | |
|---|---|---|
| | No. of | |
| Syntax | Bits | Format |

FIC_chunk_payload( ){

for(i=0; i<num_ensembles; i++){

| | | |
|---|---|---|
| ensemble_id | 8 | uimsbf |
| reserved | 3 | ‘111’ |
| ensemble_protocol_version | 5 | uimsbf |
| SLT_ensemble_indicator | 1 | bslbf |
| GAT_ensemble_indicator | 1 | bslbf |
| reserved | 1 | ‘1’ |
| MH_service_signaling_channel_version | 5 | uimsbf |
| reserved | 3 | uimsbf |
| ensemble extension | 5 | |
| num_MH_services | 8 | uimsbf |
| for (j=0; j<num_MH_services; j++){ | | |

| | | |
|---|---|---|
| MH_service_id | 16 | uimsbf |

| | |
|---|---|
| MH_service_status_extention | 2 |

| reserved | | 1 | |
|---|---|---|---|
| | reserved | 3 | ‘111’ |
| | multi_ensemble_service | 2 | uimsbf |
| | MH_service_status | 2 | uimsbf |
| | SP_indicator | 1 | bslbf |
| | } | | |

| | |
|---|---|
| } | |
| FIC_chunk_stuffing( ) | var |

}

Otherwise, as in the table below, it is possible to change the MH_service_loop_extension_length among the syntax field of the FIC chunk header, and add an information field regarding MH1.1_service status to the pay load field of FIC chunk.

TABLE 9

| | | |
|---|---|---|
| | No. of | |
| Syntax | Bits | Format |

FIC_chunk_payload( ){

for(i=0; i<num_ensembles; i++){

| | | |
|---|---|---|
| ensemble_id | 8 | uimsbf |
| reserved | 3 | ‘111’ |
| ensemble_protocol_version | 5 | uimsbf |
| SLT_ensemble_indicator | 1 | bslbf |
| GAT_ensemble_indicator | 1 | bslbf |
| reserved | 1 | ‘1’ |
| MH_service_signaling_channel_version | 5 | uimsbf |
| num_MH_services | 8 | uimsbf |
| for (j=0; j<num_MH_services; j++){ | | |

| | | |
|---|---|---|
| MH_service_id | 16 | uimsbf |
| reserved | 3 | ‘111’ |
| multi_ensemble_service | 2 | uimsbf |
| MH_service_status | 2 | uimsbf |
| SP_indicator | 1 | bslbf |

| | | |
|---|---|---|
| reserved | 5 | uimsbf |
| MH1.1_Detailed_service_Info | 3 | uimsbf |

}

| | |
|---|---|
| } | |
| FIC_chunk_stuffing( ) | var |

}

As such, it is possible to provide signaling data to the receiver side using various areas, such as field sync, TPC information, and FIC information etc.

It is possible to insert signaling data into areas besides the aforementioned areas. That is, it is possible to insert signaling data into the packet pay load portion of the existing data.

In this case, as in table 5, it is possible to configure the data so as to record the location for checking whether data for 1.1 version use exists or the location for checking the signaling data, and provide additional signaling data for 1.1 version use to detect and use signaling data corresponding to the receiver for 1.1 version use.

In addition, it is possible to configure these signaling data in an additional stream and use an additional channel besides the stream transmission channel to transmit the same to the receiver side.

In addition, other information for signaling at least one of various types of information such as whether or not existing or new mobile data is included, location of mobile data, whether or not to add base data, adding location of the base data, a disposition pattern of mobile data and base data, block mode, a coding unit, etc., may be included as well.

The digital broadcast receiver using signaling data may be embodied in a format including a data preprocessor which disposes at least one of mobile data and base data in at least a portion of the normal data area among the packets configuring the stream and a mux which creates a transport stream containing mobile data and signaling data. The detailed configuration of the data preprocessor may be embodied as one of various exemplary embodiments aforementioned, or may be embodied in a format where some configurative elements are omitted, added or changed. Especially, the signaling data may be provided in a signaling encoder or the controller or an additional field sync creator (not illustrated), and may be inserted in the transport stream by the mux or sync mux. In this case, the signaling data is data for notifying at least one of whether or not the mobile data is disposed or the disposed pattern, and may be embodied in a data field sync or TPC, FIC information, etc., as aforementioned.

As aforementioned, when there exists a scalable mode 11a besides scalable mode 11, that is, when first to fifth modes exist, the mode expression method inside the signaling data may change accordingly.

According to an exemplary embodiment, the signaling field name inside the TPC field may be referred to as a scalable mode and allocate two bits to define four modes from a) to d) of FIGS. 37 to 40 as 00, 01, 10, and 11. In this case, in the fourth mode, whether or not the mode is a compatibility mode or incompatibility mode, they have the same bit value 11. However, since the two modes are different in terms of whether or not the MPEG header and parity area are used, the group format may be different.

The receiver may check not only the TPC of the slot where an M/H group of an M/H parade is to be received but also the TPC of other slots, and when the scalable mode of all the slots is 11 and a CMM slot does not exist, which is when the normal data rate is 0 Mbps, the bit value 11 may be determined as a scalable mode 11 and may be decoded.

On the other hand, when the scalable mode is not 11 or when a CMM slot exists, which is when the normal data rate is not 0 Mbps, compatibility must be considered and thus it is possible to determine the bit value 11 as scalable mode 11a and decode the same.

According to other exemplary embodiments, the signaling field name inside the TPC field may be called a scalable mode, and three bits may be allocated to that field. Accordingly, it is possible to signal a total of 5 group formats including three group formats corresponding to a) to c) of FIGS. 37 to 40 that is first to third modes, and two group formats corresponding to d) of FIGS. 37 to 40 that is fourth to fifth modes.

That is, as aforementioned, the entire group of modes may include:

1) a first mode disposing new mobile data in a total of 11 packets among the 38 packets allocated to normal data,

2) a second mode disposing new mobile data to a total of 20 packets among the 38 packets allocated to normal data,

3) a third mode disposing new mobile data to a total of 29 packets among the 38 packets allocated to normal data,

4) a fourth mode disposing new mobile data in the entirety of 38 packets allocated to normal data, and

5) a fifth mode disposing new mobile data in the entirety of the 38 packets allocated to normal data and an area corresponding to an MPEG header and parity among the area allocated to existing mobile data.

Of these, the first mode is denoted as scalable mode 000, the second mode is denoted as scalable mode 001, the third mode is denoted as scalable mode 010, the fourth mode, that is the mode where mobile data must be filled in the 38 packets and compatibility should be considered is denoted scalable mode 011, and the fifth mode that is the mode where mobile data is filled in the 38 packets and compatibility need not be considered is denoted as scalable mode 111.

Besides, in order to define additional group formats, it is possible to allocate the bit value of a scalable mode or add a signaling bit.

The digital broadcast receiver according to various exemplary embodiments may dispose the existing mobile data, new mobile data, and normal data inside a stream and transmit the same according to various methods.

For example, in the configuration of FIG. 4, the group formatter 130 disposed inside the data preprocessor 100 formats the stream in group units as the group formatter 130 adds the base data, signaling data and initialization data to the stream processed in the block processor 120.

Accordingly, when the packet formatter 140 performs packet formatting, the mux 200 performs muxing. In this case, in the case of first to third modes, the mux 200 muxes the normal data processed in the normal processor 320 as well. On the other hand, in the case of fourth and fifth modes, the normal processor 320 does not output any normal data, and the mux 200 directly outputs the stream provided by the packet formatter 140.

[Digital Broadcast Receiver]

As aforementioned, the digital broadcast transmitter may transmit new mobile data using a portion or the entirety of the packets allocated to normal data among the existing stream configuration and a portion or entirety of the packets allocated to the existing mobile data.

The digital broadcast receiver which receives the above may receive at least one of the existing mobile data, normal data, and new mobile data and process the received data according to the version thereof.

That is, an existing digital broadcast receiver for normal data processing use may check the signaling data, and detect and decode the normal data. As aforementioned, in the case of a stream consisting of a mode where normal data is not included at all, the receiver for normal data processing use becomes unable to provide normal data services.

The digital broadcast receiver for 1.0 version use may check the signaling data and detect and decode the existing mobile data when a stream of various structures as aforementioned is received. In the case where mobile data for 1.1 version use is disposed in the entire areas, the digital broadcast receiver for 1.1 version use may not be able to provide mobile services.

On the other hand, the digital broadcast receiver for 1.1 version use may detect and process not only data for 1.1 version use but also data for 1.0 version use. In this case, when there is provided a decoding block for normal data processing, normal data services may also be provided.

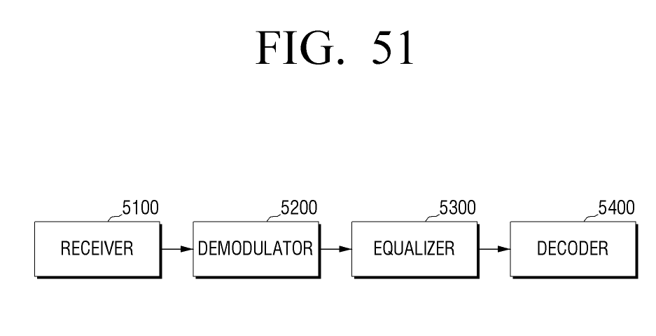

FIG. 51 is a block diagram illustrating an example of a configuration of a digital broadcast receiver according to an exemplary embodiment. The digital broadcast receiver may be embodied in a format where the configurative elements corresponding to various transmitter configurations are disposed in a reverse order, but for convenience of explanation, FIG. 51 only illustrates configurative elements essential to receiving.

That is, according to FIG. 51, the digital broadcast receiver includes a receiver 5100, demodulator 5200, equalizer 5300, and decoder 5400.

The receiver 5100 receives the transport stream transmitted from the digital broadcast transmitter through an antenna, cable, etc.

The demodulator 5200 demodulates the transport stream received through the receiver 5100. A frequency, clock signal, etc., of the signal received through the receiver 5100 are synchronized with the digital broadcast transmitter through the demodulator 5200.

The equalizer 5300 equalizes the demodulated transport stream.

The demodulator 5200 may perform the synchronization and equalization more quickly using base data included in the transport stream, especially, the base data added together with the new mobile data.

The decoder 5400 detects mobile data inside the equalized transport stream and decodes the detected mobile data.

The inserting location and size of the mobile data and base data may be notified by the signaling data included inside the transport stream or signaling data received through an additional channel.

The decoder 5400 may use the signaling data to check the location of the mobile data appropriate to the digital broadcast receiver, and then detect the mobile data at that location and decode the detected mobile data.

The configuration of the decoder 5400 may be embodied in various ways according to exemplary embodiments.

That is, the decoder 5400 may include two decoders containing a trellis decoder (not illustrated) and a convolutional decoder (not illustrated). The two decoders may improve the performance while performing mutual decoding reliability information exchange. Of these, the output of the convolutional decoder may be the same as an input of the RS encoder at the transmitter side.

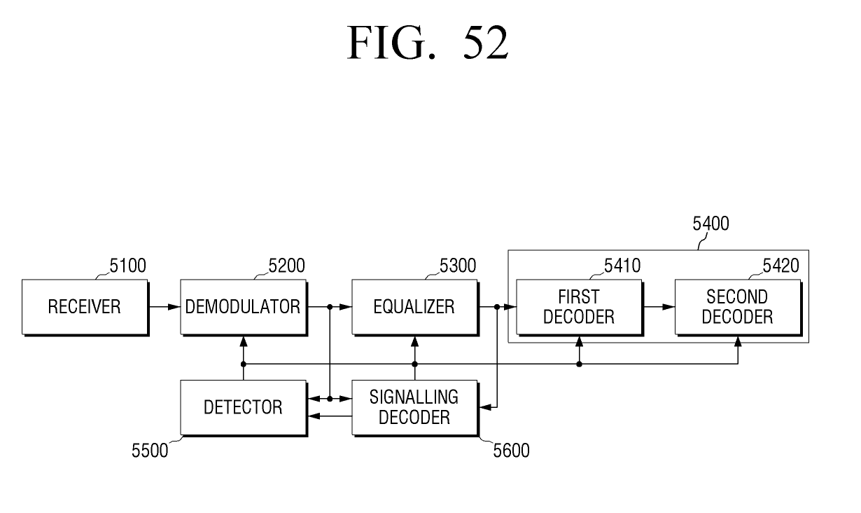

FIG. 52 is a block diagram illustrating an example of a detailed configuration of a digital broadcast receiver according to an exemplary embodiment.

According to FIG. 52, the digital broadcast receiver may include a receiver 5100, demodulator 5200, equalizer 5300, decoder 5400, detector 5500, and signaling decoder 5600.

Functions of the receiver 5100, demodulator 5200, and equalizer 5300 are the same as in FIG. 51 and thus a detailed explanation thereof is omitted.

The decoder 5400 may include the first decoder 5410 and second decoder 5420.

The first decoder 5410 performs decoding regarding at least one of the existing mobile data and new mobile data. The first decoder 5410 may perform SCCC decoding of decoding in block units.

The second decoder 54320 performs RS decoding regarding the stream decoded in the first decoder 5410.

The first and second decoders 5410, 5420 may use the output value of the signaling decoder 5600 and process the mobile data.

That is, the signaling decoder 5600 may detect and decode the signaling data contained in the stream. More specifically, the signaling decoder 5600 demuxes the reserved area, or TPC information area, or FIC information area, etc., inside the field sync data from the transmission stream. Accordingly, the signaling decoder 5600 may convolutionally decode and RS decode the demuxed portion, and then reverse randomize the same to restore the signaling data. The restored signaling data is provided to each configurative element inside the digital broadcast receiver, that is, the demodulator 5200, equalizer 5300, decoder 5400, and detector 5500. In the signaling data, various types of information that these configurations will use, that is, block mode information, mode information, base data insertion pattern information, frame mode, etc., may be included. Types and functions of this information has been explained in detail in the aforementioned portion, and thus detailed explanation thereof is omitted.

Besides the above, various information such as the coding rate, data rate, inserting location of the mobile, type of the user error correction code, information of the primary service, information necessary for supporting time slicing, description on the mobile data, information related to changing the mode information, and information for IP service support may be provided in the receiver side in a format of signaling data or other additional data format.

In the description of FIG. 52, signaling data was described as being included in the stream, but in the case where a signaling data signal is transmitted through an additional provided channel, the signaling decoder 5600 may decode such a signaling data signal and process the added base data together.

More specifically, the base data may be inserted in various locations and formats in one area of the body area and head/tail area of mobile, as illustrated in FIGS. 22 to 36. The information on the insertion pattern, that is, location, starting point, and length of the base data may be included in the signaling data. The detector 5500 may detect the base data in an appropriate location according to the signaling data and provide the detected base data to the demodulator 5200, equalizer 5300 and decoder 5400 etc.

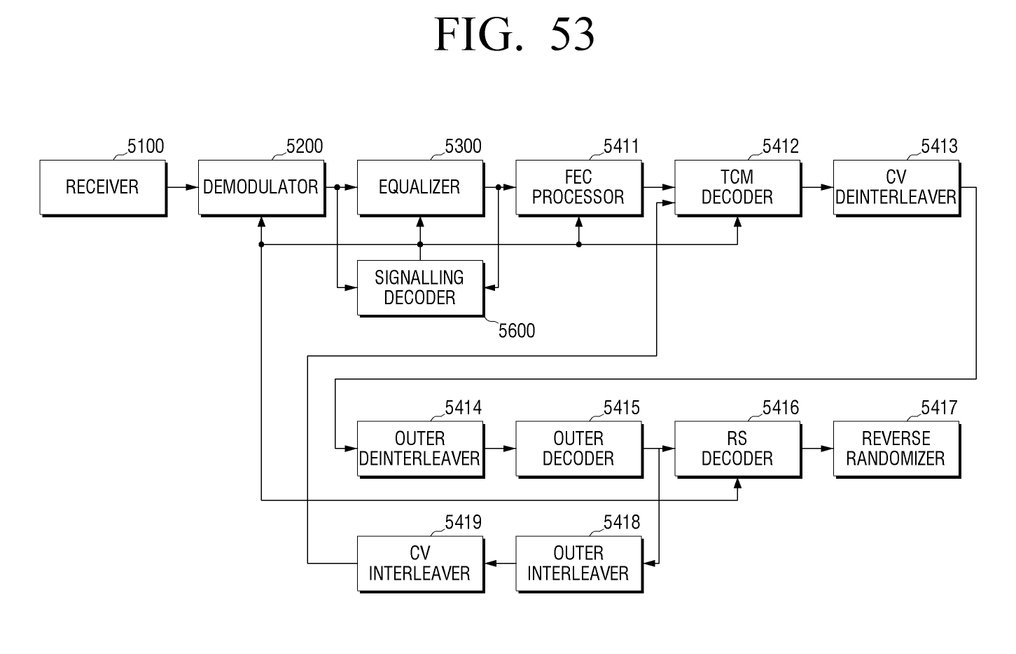

FIG. 53 is a view illustrating a detailed configuration of a digital broadcast receiver according to another exemplary embodiment.

According to FIG. 53, the digital broadcast receiver includes a receiver 5100, demodulator 5200, equalizer 5300, FEC processor 5411, TCM decoder 5412, CV deinterleaver 5412, outer deinterleaver 5414, outer decoder 5415, RS decoder 5416, reverse randomizer 5417, outer interleaver 5418, CV interleaver 5419, and signaling decoder 5600.

The receiver 5100, demodulator 5200, equalizer 5300, signaling decoder 5600, etc., were explained in FIG. 52, and thus a repeated explanation thereof is omitted. Unlike in FIG. 52, an illustration of the detector 5500 is omitted. That is, in the present exemplary embodiment, each configurative element may directly detect the base data using the signaling data decoded in the decoder 5600.

The FEC processor 5411 performs a forward direction error correction on the transport stream equalized in the equalizer 5300. The FEC processor 5411 may use the information on the location or insertion pattern of the base data among the information provided from the signaling decoder 5600 to detect the base data inside the transport stream and use the detected base data in the forward direction error correction. Otherwise, depending on the exemplary embodiment, an additional reference signal may not be used in a forward direction error correction.

In FIG. 53, each configurative element is disposed in a format where a decoding regarding mobile data is made after FEC processing is made. That is, it is a format where FEC processing on the entirety of the transport stream is made. However, it may also be embodied in a format where only mobile data is detected among the transport stream and then FEC is performed only regarding the mobile data.

TCM decoder 5412 detects mobile data among the transport stream output from the FEC processor 5411 and performs a trellis decoding. In this case, if the FEC processor 5411 already detected mobile data and performed a forward direction error correction only regarding that portion, the TCM decoder 5412 may directly perform a trellis decoding on the input data.

CV deinterleaver 5413 performs a convolutional deinterleaving on the trellis decoded data. As aforementioned, the configuration of the digital broadcast receiver corresponds to the configuration of the transport stream and the configuration of the processed digital broadcast transmitter, and thus, depending on the structure of the transmitter, a CV deinterleaver 5313 may not be needed.

The outer deinterleaver 5414 performs an outer deinterleaving on the data which received a convolutional deinterleaving. Next, the outer decoder 5415 performs decoding to remove the parity added to the mobile data.

In some cases, it is possible to repeatedly perform the process from the TCM decoder 5412 to the outer decoder 5415 at least once and improve the receiving performance of mobile data. To perform the process repeatedly, the decoding data of the outer decoder 5415 may go through the outer interleaver 5418 and CV interleaver 5419 and be provided to the TCM decoder 5412. Herein, the CV interleaver 5419 may not be necessary depending on the structure of transmitter.

As such, the trellis decoded data is provided to the RS decoder 5416. The RS decoder 5416 RS decodes the provided data, and the reverse randomizer 5417 may perform reverse randomization. After such a process, the stream on the mobile data, especially, on the newly defined 1.1 version data may be processed.

As aforementioned, when the digital broadcast receiver is for 1.1 version use, besides the 1.1 version data, 1.0 version data may also be processed.

That is, at least one of the FEC processor 5411 and TCM decoder 5412 may detect the entirety of the mobile data besides normal data and perform processing.

In addition, when the digital broadcast receiver is a common use receiver, the digital broadcast receiver may have the block for normal data processing, the block for 1.0 version data processing, and the block for 1.1 version data processing. In this case, as a plurality of processing paths are provided at the rear end of the equalizer 5300, and each of the aforementioned blocks is disposed in each processing path, and at least one processing path is selected according to a control of the additionally provided controller (not illustrated), data appropriate to a transmission stream may be included.

In addition, as aforementioned, in the transport stream, mobile data may be disposed in different patterns per slot. That is, various slots such as a first format slot where normal data is directly included, a second format slot where new mobile data is included in the entirety of the normal data, a third format slot where new mobile data is included in a portion of the normal data area, and a fourth format slot where new mobile data is included in the normal data area and the entirety of the existing mobile area may be repeatedly configured according to the predetermined pattern.

The signaling decoder 5600 decodes the signaling data and notifies frame mode information or mode information to each configurative element. Therefore, each configurative element, especially the FEC processor 5411 or TCM decoder 5412, may detect mobile data at a determined location regarding each slot and process the detected mobile data.

In FIGS. 51 to 53, illustration on the controller is omitted, but the signaling decoder 5600 may further include a controller configured to apply an appropriate control signal to each block using the decoded signaling data. This controller may control the tuning operation of the receiver 5100 according to the user's selection.

In the case of a receiver for 1.1 version use, according to the user's selection, 1.0 version data or 1.1 version data may be selectively provided. In addition, when a plurality of 1.1 version data are provided, one of the services may be provided according to the user's selection.

Especially, as aforementioned, as in the first to fourth modes (herein, first to fourth modes may all be compatibility modes, and only the fourth mode may be an incompatibility mode) or the first to fifth modes, at least one of the normal data and existing mobile, new mobile data may be disposed in the stream and be transmitted.

In this case, the digital broadcast receiver may detect each type of data in an appropriate location according to the mode and apply a decoding method to perform decoding.

More specifically, in an exemplary embodiment where the mode is expressed in two bits and a TPC signaling field reading 00, 01, 10, 11 is restored, when a 11 value is confirmed in the signaling data, the digital broadcast receiver checks the TPC of not only the slots containing an M/H group of the M/H parade to be received but also other slots. Accordingly, when the mode information of all slots is 11, and there is no CMM slot, it is determined that the fourth mode is determined as an incompatibility mode. Accordingly, the digital broadcast receiver may decode the MPEG header and parity area, for example, the aforementioned SB5 area where new mobile data is disposed in the same method as the remaining body area stream. When the scalable mode of all slots is not 11 or when a CMM slot exists, it is determined that the determined mode is a compatibility mode, that is, a scalable mode 11a, and decodes the MPEG header and parity area, that is, SB5 area, in a decoding method different from the remaining body area stream, using a method corresponding to the coding method of the new mobile data. TPC checking and mode checking of each slot may be performed in the signaling decoder or additionally provided controller.

Meanwhile, in an exemplary embodiment where a mode is expressed in three bits and signaling bits of 000, 001, 010, 011, and 111 are transmitted, the digital broadcast receiver checks the mode according to the bit value and performs a decoding corresponding thereto.

The digital broadcast receiver may combine the normal data, existing mobile data, and new mobile data, configure a transport stream and then transmit the transport stream.

Accordingly, the digital broadcast receiver which receives and processes the transport stream may be embodied in various formats, that is a receiver for normal data use capable of processing only the normal data, a receiver for existing mobile data use capable of processing only the existing mobile data, a receiver for new mobile data use capable of processing only new mobile data, and a common use receiver capable of processing at least two of the above data.

In the case of a receiver for normal data use, as aforementioned, unlike the fourth mode having compatibility with the first mode, there is no data to be processed in the fourth mode or fifth mode which does not have compatibility. Therefore, the digital broadcast receiver may disregard the transport stream which the digital broadcast receiver cannot recognize and process.

In the case of a receiver for existing mobile data use and a common use receiver capable of processing the existing mobile data and normal data together, for normal data processing, normal data included in the slots consisting of only normal packets or the entirety or a portion of the 38 packets is decoded, whereas for existing mobile data processing, existing mobile data included in the packets other than the 38 packets is detected and decoded. Especially, in the case of a slot where new mobile data is included, as aforementioned, when the block mode is separate, the primary ensemble portion is filled with new mobile data, and thus it is possible to transmit the existing data and new mobile data in one slot. Therefore, when the mode is a scalable mode 11, the receiver decodes the remaining body area besides SB 5 in order to process the existing mobile data. Meanwhile, when the mode is the scalable mode 11a, since SB 5 is not filled with new mobile data, the receiver decodes the entire body area to process the existing mobile data. Meanwhile, when the block mode is paired, the entirety of the block is filled with only 1.1 mobile data, and thus, in the case of processing the existing mobile data, the receiver disregards the corresponding slot.

Also, in the case of a receiver for new mobile data use or a common use receiver which may process the new mobile data and other data together, decoding is performed according to the block mode and mode. That is, when the block mode is separate, when the mode is scalable mode 11, the independent block of SB5 and the block where new mobile data is allocated are decoded in a decoding method in accordance with the coding method of the new mobile data, and when the mode is scalable mode 11a, the block where new mobile data is allocated is decoded in a decoding method in accordance with the coding method of new mobile data. When the block mode is paired, the entirety of the block may be decoded.

In FIGS. 11 to 53, an additionally provided controller or signaling decoder, etc., may check the block mode and mode and control the decoding as aforementioned. Especially, in the case where there are two bits denoting the mode among the signal data, when a bit value of 11 is transmitted, the controller or signaling decoder may check not only the TPC of the slot where the M/H group of the M/H parade to be received is included but also the TPC of other slots. Accordingly, when it is confirmed that the normal data rate is 0 Mbps, it may be determined that a bit value of 11 is scalable mode 11 and may be decoded. Meanwhile, when the scalable mode of all slots is not 11 or a CMM slot exists, that is, when the normal data rate is not 0 Mbps, a bit value 11 may be determined as scalable mode 11a and may be decoded.

The digital broadcast receiver of FIGS. 51 to 53 may be embodied in a set top box or TV, but also in various types of apparatuses that are portable, such as a PDA, an MP3 player, electronic dictionary, notebook, etc. In addition, although not illustrated in FIGS. 51 to 53, it is also a matter of course that the decoded result data may be scaled or converted to include the configurative elements output on the screen in a sound or image data format.

The stream configuration method of the digital broadcast receiver and the stream processing method of the digital broadcast receiver according to exemplary embodiments may be explained using the aforementioned block diagram and stream configuration diagram.

That is, the stream configuration method of the digital broadcast receiver may include a step of disposing mobile data in at least one portion of the packets allocated to the normal data among the entire group of packets forming the stream and a step of forming the stream by inserting normal data into the stream where mobile data is disposed.

The step of disposing mobile data may be performed by the data preprocessor 100 illustrated in FIGS. 2 to 4.

The mobile data may be disposed independently or together with the normal data and existing mobile data in various locations, as in the aforementioned various exemplary embodiments. That is, mobile data and base data may be disposed in various ways as in FIGS. 15 to 40.

In addition, the stream forming step muxes the normal data processed separately from mobile data together with the mobile data and forms a transport stream.

The formed transport stream is transmitted to the receiver side after going through various processes of RS encoding, interleaving, trellis encoding, sync muxing, demodulating, etc. Processing of the transport stream may be made by various configurative elements of the digital broadcast receiver illustrated in FIG. 4.

The various exemplary embodiments of the stream configuration method relate to the various operations of the aforementioned digital broadcast transmitter. Therefore, the flowchart regarding the stream configuration method omitted an illustration on those operations.

The stream processing method of the digital broadcast receiver according to an exemplary embodiment of the present disclosure is divided into the first area allocated to existing mobile data and the second area allocated to normal data, and may include a step of receiving a transport stream containing mobile data disposed separately from existing mobile data, demodulating the received transport stream, equalizing the demodulated transport stream, and decoding at least one of the existing mobile data and data for mobile use from the equalized transport stream.

The transport stream being received in this method may be the transport stream configured and transmitted in the digital broadcast transmitter according to various exemplary embodiments. That is, the transport stream may have a format where mobile data is disposed in various ways, as illustrated in FIGS. 15 to 21, and FIGS. 29 to 40. In addition, the base data may also be disposed in various formats as illustrated in FIGS. 22 to 28.

Various exemplary embodiments of the stream processing method relate to various exemplary embodiments of the aforementioned digital broadcast receiver. Therefore, an illustration on the flowchart of the stream processing method is also omitted.

The configuration examples of the streams as illustrated in FIGS. 16 to 40 are not fixed, but may be switched to different configurations depending on situations. That is, the data preprocessor 100 may apply various frame modes, modes, block modes, etc., and dispose mobile data and base data, and perform block coding by a control signal input from the control signal applied by the separately provided controller or a control signal input from outside. Accordingly, the digital broadcast operator becomes able to provide the wanted data, especially, mobile data in various sizes.

In addition, the aforementioned new mobile data, that is, 1.1 version data, may be the same data as the existing mobile data, that is, the same data as 1.0 version data, or a different data input from other sources. In addition, a plurality of 1.1 version data may be included in one slot and transmitted. Accordingly, the user of the digital broadcast receiver becomes able to view various types of data.

Block Processing Method>

The aforementioned various exemplary embodiments may be changed in various ways.

For example, the block processor 120 of the aforementioned FIG. 4 appropriately combines the existing mobile data, normal data, new mobile data, and base data disposed inside the stream and performs block coding. Herein, the new mobile data and base data may be disposed in not only at least a portion of the normal data area which is allocated regarding existing mobile data, but also in at least a portion of the existing mobile data area. That is, the new mobile data and base data may be at a state where normal data, new mobile data, and existing mobile data are mixed therein.

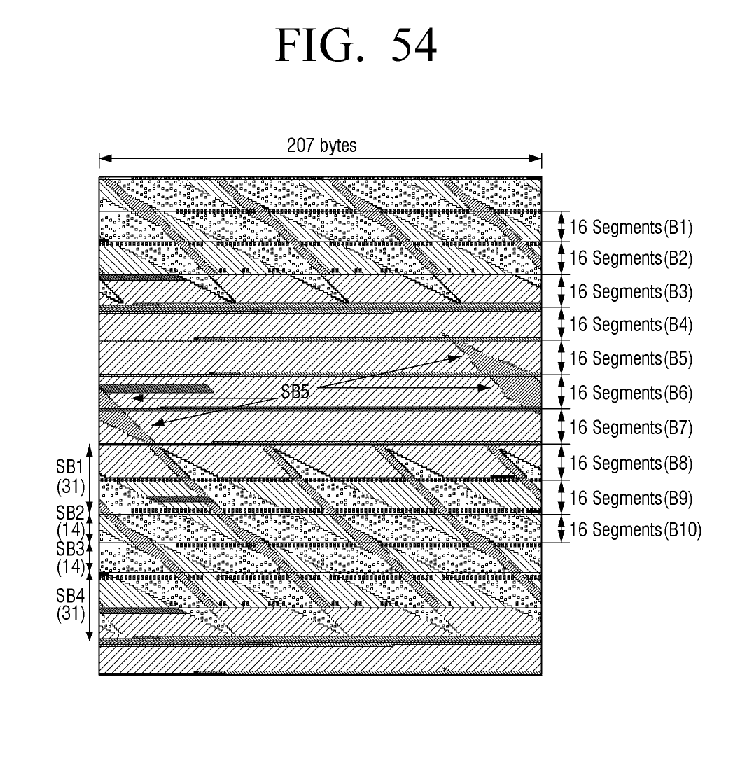

FIG. 54 illustrates an example of a stream format after interleaving. According to FIG. 54, the stream containing the mobile data group consists of 208 data segments. Of these, the first 5 segments correspond to the RS parity area and are thus excluded from the mobile data group. Accordingly, the mobile data group of a total of 203 data segments is divided into 15 mobile data blocks. More specifically, B1 to B10, and SB1 to SB5 blocks are included. Of these, blocks B1 to B10 may correspond to the mobile data disposed in the existing mobile data area as illustrated in FIG. 8. Blocks SB1 to SB5 may correspond to the new mobile data allocated to the existing normal data area. SB5 includes the MPEG header and RS parity for backward compatibility.

Each of B1 to B10 consists of 16 segments, each of SB1 and SB4 may consist of 31 segments, and each of SB2 and SB3 may consist of 14 segments.

These blocks, that is B1˜B10 and SB1˜SB5 may be combined in various formats and be block coded.

That is, as aforementioned, the block mode may be set in various ways such as 00, 01, etc. For each SCB block, when the block mode is set as “00”, the SOBL (SCCC Output Block Length) and SIBL (SCCC Input Block Length) regarding each SCB block are as follows:

TABLE 10

SCCC Block

SIBL

| | SOBL | 1/2 rate | 1/4 rate |
|---|---|---|---|
| SCB1 (B1) | 528 | 264 | 132 |
| SCB2 (B2) | 1536 | 768 | 384 |
| SCB3 (B3) | 2376 | 1188 | 594 |
| SCB4 (B4) | 2388 | 1194 | 597 |
| SCB5 (B5) | 2772 | 1386 | 693 |
| SCB6 (B6) | 2472 | 1236 | 618 |
| SCB7 (B7) | 2772 | 1386 | 693 |
| SCB8 (B8) | 2508 | 1254 | 627 |
| SCB9 (B9) | 1416 | 708 | 354 |
| SCB10 (B10) | 480 | 240 | 120 |

According to table 10, it can be seen that B1 to B10 become SCB1 to SCB10.

Meanwhile, for each SCB block, when the block mode is set as “01”, the SOBL (SCCC Output Block Length) and SIBL (SCCC Input Block Length) regarding each SCB block can be summarized as follows:

TABLE 11

SCCC Block

SIBL

| | SOBL | 1/2 rate | 1/4 rate |
|---|---|---|---|
| SCB1 (B1 + B6) | 3000 | 1500 | 750 |
| SCB2 (B2 + B7) | 4308 | 2154 | 1077 |
| SCB3 (B3 + B8) | 4884 | 2442 | 1221 |
| SCB4 (B4 + B9) | 3804 | 1902 | 951 |
| SCB5 (B5 + B10) | 3252 | 1626 | 813 |

According to table 11, it can be seen that B1 and B6 are combined to form one SCB1, and that B2 and B7, B3 and B8, B4 and B9, and B5 and B10 are combined to form SCB2, SCB3, SCB4, SCN5, respectively. In addition, it can be seen that the input block length appears differently depending on whether or not it is 1/2 rate, or 1/4 rate.

Combining each of B1 to B10 and forming SCB block as aforementioned may be an operation when new mobile data is not disposed, that is, an operation in CMM mode.

In the SFCMM mode where new mobile date is disposed, each block may be combined differently and form the SCB block. That is, existing mobile data and new mobile data may be combined together to form an SCC block coding. Tables 12 and 13 below illustrate examples of blocks differently combined according to the RS frame mode and slot mode.

TABLE 12

| | RS Frame Mode | | | |
|---|---|---|---|---|
| | 00 | | 01 | |
| | SCCC Block Mode | | | |
| | 00 | 01 | 00 | 01 |
| Description | Separate SCCC | Paired SCCC | Separate SCCC | Paired SCCC |
| | Block Mode | Block Mode | Block Mode | Block Mode |
| SCB | SCB input, | SCB input, | SCB input, | SCB input, |
| | M/H Blocks | M/H Blocks | M/H Blocks | M/H Blocks |
| SCB1 | B1 | B1 + B6 + SB3 | B1 | B1 + SB3 + |
| | | | | B9 + SB1 |
| SCB2 | B2 | B2 + B7 + SB4 | B2 | B2 + SB4 + |
| | | | | B10 + SB2 |
| SCB3 | B3 | B3 + B8 | B9 + SB1 | |
| SCB4 | B4 | B4 + B9 + SB1 | B10 + SB2 | |
| SCB5 | B5 | B5 + B10 + SB2 | SB3 | |
| SCB6 | B6 | | SB4 | |
| SCB7 | B7 | | | |
| SCB8 | B8 | | | |
| SCB9 | B9 + SB1 | | | |
| SCB10 | B10 + SB2 | | | |
| SCB11 | SB3 | | | |
| SCB12 | SB4 | | | |

In table 12, RS frame mode refers to information for notifying whether or not one ensemble is included inside one slot (when RS frame mode is 00), or whether or not a plurality of ensembles such as the primary ensemble and secondary ensemble are included in one slot (when RS frame mode is 01). In addition, SCCC block mode refers to information for showing whether or not the mode is a mode for performing an individual SCCC block processing or a mode of combining a plurality of blocks and performing SCCC block processing as in the aforementioned block mode.

Table 12 illustrates a case where the slot mode is 00. Slot mode is information showing the criteria dividing the start and end of the slot. That is, when the slot mode is 00, this indicates that the mode is a mode where the portion including B1 to B10 and SB1 to SB5 regarding the same slot is classified as one slot, and when the slot mode is 01, this indicates that the mode is a mode where a portion consisting of a total of 15 blocks configured by sending B1 and B2 to the previous slot and including B1 and B2 of subsequence slots into the current slot is classified as one slot. A slot mode may be called various names according to the version of the standard document. For example, the slot mode may be called a block extension mode. This will be explained in more detail hereinbelow.

According to table 12, when the RS frame mode is 00, and SCCC block mode is 00, B1 to B8 are used as SCB1 to SCB8, B9 and SB1 are combined to form SCB9, B10 and SB@ are combined to form SCB10, and SB3 and SB4 are used as SCB11 and SCB12, respectively. When the SCCC block mode is 01, B1, B6, SB3 are combined to be used as SCB1, B2+B7+SB4 are used as SB2, and B3+B8, B4+B9+SB1, B5+B10+SB2 are used as SCB3, SCB4, SCB5, respectively.

In the case where the RS frame mode is 01, when the SCCC block mode is 00, B1, B2, B9+SB1, B10+SB2, SB3, SB4 are used as SCB1 to SB6, respectively. In addition, when the SCCC block mode is 01, B1+SB3+B9+SB1 is used as SB1, and B2+SB4+B10+SB2 is used as SCB2.

Besides the above, when the slot mode is 01, and the new mobile data is disposed according to the aforementioned first, second, and third modes, the SCCC block may be combined as in the following table.

TABLE 13

| | RS Frame Mode | | | |
|---|---|---|---|---|
| | 00 | | 01 | |
| | SCCC Block Mode | | | |
| | 00 | 01 | 00 | 01 |
| Description | Separate SCCC | Paired SCCC | Separate SCCC | Paired SCCC |
| | Block Mode | Block Mode | Block Mode | Block Mode |
| SCB | SCB input, | SCB input, | SCB input, | SCB input, |
| | M/H Blocks | M/H Blocks | M/H Blocks | M/H Blocks |
| SCB1 | B1 + SB3 | B1 + B6 + SB3 | B1 + SB3 | B1 + SB3 + |
| | | | | B9 + SB1 |
| SCB2 | B2 + SB4 | B2 + B7 + SB4 | B2 + SB4 | B2 + SB4 + |
| | | | | B10 + SB2 |
| SCB3 | B3 | B3 + B8 | B9 + SB1 | |
| SCB4 | B4 | B4 + B9 + SB1 | B10 + SB2 | |
| SCB5 | B5 | B5 + B10 + SB2 | | |
| SCB6 | B6 | | | |
| SCB7 | B7 | | | |
| SCB8 | B8 | | | |
| SCB9 | B9 + SB1 | | | |
| SCB10 | B10 + SB2 | | | |

According to table 13, B1 to B10 and SB1 to SB5 may be combined in various methods according to the setting state of the RS frame mode and SCCC block mode.

When the slot mode is 01 and the new mobile data is disposed in the entirety of the aforementioned fourth mode, the SCB block may be configured in various combinations as in the table below.

TABLE 14

| | RS Frame Mode | | | |
|---|---|---|---|---|
| | 00 | | 01 | |
| | SCCC Block Mode | | | |
| | 00 | 01 | 00 | 01 |
| Description | Separate SCCC | Paired SCCC | Separate SCCC | Paired SCCC |
| | Block Mode | Block Mode | Block Mode | Block Mode |
| SCB | SCB input, | SCB input, | SCB input, | SCB input, |
| | M/H Blocks | M/H Blocks | M/H Blocks | M/H Blocks |
| SCB1 | B1 + SB3 | B1 + B6 + | B1 + SB3 | B1 + SB3 + |
| | | SB3 + SB5 | | B9 + SB1 |
| SCB2 | B2 + SB4 | B2 + B7 + SB4 | B2 + SB4 | B2 + SB4 + |
| | | | | B10 + SB2 |
| SCB3 | B3 | B3 + B8 | B9 + SB1 | |
| SCB4 | B4 | B4 + B9 + SB1 | B10 + SB2 | |
| SCB5 | B5 | B5 + B10 + SB2 | | |
| SCB6 | B6 + SB5 | | | |
| SCB7 | B7 | | | |
| SCB8 | B8 | | | |
| SCB9 | B9 + SB1 | | | |
| SCB10 | B10 + SB2 | | | |

As such, the existing mobile data, normal data, and new mobile data may be classified in blocks, and each block may be combined in various ways per mode and configure the SCCC block. Accordingly, the configured SCCC blocks are combined together for the RS frame.

As aforementioned, combining and coding of a block may be performed inside the data preprocessor 100 illustrated in the aforementioned various exemplary embodiments. More specifically, the block processor 120 inside the data preprocessor 100 may combine the blocks to perform block coding. An explanation on other processing besides the combining method has already been disclosed in the exemplary embodiments mentioned above, and thus a repeated explanation thereof is omitted.

The coding rate that codes the SCCC block, that is, the SCCC outer code rate, may be determined differently according to the outer code mode. More specifically, the coding rate may be summarized as in the table below.

TABLE 15

| SCCC outer code mode | Description |
|---|---|
| 00 | The outer code rate of a |
| | SCCC Block is 1/2 rate |
| 01 | The outer code rate of a |
| | SCCC Block is 1/4 rate |
| 10 | The outer code rate of a |
| | SCCC Block is 1/3 rate |
| 11 | Reserved |

As disclosed in table 15, the SCCC outer code mode may be set in various ways as 00, 01, 10, 11. In the case of 00, the SCCC block may be coded by 1/2 code rate, in the case of 01, by 1/4 code rate, and in the case of 10, by 1/3 code rate. Such code rates may be changed in various ways according to the version of the standard. Newly added code rates may be applied to the SCCC outer code mode 11. The matching relationship between the aforementioned SCCC outer code mode and the code rate may be changed. The data preprocessor 100 may code the SCCC block with an appropriate code rate according to the setting state of the outer code mode. The setting state of the outer code mode may be notified from the controller 310 of other configurative elements or may be checked through an additional signaling channel. The 1/3 code rate receives 1 bit and outputs 3 bits, and the format of the encoder may be configured in various ways. For example, the format of the encoder may be configured in a combination of 1/2 code rate and 1/4 code rate, and it is also possible to puncture the output of the 4-state convolutional encoder.

[Block Extension Mode: BEM]

As aforementioned, the method of coding blocks existing inside a slot changes according to the slot mode or block extension mode. As aforementioned, when the block extension mode is 00, this indicates that the portion including B1 to B10 and SB1 to SB5 regarding the same slot is classified as one slot, and when the block extension mode is 01, this indicates that the mode is a mode where a portion consisting of a total of 15 blocks after sending B1 and B2 to the previous slots and including B1 and B2 of the subsequent slot in the current slot is classified as one slot.

It is possible to classify the group region per block inside the slot. For example, the four blocks B4 to B7 may be called group region A, two blocks B3 and B8 may be called group region B, two blocks B2 and B9 may be called group region C, and two blocks B1 and B10 may be called group region D. In addition, four blocks SB1 to SB4 appearing when the 38 packets which constitute the normal data area are interleaved may be called group region E.

When the block extension mode of an arbitrary slot is 01, group region A and B consisting of blocks B3 to B8 may be called a primary ensemble. It is possible to send the blocks B1 and B2 to the previous slots, and include blocks B9 and B10, blocks SB1 to SB4, and B1 and B2 of the subsequent slot into B2, and define group region C, D, E as the new secondary ensemble. It is possible to fill the head/tail area with long training data of a length corresponding to one data segment similarly with the primary, and an advantage is that the receiving performance of the head/tail area may be improved up to the same level as the receiving performance as the body area.

When the block extension mode of an arbitrary slot is 00, the primary ensemble is the same as the case of BEM 01, but there is a difference in the secondary ensemble. Blocks B1 and B2, blocks B9 and B10, and blocks SB1 to SB4 of the current slot may be included and be defined as the secondary ensemble. Unlike the primary, the head/tail area has a saw shape, and thus it is impossible to fill with long training data. Thus, the receiving performance of the head/tail area deteriorates as compared to the body area.

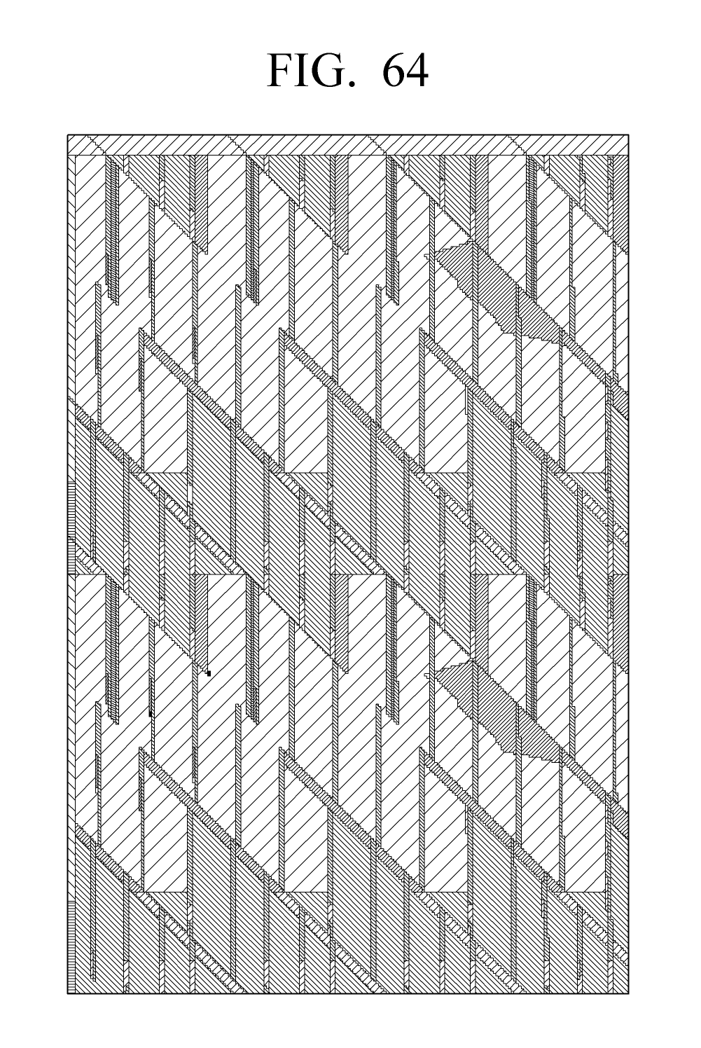

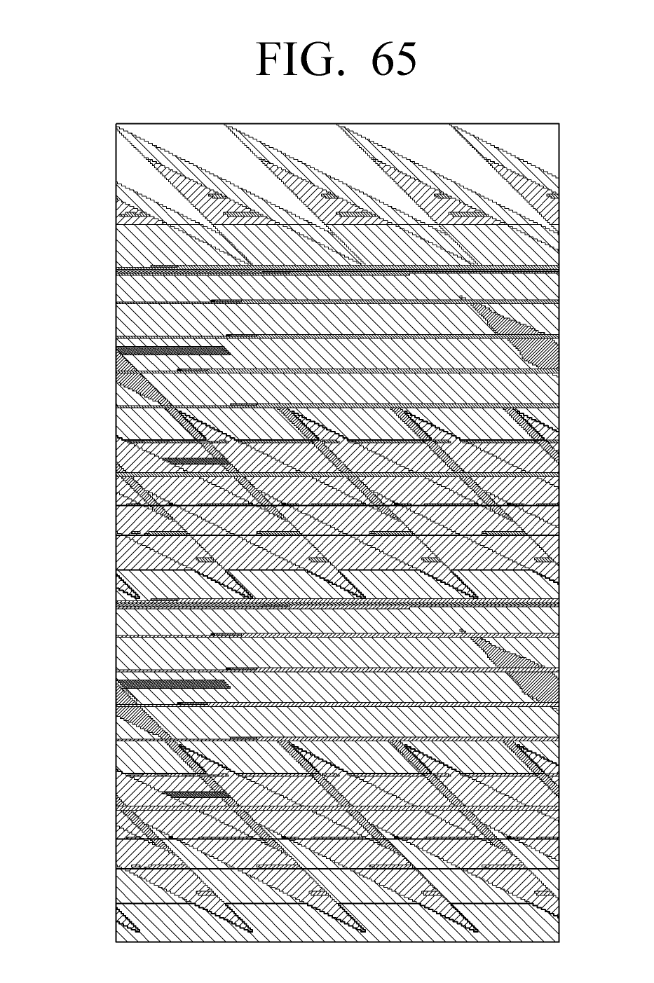

When two arbitrary slots approach in BEM 00 mode, long training data may be filled in a portion where saw shaped head/tail areas cross and meet one another. As illustrated in FIGS. 64 and 65, as each group of the segmented training data is connected in the area where two slots of BEM 00 mode approach and meet each other, it becomes consequently possible to create a long training of the same length as one data segment. In FIGS. 64 and 65, trellis encoder initialization byte location and base known byte location are displayed.

When configuring the M/H frame according to the service type, the slot filled with new mobile data (SFCMM Slot) may be disposed adjacently with slots filled with 156 packets (Full Main Slot) with only the CMM Slot filled with existing mobile data or normal data. Herein, when the BEM mode of SFCMM Slot is 00, even when CMM Slot or Full Main Slot is disposed as an adjacent slot, combining is possible without difficulty. Among 16 slots inside the M/H sub-frame, assuming a case where BEM 00 slot is disposed in Slot #0 and CMM Slot is disposed in Slot#1, a block coding is made by a combination of the blocks B1 to B10 and blocks SB1 to SB4 inside Slot #0, and a block coding for Slot#1 is made by a combination of blocks B1 to B10.

In the case where the BEM mode of the SFCMM Slot is 01, when a CMM slot or Full Main Slot is disposed as an adjacent slot, the orphan region must be considered. An orphan region refers to an area that cannot be easily used in any slot as a plurality of different slots is continuously disposed.

For example, assuming a case where, among the 16 slots inside the M/H sub-frames, BEM 01 slot is disposed in Slot#0 and CMM slot is disposed in Slot#1, a block coding is made by sending blocks B1 and B2 inside Slot#0 to the previous slot, and including blocks B3 to B10 and SB1 to SB4 and B1 and B2 of the subsequent slot. That is, the two slots filled with mobile data 1.0 and mobile data 1.1 that do not have compatibility with each other should be made not to interfere with each other according to the block coding method of BEM 01.

The slot where BEM is 00 and the slot where BEM is 01 may be set not to be combined together and used. In the case of BEM 01, the CMM mode, BEM01 mode, and full main mode slot may be combined together and used. In this case, the area which is difficult to use due to a difference of modes may be regarded as an orphan area and may be utilized.

[Orphan Region]

The area of an orphan region that prevents interference between two slots changes according to which type of slot the slot having BEM 01 is adjacent to and according to the order of slot.

First of all, in the case where an (i)th slot is a CMM slot and the subsequent slot (i+1)th slot is BEM 01 slot, the blocks B1 and B2 existing in the head area of BEM01 slot are sent to the previous slot. However, since a CMM slot is not block coded using the blocks B1 and B2 of the subsequent slot, the block B1 and B2 areas of slots (i+1) are left without being allocated to any service, and this area is defined as orphan type 1. In addition, also in the case where an (i)th slot is a full main slot and an (i+1)th slot which is the subsequent slot is BEM 01 slot, block B1 and B2 areas of slot (i+1) are left without being allocated to any service, also generating an orphan type1.

Secondly, in the case where an (i)th slot is BEM01 slot and the subsequent slot (i+1)th slot is CMM slot, a block coding is performed using blocks B1 and B2 in the subsequent slot, and thus it becomes difficult to use blocks B1 and B2 in the subsequent slot. That is, the subsequent slot, CMM slot, is set in a dual frame mode, and thus services allocated only to the primary ensemble and the secondary ensemble must be left empty. Herein, among the secondary ensemble consisting of blocks B1 to B2 and B9 to B10, blocks B1 and B2 are brought from the (i)th slot and then used, but the remaining block B9 and B10 areas are left without any service allocated thereto, and this area is defined as orphan type2.

Lastly, when the BEM 01 slot is adjacent to (i)th, and the full main slot is adjacent to (i+1)th, orphan type3 is generated. When BEM01 slot brings and uses the area corresponding to blocks B1 and B2 from the subsequent slot, full main slot, it becomes difficult to transmit normal data to the superior 32 packets where blocks B1 and B2 exist among the 156 subsequent slots. That is, a portion of the first 32 packets of the subsequent slot corresponds to the area of blocks B1 and B2, and thus is used in the (i)th slot, BEM 01 slot, but the remaining area not corresponding to the area of blocks B1 and B2 in the 32 packets is left without any service allocated thereto. The remaining area corresponding to an area of blocks B1 and B2 in the first 21 packets of the subsequent slot is distributed in a portion of group region A and B when seen in the group format after interleaving. Therefore, orphan type3 is generated in the body area of the subsequent slot.

[Method of Utilizing Orphan]

In the orphan area, new mobile data, training data, or a dummy byte may be included when necessary. In the case of filling the orphan region with new mobile data, the existence and type of the corresponding data and signaling information necessary for the receiver to recognize and decode the data may be added.

In the case of filling the orphan region with training data, it is possible to initialize the trellis encoder in accordance with the training sequence to be generated and define the known byte so that the receiver can recognize the training sequence.

Table 16 illustrates an example of the location of an orphan area and an orphan use method when BEM is 01.

TABLE 16

| Slot | Slot | Loss | Orphan | |
|---|---|---|---|---|
| (i) | (i + 1) | (bytes) | Location | Orphan Use |
| CMM | BEM = 01 | 1850 | Slot(i + 1) Head | Training |
| | | | | (141/89) |
| BEM = 01 | CMM | 1570 | Slot(i + 1) Tail | Training |
| | | | | (195/141) |
| Full Main | BEM = 01 | 1850 | Slot(i + 1) Head | Training |
| | | | | (141/89) |
| BEM = 01 | Full Main | 3808 | Slot(i + 1) Part | Dummy |
| | | | of Region A and B | |

Otherwise, generation of an orphan area when BEM is 01 may be configured as in table 17 as shown below.

TABLE 17

| | | | | | Orphan |
|---|---|---|---|---|---|
| | | | | Orphan | Use(Known |
| Orphan | Slot | Slot | Loss | Region | bytes/Initiali- |
| Type | (i) | (i + 1) | (bytes) | Location | zation bytes) |
| type1 | CMM slot | SFCMM Slot | 1618 | Slot(i + 1) | Training |
| | | with | | Head | (210/252) |
| | | BEM = 01 | | | |
| type2 | SFCMM Slot | CMM slot | 1570 | Slot(i + 1) | Training |
| | with | | | Tail | (195/141) |
| | BEM = 01 | | | | |
| type1 | M/H Slot | SFCMM Slot | 1618 | Slot(i + 1) | Training |
| | with only | with | | Head | (210/252) |
| | Main packets | BEM = 01 | | | |
| type3 | SFCMM Slot | M/H Slot | 3808 | Slot(i + 1) | Dummy |
| | with | with only | | Part of | |
| | BEM = 01 | Main packets | | Regions | |
| | | | | A and B | |

As illustrated in the above table, an orphan area may be formed in various locations and sizes according to the format of two sequential slots. In addition, such an orphan area may be utilized for various uses such as training data, dummy data, etc. Tables 16 and 17 do not illustrate cases where mobile data is used in the orphan area, but of course such a case is also possible.

When an orphan area is utilized, a stream processing method of the digital broadcast transmitter may be embodied to include a step of forming a stream including a plurality of different type of slots in which at least one of existing mobile data, normal data, and new mobile data is disposed in different formats respectively and a transmitting step of encoding and interleaving the stream and outputting the encoded and interleaved stream as a transport stream. Herein, the transmitting step may refer to the operation performed in the exciter 400 among the configurative elements in the aforementioned digital broadcast transmitter.

The step of forming a stream may dispose at least one of new mobile data, training data, and dummy data in the orphan area where data is not allocated due to the difference of formats between the continuous slots. Such a method of utilizing the orphan area was explained hereinabove.

In addition, an orphan area may be shown in various types as aforementioned.

That is, an orphan area may be one of a first type area formed in a head portion of the SFCMM slot in the case where the CMM slot and SFCMM slot where the block extension mode is 01 are sequentially disposed or in the case where the full main slot containing only normal data and SFCMM slot where the block extension mode is 01 are sequentially disposed,

a second type orphan area formed on a tail portion of the CMM slot in the case where SFCMM slot where the block extension mode is 01 and the CMM slot are sequentially disposed, and

a third type orphan area formed on a body portion of the full main slot in the case where SFCMM slot where the block extension mode is 01, and the full main slot including only normal data are sequentially disposed.

It has been already explained hereinabove that the CMM slot is a slot where existing mobile data is disposed in the first area allocated for existing mobile data and normal data is disposed in the second area allocated for normal data.

In addition, it has been already explained hereinabove that the SFCMM slot is a slot where new mobile data is disposed in a determined mode in at least a portion of the entire area including the first area and second area.

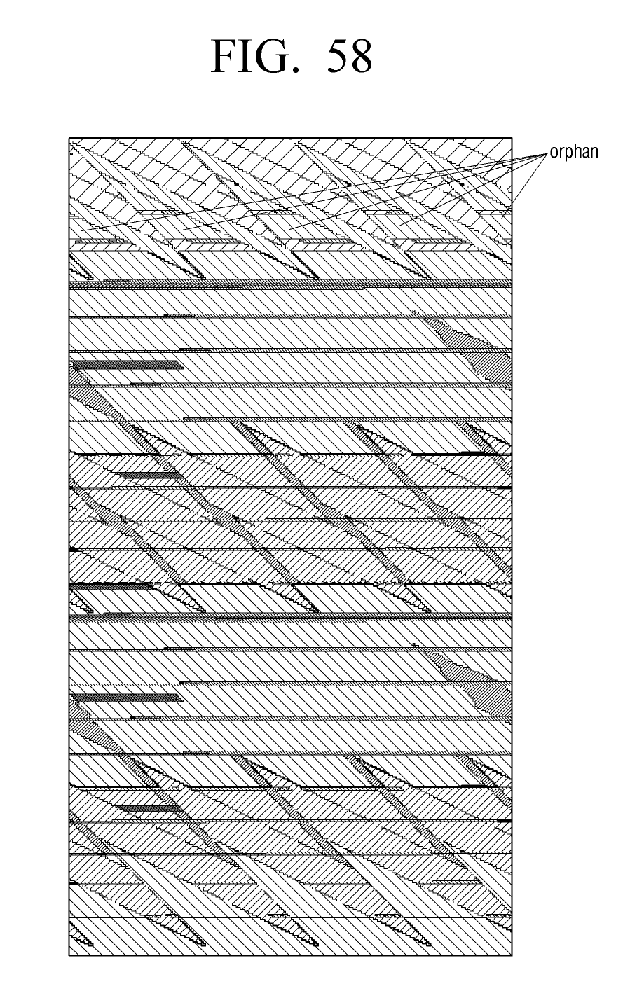

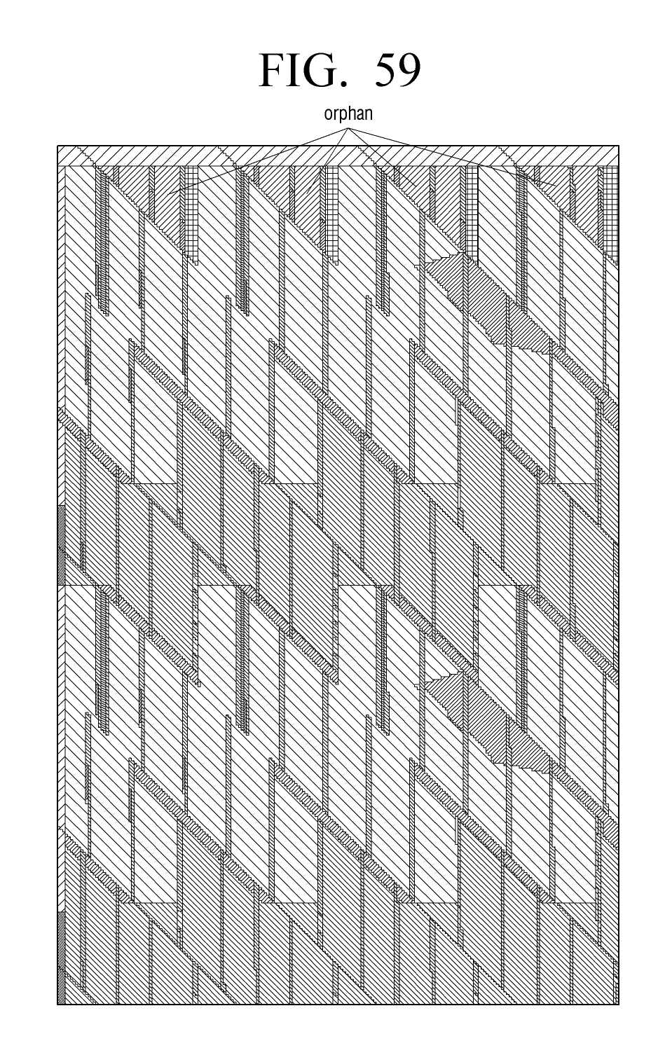

FIG. 58 is a stream structure of a first type orphan area after interleaving, and FIG. 59 is a stream structure of a first type orphan area before interleaving.

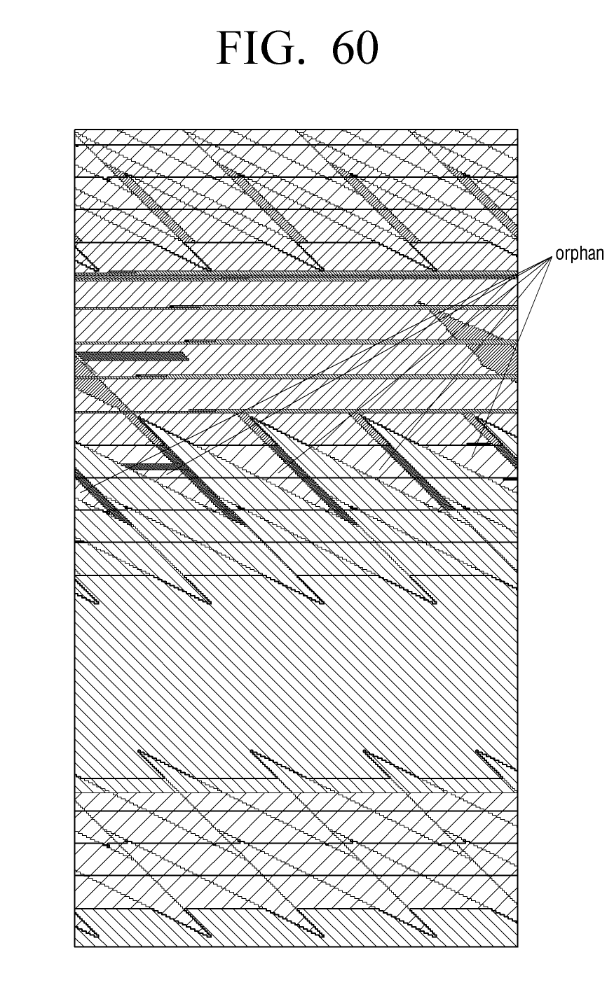

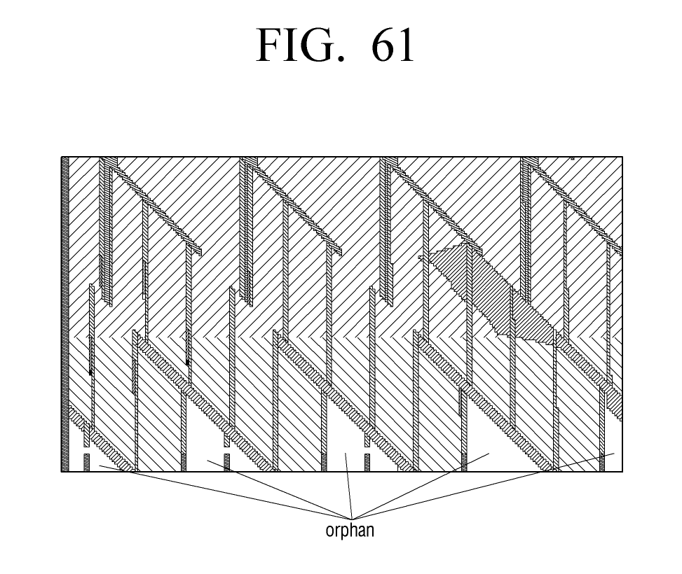

In addition, FIG. 60 is a stream structure of a second type orphan area before interleaving, and FIG. 61 is a stream structure of a second type orphan area before interleaving.

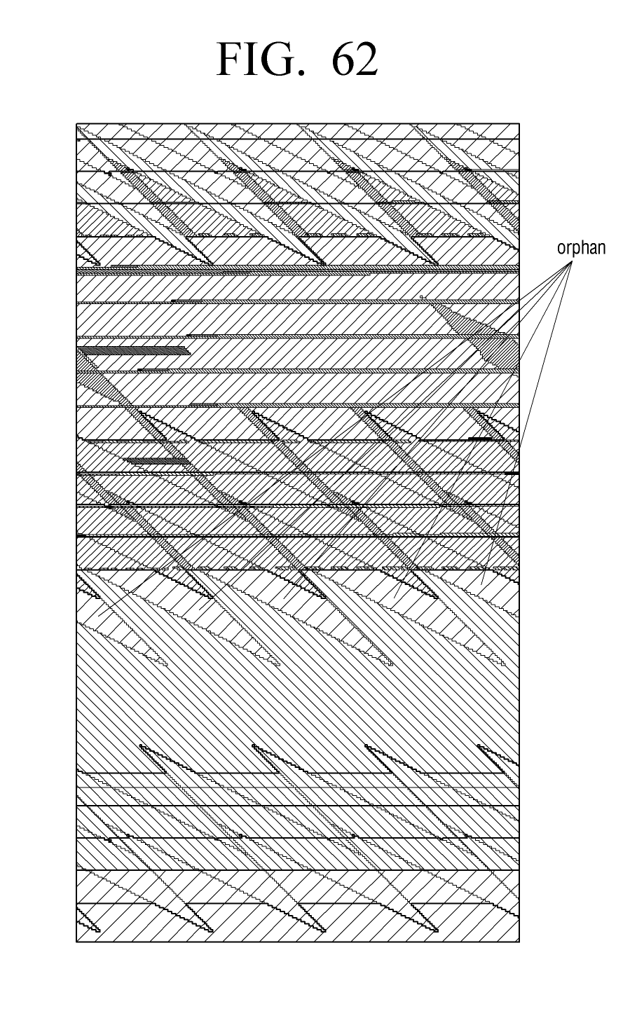

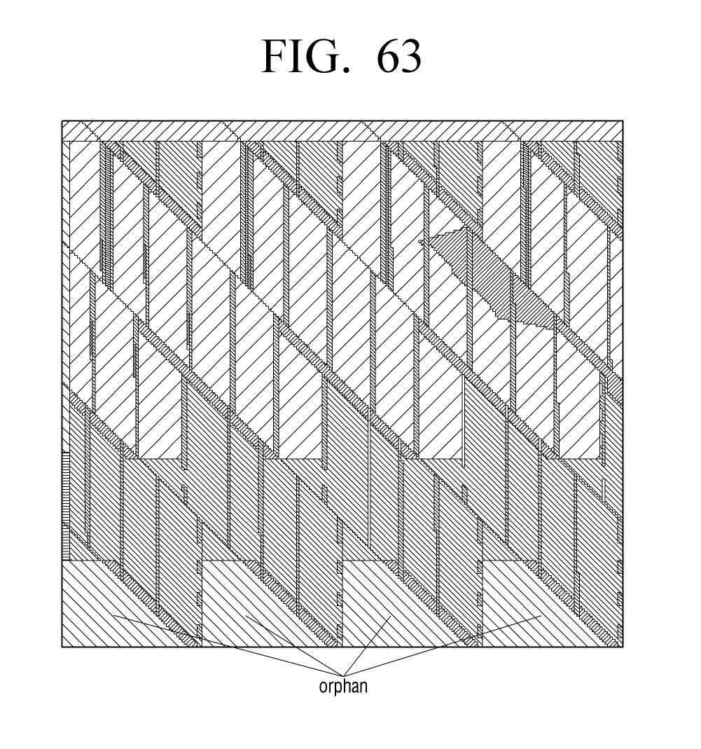

In addition, FIG. 62 is a stream structure of a third type orphan area after interleaving, and FIG. 63 is a stream structure of a third type orphan area after interleaving.

According to these drawings, it can be seen that an orphan area can be generated in various locations according to the disposition pattern of a slot.

The transmission stream transmitted from such a digital broadcast transmitter may be received in the digital broadcast receiver and may be processed.

That is, the digital broadcast receiver may include a receiver configured to receive a transport stream encoded and interleaved in a state where a plurality of different type of slots in which at least one of existing mobile data, normal data, and new mobile data is disposed in different formats are continuously disposed, a demodulator configured to demodulate a transport stream, an equalizer configured to equalize the demodulated transport stream, and a decoder configured to decode new mobile data from the equalized stream. Herein, the transport stream may include an orphan area where data is not allocated due to a difference of formats between the sequential slots, and in the orphan area, at least one of the new mobile data, training data, and dummy data may be disposed.

The digital broadcast receiver may detect only the data that the digital broadcast receiver can process and process the detected data depending on its type, that is, whether the digital broadcast receiver is an exclusive receiver for normal data, CMM exclusive receiver, SFCMM exclusive receiver, and common use receiver.

As aforementioned, whether or not data exists in the orphan area and the type thereof may be notified using signaling information. That is, the digital broadcast receiver may decode signaling information and may further include a signaling decoder configured to check whether or not data exists in the orphan area and the type thereof.

[Signaling Data]

Information such as the number of existing mobile data packets, newly added mobile data packets, code rate, etc., is transmitted to the receiver side as signaling information.

For example, such signaling information may be transmitted using the reserved area of TPC. In this case, some sub frames may transmit information on the present frame, and other sub frames may transmit information on the next frame to embody “Signaling in Advance”. That is, a predetermined TPC parameter and FIC data may be pre-signaled.

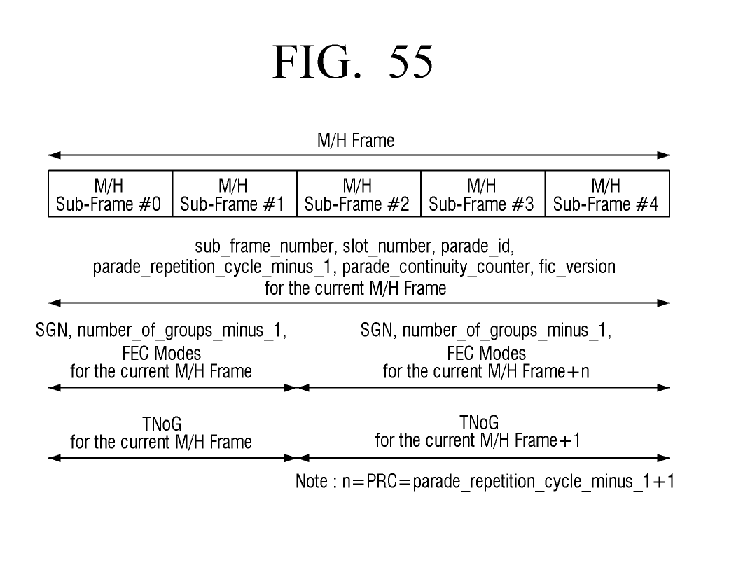

More specifically, as illustrated in FIG. 55, one M/H frame may be divided into 5 sub frames. TPC parameters such as sub_frame_number, slot_number, parade_id, parade_repetition_cycle_minus_{—}1, parade_continuity_counter, fic_version, and slot modes added as aforementioned may transmit information on the current frame in 5 sub frames. TPC parameters such as SGN, number_of groups_minus_{—}1, FEC Modes, TNoG, number of existing or new mobile data packet added as aforementioned, code rate, etc., may be recorded differently according to the number of the sub frame. That is, sub frames #0, #1, may transmit information on the current frame, and sub frames #2, #3, #4 may transmit information on the next frame considering the PRC (Parade Repetition Cycle). In the case of TNoG, sub frames #0, #1 may transmit information on the present frame, and sub frames #2, #3, #4 may transmit information on the current frame and next frame.

More specifically, TPC information may be configured as in the table below.

TABLE 18

| | | |
|---|---|---|
| | No. of | |
| Syntax | Bits | Format |

TPC_data {

| | | |
|---|---|---|
| sub-frame_number | 3 | uimsbf |
| slot_number | 4 | uimsbf |
| parade_id | 7 | uimsbf |

| if(sub-frame_number≦1){ | | | |
|---|---|---|---|
| current_starting_group_number | | 4 | uimsbf |
| current_number_of_groups_minus_1 | } | 3 | uimsbf |

if(sub-frame_number≧2){

| next_starting_group_number | | 4 | uimsbf |
|---|---|---|---|
| next_number_of_groups_minus_1 | } | 3 | uimsbf |

| | | |
|---|---|---|
| parade_repetition_cycle_minus_1 | 3 | uimsbf |
| if(sub-frame_number≦1){ | | |

| current_rs_frame_mode | | 2 | bslbf |
|---|---|---|---|
| current_rs_code_mode_primary | | 2 | bslbf |
| current_rs_code_mode_secondary | | 2 | bslbf |
| current_sccc_block_mode | | 2 | bslbf |
| current_sccc_outer_code_mode_a | | 2 | bslbf |
| current_sccc_outer_code_mode_b | | 2 | bslbf |
| current_sccc_outer_code_mode_c | | 2 | bslbf |
| current_sccc_outer_code_mode_d | } | 2 | bslbf |

if(sub-frame_number≧2){

| next_rs_frame_mode | | 2 | bslbf |
|---|---|---|---|
| next_rs_code_mode_primary | | 2 | bslbf |
| next_rs_code_mode_secondary | | 2 | bslbf |
| next_sccc_block_mode | | 2 | bslbf |
| next_sccc_outer_code_mode_a | | 2 | bslbf |
| next_sccc_outer_code_mode_b | | 2 | bslbf |
| next_sccc_outer_code_mode_c | | 2 | bslbf |
| next_sccc_outer_code_mode_d | } | 2 | bslbf |

| | | |
|---|---|---|
| fic_version | 5 | uimsbf |
| parade_continuity_counter | 4 | uimsbf |
| if(sub-frame_number≦1){ | | |

| current_TNoG | | 5 | uimsbf |
|---|---|---|---|
| reserved | } | 5 | bslbf |

if(sub-frame_number≧2){

| next_TNoG | | 5 | uimsbf |
|---|---|---|---|
| current_TNoG | } | 5 | uimsbf |

if(sub-frame_number≦1){

| current_sccc_outer_code_mode_e | | 2 | bslbf |
|---|---|---|---|
| current_scalable_mode | } | 2 | uimsbf |

if(sub-frame_number≧2){

| next_sccc_outer_code_mode_e | | 2 | bslbf |
|---|---|---|---|
| next_scalable_mode | } | 2 | uimsbf |

| | | |
|---|---|---|
| slot mode | 2 | uimsbf |
| reserved | 10 | bslbf |
| tpc_protocol_version | 5 | bslbf |

}

As illustrated in table 18, in the case where the number of sub frames is 1 or less, that is, in #0, #1, various information on the current M/H frame is transmitted, and in the case where the sub frame number is 2 or more, that is in #2, #3, #4, PRC (Parade Repetition Cycle) may be considered, and then various information on the next M/H frame may be transmitted. Accordingly, it becomes possible to know information on the next frame, thereby improving the process speed.

According to a change in the exemplary embodiment as aforementioned, the configuration of the receiver side may also be changed. That is, the receiver side may decode the data which has been combined in various ways according to the block mode and then block coded, and restore existing mobile data, normal data, new mobile data, etc. In addition, the receiver may check the signaling information on the next frame in advance and prepare processing according to the checked information.

More specifically, in the digital broadcast receiver having a configuration of FIG. 51, the receiver 5100 combines the data disposed in the existing mobile data area with the new mobile data disposed in the normal data in block units, performs SCCC coding and receives the configured stream.

Herein, the stream may be divided in frame units, and one frame may be divided into a plurality of sub frames. In addition, in at least a portion of the plurality of sub frames, signaling information on the current frame is included, and in the remaining sub frame among a plurality of sub frames, signaling information on the next frame where PRC (Parade Repetition Cycle) is considered may be included. For example, among a total of 5 sub frames, in #0, #1 sub frames, information on the current frame may be included, and in #2, #3, #4 sub frames, information on the next frame where PRC (Parade Repetition Cycle) is considered may be included.

In addition, the aforementioned stream may be a stream which has been SCCC coded with one rate of 1/2 rate, 1/3 rate, 1/4 rate by the digital broadcast transmitter.

When the aforementioned stream is transmitted, the demodulator 5200 demodulates the stream and the equalizer 5300 equalizes the demodulated stream.

The decoder 5400 decodes at least one of existing mobile data and new mobile data from the equalized stream. In this case, the decoder 5400 may prepare processing on the next frame in advance using the frame information included in each sub frame.

As such, the digital broadcast receiver may appropriately process the stream transmitted from the digital broadcast transmitter according to various exemplary embodiments. Explanation and illustration on the stream processing method of the digital broadcast receiver is omitted.

As such, the configuration of the receiver according to various changed exemplary embodiments is similar to the configuration of other exemplary embodiments, and thus, illustration and repeated explanation thereof is omitted.

FIG. 56 is a view illustrating an M/H group format before data interleaving in the aforementioned compatibility mode, that is, in scalable mode 11a.

According to FIG. 56, the M/H group including the mobile data consists of 208 data segments. In the case where the M/H group is distributed across 156 packets inside the M/H slot consisting of 156 packet units, the resulting 156 packets interleaved by the interleaving rule of interleaver 430 are spread to 208 data segments.

The mobile data group of a total of 208 data segments is divided into 15 mobile data blocks. More specifically, B1 to B10, and SB1 to SB5 blocks are included. Of these, blocks B1 to B10 may correspond to the mobile data disposed in the existing mobile data area as illustrated in FIG. 8. Meanwhile, blocks SB1 to SB5 may correspond to the new mobile data allocated to the existing normal data area. SB5 is an area including the MPEG header and RS parity for backward compatibility.

Each of blocks B1 to B10 may consist of 16 segments as the existing mobile data area, block SB4 may consist of 31 segments, and each of blocks SB2 and SB3 may consist of 14 segments. Block SB1 may have a different segment length distributed according to the mode. In all frames, in the case where normal data is not transmitted at all, that is, when the data rate of 19.4 Mbps is filled with mobile data, block SB1 may consist of 32 segments. Besides, in the case where normal data is transmitted even by a portion, block SB1 may consist of 31 segments.

Block SB5 is an area where an MPEG header and RS parity existing in 51 segments of a body area are distributed, and in the case where normal data is not transmitted at all in any of the frames, that is, when the area is filled with mobile data by 19.4 Mbps, block SB5 may be filled with mobile data and defined as SB5. This corresponds to the aforementioned incompatibility mode. As such, when all data is allocated to mobile data, it is not necessary to consider compatibility. The area where an MPEG header and RAS parity which are used for the compatibility with the receiver for receiving existing normal data may be redefined as mobile data and may be used.

As aforementioned, these blocks, that is, B1 to B10, and SB1 to SB5, may be combined in various formats and may be block coded.

That is, in the case where the SCCC block mode is 00(separate block), the SCCC outer code mode may be applied differently per group region (A,B,C,D), whereas in the case where the SCCC block mode is 01 (paired block), the SCCC outer code mode of all regions must be the same. For example, SB1 and SB4, which are newly added mobile data blocks, follow the SCCC outer code mode determined for group region C, and blocks SB2 and SB3 follow the SCCC outer code mode determined for group region D. Lastly, block SB5 follows the SCCC outer code mode determined for group region A.

Especially, in the case where block SB5 is derived, the receiver may be in a state where services are implemented with only mobile data, and in this case, it is possible to apply the coding of SB5 differently considering the compatibility between the receiver which receives existing mobile data and the receiver which additionally receives new mobile data.

That is, in the case where the block mode of the slot where block SB5 is derived is separate, it may be necessary to fill the primary ensemble with 1.0 mobile data and fill the secondary ensemble with 1.1 mobile data to maintain compatibility with the receivers which receive mobile data. Therefore, an SB5 block may be coded independently.

When the block mode of the slot where block SB5 is derived is paired, the block SB5 is a single frame, in which case it is not necessary to consider the compatibility with the existing mobile data receiver. Therefore, it is possible to absorb block SB5 as a portion of the existing body area and code the same.

More specifically, in the case where new mobile data is disposed in the entirety of the second area inside one slot as in the case of an incompatibility mode, that is scalable mode 11, the coding of SB5 may be applied differently according to the block mode. For example, when the block mode determined for the corresponding slot is a separate mode where existing mobile data and new mobile data may coexist, the block including the MPEG header and RS parity area, that is, SB5, may be coded differently with the body area inside the corresponding slot. On the other hand, when the block mode is a paired mode only existing in new mobile data, the block including the MPEG header and RS parity area, that is, SB5, may be coded together with the remaining portion of the body area. As such, various types of block coding may be performed.

Accordingly, the digital broadcast receiver which receives a transport stream checks the mode according to signaling data, and detects new mobile data to be suitable to that mode and then reproduces the detected new mobile data. That is, in the case where new mobile data of paired block mode is transmitted in the aforementioned incompatibility mode (that is, fifth mode or scalable mode 11), it is possible to decode the new mobile data together with the mobile data included in the existing body area without separately decoding the SB5 block.

In the case where base data, that is, a training sequence, exists as aforementioned, it is necessary to initialize the memories inside the trellis encoder before the training sequence is trellis encoded. In this case, the area provided for memory initialization, that is, an initialization byte, must be disposed before the training sequence.

FIG. 56 illustrates a stream structure after interleaving. According to FIG. 56, the training sequence appears in a plurality of long training sequence formats in the body area, and in a plurality of training sequence formats also in the head tail area as well. More specifically, in the head tail area, a total of 5 long training sequences appear. Of these, regarding the second, third, and fourth training sequences, the trellis initialization byte may be determined to start not from the first byte but after a certain byte, unlike the first and fifth training sequence.

Such transferring of the location of a trellis initialization byte is not limited only to the head/tail area. That is, in some of the long training sequences among the plurality of long training sequences included in the body area, the trellis initialization byte may also be designed to start after a certain byte of each segment.

[PL, SOBL, SIBL Size According to Block Mode]

The PL (RS Frame Portion Length), SOBL (SCCC Output Block Length) may be embodied in various sizes. The following table shows the PL of the primary RS frame when the RS frame mode is 00 (that is, single frame), SCCC block mode is 00 (that is, separate block), and SCCC block extension mode is 01.

TABLE 19

| SCCC Outer Code Mode Combinations | | | | | | | | |
|---|---|---|---|---|---|---|---|---|
| | | For Region | For Region | | | | | |
| For Region | | C, M/H | D, M/H | PL | | | | |
| A and M/H | For Region | Blocks SB1 | Blocks SB2 | Scalable | Scalable | Scalable | Scalable | Scalable |
| Block SB5 | B | and SB4 | and SB3 | Mode 00 | Mode 01 | Mode 10 | Mode 11 | Mode 11a |
| 00 | 00 | 00 | 00 | 10440 | 11094 | 11748 | 13884 | 12444 |
| 00 | 00 | 00 | 10 | 10138 | 10678 | 11216 | 13126 | 11766 |
| 00 | 00 | 00 | 01 | 9987 | 10470 | 10950 | 12747 | 11427 |
| 00 | 00 | 10 | 00 | 9810 | 10360 | 10912 | 12698 | 11522 |
| 00 | 00 | 10 | 10 | 9508 | 9944 | 10380 | 11940 | 10844 |
| 00 | 00 | 10 | 01 | 9357 | 9736 | 10114 | 11561 | 10505 |
| 00 | 00 | 01 | 00 | 9495 | 9993 | 10494 | 12105 | 11061 |
| 00 | 00 | 01 | 10 | 9193 | 9577 | 9962 | 11347 | 10383 |
| 00 | 00 | 01 | 01 | 9042 | 9369 | 9696 | 10968 | 10044 |
| 00 | 10 | 00 | 00 | 9626 | 10280 | 10934 | 13070 | 11630 |
| 00 | 10 | 00 | 10 | 9324 | 9864 | 10402 | 12312 | 10952 |
| 00 | 10 | 00 | 01 | 9173 | 9656 | 10136 | 11933 | 10613 |
| 00 | 10 | 10 | 00 | 8996 | 9546 | 10098 | 11884 | 10708 |
| 00 | 10 | 10 | 10 | 8694 | 9130 | 9566 | 11126 | 10030 |
| 00 | 10 | 10 | 01 | 8543 | 8922 | 9300 | 10747 | 9691 |
| 00 | 10 | 01 | 00 | 8681 | 9179 | 9680 | 11291 | 10247 |
| 00 | 10 | 01 | 10 | 8379 | 8763 | 9148 | 10533 | 9569 |
| 00 | 10 | 01 | 01 | 8228 | 8555 | 8882 | 10154 | 9230 |
| 00 | 01 | 00 | 00 | 9219 | 9873 | 10527 | 12663 | 11223 |
| 00 | 01 | 00 | 10 | 8917 | 9457 | 9995 | 11905 | 10545 |
| 00 | 01 | 00 | 01 | 8766 | 9249 | 9729 | 11526 | 10206 |
| 00 | 01 | 10 | 00 | 8589 | 9139 | 9691 | 11477 | 10301 |
| 00 | 01 | 10 | 10 | 8287 | 8723 | 9159 | 10719 | 9623 |
| 00 | 01 | 10 | 01 | 8136 | 8515 | 8893 | 10340 | 9284 |
| 00 | 01 | 01 | 00 | 8274 | 8772 | 9273 | 10884 | 9840 |
| 00 | 01 | 01 | 10 | 7972 | 8356 | 8741 | 10126 | 9162 |
| 00 | 01 | 01 | 01 | 7821 | 8148 | 8475 | 9747 | 8823 |
| 10 | 00 | 00 | 00 | 8706 | 9360 | 10014 | 12422 | 10710 |
| 10 | 00 | 00 | 10 | 8404 | 8944 | 9482 | 11256 | 10032 |
| 10 | 00 | 00 | 01 | 8253 | 8736 | 9216 | 10877 | 9693 |
| 10 | 00 | 10 | 00 | 8076 | 8626 | 9178 | 10828 | 9788 |
| 10 | 00 | 10 | 10 | 7774 | 8210 | 8646 | 10070 | 9110 |
| 10 | 00 | 10 | 01 | 7623 | 8002 | 8380 | 9691 | 8771 |
| 10 | 00 | 01 | 00 | 7761 | 8259 | 8760 | 10235 | 9327 |
| 10 | 00 | 01 | 10 | 7459 | 7843 | 8228 | 9477 | 8649 |
| 10 | 00 | 01 | 01 | 7308 | 7635 | 7962 | 9098 | 8310 |
| 10 | 10 | 00 | 00 | 7892 | 8546 | 9200 | 11200 | 9896 |
| 10 | 10 | 00 | 10 | 7590 | 8130 | 8668 | 10442 | 9218 |
| 10 | 10 | 00 | 01 | 7439 | 7922 | 8402 | 10063 | 8879 |
| 10 | 10 | 10 | 00 | 7262 | 7812 | 8364 | 10014 | 8974 |
| 10 | 10 | 10 | 10 | 6960 | 7396 | 7832 | 9256 | 8296 |
| 10 | 10 | 10 | 01 | 6809 | 7188 | 7566 | 8877 | 7957 |
| 10 | 10 | 01 | 00 | 6947 | 7445 | 7946 | 9421 | 8513 |
| 10 | 10 | 01 | 10 | 6645 | 7029 | 7414 | 8663 | 7835 |
| 10 | 10 | 01 | 01 | 6494 | 6821 | 7148 | 8284 | 7496 |
| 10 | 01 | 00 | 00 | 7485 | 8139 | 8793 | 10793 | 9489 |
| 10 | 01 | 00 | 10 | 7183 | 7723 | 8261 | 10035 | 8811 |
| 10 | 01 | 00 | 01 | 7032 | 7515 | 7995 | 9656 | 8472 |
| 10 | 01 | 10 | 00 | 6855 | 7405 | 7957 | 9607 | 8567 |
| 10 | 01 | 10 | 10 | 6553 | 6989 | 7425 | 8849 | 7889 |
| 10 | 01 | 10 | 01 | 6402 | 6781 | 7159 | 8470 | 7550 |
| 10 | 01 | 01 | 00 | 6540 | 7038 | 7539 | 9014 | 8106 |
| 10 | 01 | 01 | 10 | 6238 | 6622 | 7007 | 8256 | 7428 |
| 10 | 01 | 01 | 01 | 6087 | 6414 | 6741 | 7877 | 7089 |
| 01 | 00 | 00 | 00 | 7839 | 8493 | 9147 | 11079 | 9843 |
| 01 | 00 | 00 | 10 | 7537 | 8077 | 8615 | 10321 | 9165 |
| 01 | 00 | 00 | 01 | 7386 | 7869 | 8349 | 9942 | 8826 |
| 01 | 00 | 10 | 00 | 7209 | 7759 | 8311 | 9893 | 8921 |
| 01 | 00 | 10 | 10 | 6907 | 7343 | 7779 | 9135 | 8243 |
| 01 | 00 | 10 | 01 | 6756 | 7135 | 7513 | 8756 | 7904 |
| 01 | 00 | 01 | 00 | 6894 | 7392 | 7893 | 9300 | 8460 |
| 01 | 00 | 01 | 10 | 6592 | 6976 | 7361 | 8542 | 7782 |
| 01 | 00 | 01 | 01 | 6441 | 6768 | 7095 | 8163 | 7443 |
| 01 | 10 | 00 | 00 | 7025 | 7679 | 8333 | 10265 | 9029 |
| 01 | 10 | 00 | 10 | 6723 | 7263 | 7801 | 9507 | 8351 |
| 01 | 10 | 00 | 01 | 6572 | 7055 | 7535 | 9128 | 8012 |
| 01 | 10 | 10 | 00 | 6395 | 6945 | 7497 | 9079 | 8107 |
| 01 | 10 | 10 | 10 | 6093 | 6529 | 6965 | 8321 | 7429 |
| 01 | 10 | 10 | 01 | 5942 | 6321 | 6699 | 7942 | 7090 |
| 01 | 10 | 01 | 00 | 6080 | 6578 | 7079 | 8486 | 7646 |
| 01 | 10 | 01 | 10 | 5778 | 6162 | 6547 | 7728 | 6968 |
| 01 | 10 | 01 | 01 | 5627 | 5954 | 6281 | 7349 | 6629 |
| 01 | 01 | 00 | 00 | 6618 | 7272 | 7926 | 9858 | 8622 |
| 01 | 01 | 00 | 10 | 6316 | 6856 | 7394 | 9100 | 7944 |
| 01 | 01 | 00 | 01 | 6165 | 6648 | 7128 | 8721 | 7605 |
| 01 | 01 | 10 | 00 | 5988 | 6538 | 7090 | 8672 | 7700 |
| 01 | 01 | 10 | 10 | 5686 | 6122 | 6558 | 7914 | 7022 |
| 01 | 01 | 10 | 01 | 5535 | 5914 | 6292 | 7535 | 6683 |
| 01 | 01 | 01 | 00 | 5673 | 6171 | 6672 | 8079 | 7239 |
| 01 | 01 | 01 | 10 | 5371 | 5755 | 6140 | 7321 | 6561 |
| 01 | 01 | 01 | 01 | 5220 | 5547 | 5874 | 6942 | 6222 |

| | | | | | |
|---|---|---|---|---|---|
| Others | Undefined | Undefined | Undefined | Undefined | Undefined |

In addition, the following table shows the PL of the primary RS frame when the RS frame mode is 00 (that is, single frame), SCCC block mode is 01 (that is, paired block), and SCCC block extension mode is 01.

TABLE 20

| | PL | | | | |
|---|---|---|---|---|---|
| SCCC Outer | Scalable | Scalable | Scalable | Scalable | Scalable |
| Code Mode | Mode 00 | Mode 01 | Mode 10 | Mode 11 | Mode 11a |
| 00 | 10440 | 11094 | 11748 | 13884 | 12444 |
| 10 | 6960 | 7396 | 7832 | 9256 | 8296 |
| 01 | 5220 | 5547 | 5874 | 6942 | 6222 |

| | |
|---|---|
| Others | Undefined |

In addition, the following table shows the PL of the secondary RS frame when the RS frame mode is 01 (that is, dual frame), SCCC block mode is 00 (that is, separated block), and SCCC block extension mode is 01.

TABLE 21

| SCCC Outer Code Mode Combinations | | | | | | | |
|---|---|---|---|---|---|---|---|
| For Region | For Region | | | | | | |
| C, M/H | D, M/H | | PL | | | | |
| Blocks SB1 | Blocks SB2 | For M/H | Scalable | Scalable | Scalable | Scalable | Scalable |
| and SB4 | and SB3 | Block SB5 | Mode 00 | Mode 01 | Mode 10 | Mode 11 | Mode 11a |
| 00 | 00 | 00 | 2796 | 3450 | 4104 | 6240 | 4800 |
| 00 | 10 | 00 | 2494 | 3034 | 3572 | 5482 | 4122 |
| 00 | 01 | 00 | 2343 | 2826 | 3306 | 5103 | 3783 |
| 10 | 00 | 00 | 2166 | 2716 | 3268 | 5054 | 3878 |
| 10 | 10 | 00 | 1864 | 2300 | 2736 | 4296 | 3200 |
| 10 | 01 | 00 | 1713 | 2092 | 2470 | 3917 | 2861 |
| 01 | 00 | 00 | 1851 | 2349 | 2850 | 4461 | 3417 |
| 01 | 10 | 00 | 1549 | 1933 | 2318 | 3703 | 2739 |
| 01 | 01 | 00 | 1398 | 1725 | 2052 | 3324 | 2400 |
| 00 | 00 | 01 | 2796 | 3450 | 4104 | 6036 | 4800 |
| 00 | 10 | 01 | 2494 | 3034 | 3572 | 5278 | 4122 |
| 00 | 01 | 01 | 2343 | 2826 | 3306 | 4899 | 3783 |
| 10 | 00 | 01 | 2166 | 2716 | 3268 | 4850 | 3878 |
| 10 | 10 | 01 | 1864 | 2300 | 2736 | 4092 | 3200 |
| 10 | 01 | 01 | 1713 | 2092 | 2470 | 3713 | 2861 |
| 01 | 00 | 01 | 1851 | 2349 | 2850 | 4257 | 3417 |
| 01 | 10 | 01 | 1549 | 1933 | 2318 | 3499 | 2739 |
| 01 | 01 | 01 | 1398 | 1725 | 2052 | 3120 | 2400 |

| | | | | | |
|---|---|---|---|---|---|
| Others | Undefined | Undefined | Undefined | Undefined | Undefined |

In addition, the following table shows the SOBL and SIBL when the SCCC block mode is 00 (that is, separated block), RS frame mode is 00 (that is, single frame), and SCCC block extension mode is 01.

TABLE 22

| | SOBL | | | | | SIBL | | | | |
|---|---|---|---|---|---|---|---|---|---|---|
| | Scalable | Scalable | Scalable | Scalable | Scalable | Scalable | Scalable | Scalable | Scalable | Scalable |
| | Mode | Mode | Mode | Mode | Mode | Mode | Mode | Mode | Mode | Mode |
| SCCC Block | 00 | 01 | 10 | 11 | 11a | 00 | 01 | 10 | 11 | 11a |
| | | | | | | 1/2 rate | | | | |
| SCB1 (B1 + | 888 | 1212 | 1536 | 2280 | 1932 | 444 | 606 | 768 | 1140 | 966 |
| SB3) | | | | | | | | | | |
| SCB2 (B2 + | 1872 | 2160 | 2412 | 3432 | 2568 | 936 | 1080 | 1206 | 1716 | 1284 |
| SB4) | | | | | | | | | | |
| SCB3 (B3) | 2376 | 2376 | 2376 | 2376 | 2376 | 1188 | 1188 | 1188 | 1188 | 1188 |
| SCB4 (B4) | 2388 | 2388 | 2388 | 2388 | 2388 | 1194 | 1194 | 1194 | 1194 | 1194 |
| SCB5 (B5) | 2772 | 2772 | 2772 | 2772 | 2772 | 1386 | 1386 | 1386 | 1386 | 1386 |
| SCB6 (B6) | 2472 | 2472 | 2472 | 2472 | 2472 | 1236 | 1236 | 1236 | 1236 | 1236 |
| SCB7 (B7) | 2772 | 2772 | 2772 | 2772 | 2772 | 1386 | 1386 | 1386 | 1386 | 1386 |
| SCB8 (B8) | 2508 | 2508 | 2508 | 2508 | 2508 | 1254 | 1254 | 1254 | 1254 | 1254 |
| SCB9 (B9 + | 1908 | 2244 | 2604 | 3684 | 2964 | 954 | 1122 | 1302 | 1842 | 1482 |
| SB1) | | | | | | | | | | |
| SCB10 (B10 + | 924 | 1284 | 1656 | 2268 | 2136 | 462 | 642 | 828 | 1134 | 1068 |
| SB2) | | | | | | | | | | |
| SCB11 (SB5) | 0 | 0 | 0 | 816 | 0 | 0 | 0 | 0 | 408 | 0 |
| | | | | | | 1/3 rate | | | | |
| SCB1 (B1 + | 888 | 1212 | 1536 | 2280 | 1932 | 296 | 404 | 512 | 760 | 644 |
| SB3) | | | | | | | | | | |
| SCB2 (B2 + | 1872 | 2160 | 2412 | 3432 | 2568 | 624 | 720 | 804 | 1144 | 856 |
| SB4) | | | | | | | | | | |
| SCB3 (B3) | 2376 | 2376 | 2376 | 2376 | 2376 | 792 | 792 | 792 | 792 | 792 |
| SCB4 (B4) | 2388 | 2388 | 2388 | 2388 | 2388 | 796 | 796 | 796 | 796 | 796 |
| SCB5 (B5) | 2772 | 2772 | 2772 | 2772 | 2772 | 924 | 924 | 924 | 924 | 924 |
| SCB6 (B6) | 2472 | 2472 | 2472 | 2472 | 2472 | 824 | 824 | 824 | 824 | 824 |
| SCB7 (B7) | 2772 | 2772 | 2772 | 2772 | 2772 | 924 | 924 | 924 | 924 | 924 |
| SCB8 (B8) | 2508 | 2508 | 2508 | 2508 | 2508 | 836 | 836 | 836 | 836 | 836 |
| SCB9 (B9 + | 1908 | 2244 | 2604 | 3684 | 2964 | 636 | 748 | 868 | 1228 | 988 |
| SB1) | | | | | | | | | | |
| SCB10 (B10 + | 924 | 1284 | 1656 | 2268 | 2136 | 308 | 428 | 552 | 756 | 712 |
| SB2) | | | | | | | | | | |
| SCB11 (SB5) | 0 | 0 | 0 | 816 | 0 | 0 | 0 | 0 | 272 | 0 |
| | | | | | | 1/4 rate | | | | |
| SCB1 (B1 + | 888 | 1212 | 1536 | 2280 | 1932 | 222 | 303 | 384 | 570 | 483 |
| SB3) | | | | | | | | | | |
| SCB2 (B2 + | 1872 | 2160 | 2412 | 3432 | 2568 | 468 | 540 | 603 | 858 | 642 |
| SB4) | | | | | | | | | | |
| SCB3 (B3) | 2376 | 2376 | 2376 | 2376 | 2376 | 594 | 594 | 594 | 594 | 594 |
| SCB4 (B4) | 2388 | 2388 | 2388 | 2388 | 2388 | 597 | 597 | 597 | 597 | 597 |
| SCB5 (B5) | 2772 | 2772 | 2772 | 2772 | 2772 | 693 | 693 | 693 | 693 | 693 |
| SCB6 (B6) | 2472 | 2472 | 2472 | 2472 | 2472 | 618 | 618 | 618 | 618 | 618 |
| SCB7 (B7) | 2772 | 2772 | 2772 | 2772 | 2772 | 693 | 693 | 693 | 693 | 693 |
| SCB8 (B8) | 2508 | 2508 | 2508 | 2508 | 2508 | 627 | 627 | 627 | 627 | 627 |
| SCB9 (B9 + | 1908 | 2244 | 2604 | 3684 | 2964 | 477 | 561 | 651 | 921 | 741 |
| SB1) | | | | | | | | | | |
| SCB10 (B10 + | 924 | 1284 | 1656 | 2268 | 2136 | 231 | 321 | 414 | 567 | 534 |
| SB2) | | | | | | | | | | |
| SCB11 (SB5) | 0 | 0 | 0 | 816 | 0 | 0 | 0 | 0 | 204 | 0 |

In addition, the following table shows SOBL and SIBL when the SCCC block mode is 01 (that is, paired block), RS frame mode is 01 (that is, dual frame), and SCCC block extension mode is 01.

TABLE 23

| | SOBL | | | | | SIBL | | | | |
|---|---|---|---|---|---|---|---|---|---|---|
| | Scalable | Scalable | Scalable | Scalable | Scalable | Scalable | Scalable | Scalable | Scalable | Scalable |
| | Mode | Mode | Mode | Mode | Mode | Mode | Mode | Mode | Mode | Mode |
| SCCC Block | 00 | 01 | 10 | 11 | 11a | 00 | 01 | 10 | 11 | 11a |
| | | | | | | 1/2 rate | | | | |
| SCB1 (B1 + B6 + | 3360 | 3684 | 4008 | 4752 | 4404 | 1680 | 1842 | 2004 | 2376 | 2202 |
| SB3) | | | | | | | | | | |
| SCB2 (B2 + B7 + | 4644 | 4932 | 5184 | 6204 | 5340 | 2322 | 2466 | 2592 | 3102 | 2670 |
| SB4) | | | | | | | | | | |
| SCB3 (B3 + B8) | 4884 | 4884 | 4884 | 4884 | 4884 | 2442 | 2442 | 2442 | 2442 | 2442 |
| SCB4 (B4 + B9 + | 4296 | 4632 | 4992 | 6072 | 5352 | 2148 | 2316 | 2496 | 3036 | 2676 |
| SB1) | | | | | | | | | | |
| SCB5 (B5 + B10 + | 3696 | 4056 | 4428 | 5040 | 4908 | 1848 | 2028 | 2214 | 2520 | 2454 |
| SB2) | | | | | | | | | | |
| SCB6 (SB5) | 0 | 0 | 0 | 816 | 0 | 0 | 0 | 0 | 408 | 0 |
| | | | | | | 1/3 rate | | | | |
| SCB1 (B1 + B6 + | 3360 | 3684 | 4008 | 4752 | 4404 | 1120 | 1228 | 1336 | 1584 | 1468 |
| SB3) | | | | | | | | | | |
| SCB2 (B2 + B7 + | 4644 | 4932 | 5184 | 6204 | 5340 | 1548 | 1644 | 1728 | 2068 | 1780 |
| SB4) | | | | | | | | | | |
| SCB3 (B3 + B8) | 4884 | 4884 | 4884 | 4884 | 4884 | 1628 | 1628 | 1628 | 1628 | 1628 |
| SCB4 (B4 + B9 + | 4296 | 4632 | 4992 | 6072 | 5352 | 1432 | 1544 | 1664 | 2024 | 1784 |
| SB1) | | | | | | | | | | |
| SCB5 (B5 + B10 + | 3696 | 4056 | 4428 | 5040 | 4908 | 1232 | 1352 | 1476 | 1680 | 1636 |
| SB2) | | | | | | | | | | |
| SCB6 (SB5) | 0 | 0 | 0 | 816 | 0 | 0 | 0 | 0 | 272 | 0 |
| | | | | | | 1/4 rate | | | | |
| SCB1 (B1 + B6 + | 3360 | 3684 | 4008 | 4752 | 4404 | 840 | 921 | 1002 | 1188 | 1101 |
| SB3) | | | | | | | | | | |
| SCB2 (B2 + B7 + | 4644 | 4932 | 5184 | 6204 | 5340 | 1161 | 1233 | 1296 | 1551 | 1335 |
| SB4) | | | | | | | | | | |
| SCB3 (B3 + B8) | 4884 | 4884 | 4884 | 4884 | 4884 | 1221 | 1221 | 1221 | 1221 | 1221 |
| SCB4 (B4 + B9 + | 4296 | 4632 | 4992 | 6072 | 5352 | 1074 | 1158 | 1248 | 1518 | 1338 |
| SB1) | | | | | | | | | | |
| SCB5 (B5 + B10 + | 3696 | 4056 | 4428 | 5040 | 4908 | 924 | 1014 | 1107 | 1260 | 1227 |
| SB2) | | | | | | | | | | |
| SCB6 (SB5) | 0 | 0 | 0 | 816 | 0 | 0 | 0 | 0 | 204 | 0 |

As aforementioned, it is possible to embody PL, SOBL, and SIBL in various sizes according to the block mode. The data disclosed in the above tables is merely exemplary, and thus, exemplary embodiments are not limited thereto.

[Initialization]

As aforementioned, when base data, that is, training data, is included in a stream, initialization must be performed. That is, in the ATSC-M/H transmission system, it is possible to initialize the trellis encoder to be suitable to the training sequence to be generated and then define the known byte so that the receiver can recognize the training sequence.

In the group format of BEM 00 mode, a trellis initialization byte is on the boundary surface of each saw tooth, and then the known byte is distributed. Supposing the trellis encoding is performed from the upper segments to lower segments and from left bytes to right bytes, trellis encoding is performed between the boundary surface of the saw tooth filled with data of the next slot, and thus, it is not possible to predict the trellis encoder memory value in the boundary surface of the saw tooth filled with the data of the next current slot. Therefore, the trellis encoder must be initialized in the boundary surface of each saw tooth. As illustrated in FIGS. 56 and 57, the initialization byte may be distributed on each saw tooth boundary of the head area consisting of blocks B1 and B2, and also on each saw tooth boundary surface of the tail area consisting of blocks SB1 to SB4.

When any two slots are adjacent to each other as BEM 00, short training data of each head/tail area is located on the same segment and is continuously connected, and thus, may play the role of one long training data. In the case where two BEM 00 slots are adjacent to each other and thus the training data is concatenated, only the very first maximum 12 initialization bytes of the segment where training data exists are used as the initialization mode, and the initialization byte existing in the portion where the following saw tooth is engaged may be input just like the known byte and then trellis encoded.

Besides the very first maximum 12 initialization bytes of the segment, the middle initialization byte existing in the portion where the saw tooth is engaged may be input as the known byte or an initialization byte depending on the case adjacent to the same BEM 00 slot and the case adjacent to another slot besides BEM 00. That is, the operation of the trellis encoder may be muxed in a normal mode or in an initialization mode for the middle initialization byte period. A different symbol is generated depending on in which mode the trellis encoder muxes the input, and thus, the symbol value that the receiver uses in training may change. Therefore, in order to minimize confusion of the receiver, in the case where two BEM 00 slots are adjacent to each other and configures a long training, it is possible to determine the middle initialization byte value to be used as the initialization mode in the case where BEM 00 slot is not adjacent to the same slot, based on the symbol to be generated by muxing all the middle initialization byte values. That is, it is possible to determine the middle initialization byte value so as to create a same value as the long training symbol value generated in the case of concatenation. Herein, during the first two symbols of the middle initialization bytes, the symbol value may be different from when a concatenation is made.

As such, it is possible to embody the stream processing method of the digital broadcast transmitter so that a long training sequence may be formed in the boundary portions of the continuous slots.

That is, the stream processing method at the transmitter side may include a step of forming a stream where slots containing a plurality of blocks are sequentially disposed, and a step of encoding and interleaving the stream and outputting the encoded and interleaved stream as a transport stream.

Herein, the step of forming a stream may include disposing base data in each predetermined segment of the adjacent slot so that a long training sequence can be formed in the boundary portion of the adjacent slots engaged in a saw tooth format, in the case where slots set in the block extension mode 00 which enable the use of the entire group of blocks inside the corresponding slot are sequentially disposed. The block extension mode 00 is a mode determined so that the aforementioned blocks B1 and B2 are all used in that slot. Accordingly, in the boundary portion of the next slot, the saw tooth of the preceding slot and the saw tooth of the following slot engage each other. In this case, base data is disposed in an appropriate segment location of the preceding slot and in the appropriate segment location of the following slot so that the base data may be connected in the saw tooth portion of the two slots. More specifically, when base data is disposed in about the 130^{th} segment of the preceding slot and in the 15^{th} segment of the following slot, they are connected in the boundary portion, forming one long training sequence.

As such, in the case where the first base data disposed in the saw tooth portion of the preceding slot and the second base data disposed in the saw tooth portion of the following slot are connected alternately in the boundary portion, the value of the first base data and the value of the second base data may be a value predetermined to form a long training sequence between the digital broadcast receiver and digital broadcast transmitter.

Otherwise, the base data may be inserted to have a same sequence with reference to the long training sequence used in the slot of block extension mode 01 which is enabled to provide some blocks inside the corresponding slot to other slots.

FIG. 64 is a stream structure before interleaving when the block extension mode is 00, and FIG. 65 is a stream structure after interleaving when the block extension mode is 00.

When base data is disposed in a long training sequence format, as aforementioned, initialization need not be made at every base data portion. Therefore, in this case, there may be included a step of initializing the trellis encoder before the trellis encoding of the base data corresponding to the first portion of the long training sequence.

On the other hand, in the case where slots set in different block extension modes are sequentially disposed, the base data cannot be connected in the boundary portion. Therefore, in this case, the transmitting step may initialize the trellis encoder before the trellis encoding of each base data disposed in the saw tooth portion in the boundary of the sequentially disposed slots.

In the case where base data is disposed in a long training sequence format in the boundary portion and is transmitted, the stream processing method of the digital broadcast receiver may be embodied accordingly.

That is, the stream processing method of the digital broadcast receiver may include a step of receiving an encoded and interleaved transport stream with slots containing a plurality of blocks sequentially disposed, a step of demodulating the received transport stream, a step of equalizing the demodulated transport stream, and a step of decoding the new mobile data from the equalized stream.

Herein, each slot of the transport stream may include at least one of normal data, existing mobile data, and new mobile data.

In addition, in the case where the slots set in block extension mode 00 which enable using the entire group of blocks inside the corresponding slot are sequentially disposed, the transport stream may be one stream having base data disposed in each predetermined segment of each of the adjacent slots so that a long training sequence may be formed in the boundary portion of the adjacent slots engaged in a saw tooth format.

As aforementioned, each base data in the boundary portion of the preceding slot and the following slot may be sequentially connected to form a long training sequence which is base data between the digital broadcast transmitter and digital broadcast receiver.

In addition, such a long training sequence may have a same sequence with reference to the long training sequence used in the slot of block extension mode 01 which enables some blocks inside the corresponding slot to be provided to other slots.

The digital broadcast receiver may know whether or not such a long training sequence is used by checking the block extension mode of each slot.

That is, the stream processing method of the digital broadcast receiver may further include a step of decoding the signaling data on each slot and checking the block extension mode of each slot. More specifically, such a block extension mode may be recorded in the TPC of each slot.

In this case, the digital broadcast receiver may delay the base data detection and processing until the block extension mode of the next slot is checked, even when the receiving of one slot is completed. That is, the method may include detecting the base data of a saw tooth portion located in the boundary of the adjacent slot with the long training sequence and processing the detected base data, when it is confirmed that the block extension mode of the following slot is 00 mode.

According to another exemplary embodiment, the signaling data of each slot may be embodied to notify information on the surrounding slots in advance.

In this case, the digital broadcast receiver may perform a step of decoding the signaling data of the preceding slot among the adjacent slots and checking the block extension mode of the preceding slot and following slot together.

The aforementioned stream processing method of the digital broadcast receiver and digital broadcast transmitter may be performed in the digital broadcast transmitter and digital broadcast receiver having the configuration as illustrated in the aforementioned various drawings and explanation. For example, in the case of the digital broadcast receiver, the digital broadcast receiver may further include a detector configured to perform base data detection and processing besides the basic configuration of the receiver, demodulator, equalizer, decoder, etc. In this case, when it is determined that two slots of block extension mode 00 are received, the detector may detect the long training data disposed in the boundary portion of the slots and utilize the detected result in error correction. In addition, the detector may provide the detected result to at least one of the demodulator, equalizer, decoder, etc.

[Location of Training Data Considering RS Parity]

Regarding a segment for which an RS parity value is already determined, in order for the receiver to operate normally without generating any error, the precalculated RS parity value must be changed as the data of the segment changes in the trellis encoder initialization process. In the case of a packet where a trellis initialization byte exists, a non-systematic RS parity 20 byte of the corresponding packet cannot be disposed before a trellis initialization byte. A trellis initialization byte can exist only in a location satisfying such restricted conditions, and training data can be generated by such an initialization byte.

As illustrated in FIGS. 64 and 65, in order to arrange the segment so that the trellis initialization byte can be disposed before the RS parity, the RS parity location has been changed to be different from the group format of the BEM 01 slot. That is, in the group format of the BEM 01 slot, in the first 5 segments among the 208 data segments after the interleaving, only RS parity was located, but in the case of the BEM 00 slot, the location of the RS parity may be changed to fill the lower portion of block B2, as illustrated in FIGS. 64 and 65.

Considering the changed RS parity, regarding the location of the training data distributed in the BEM 00 slot, the 1^{st}, 2^{nd} and 3^{rd} training data may be located in the 7^{th}, 8^{th} segment, 20^{th}, 21^{st} segment, and 31^{st}, 32^{nd} segment in block B1 and B2 areas. In the 33^{rd} to 37^{th} segments of block B1 and B2 area, the changed RS parities may be located. In addition, in the tail area, the 1^{st}, 2^{nd}, 3^{rd}, 4^{th}, and 5^{th} training data may be located in the 134^{th}, 135^{th} segment, 150^{th}, 151^{th} segment, 163^{rd}, 164^{th} segment, 176^{th}, 177^{th} segment, 187^{th}, 188^{th} segment. In the case where two BEM 00 slots are adjacent to each other and generate a concatenated long training data, the 1^{st} training data of block B1 and B2 area and the 3^{rd} training data of the tail area, the 2^{nd} training data of block B1 and B2 area and the 4^{th} training data of the tail area, the 2^{nd} training data of block B1 and B2 area and the 4^{th} training data of the tail area, and the 3^{rd} training data of block B1 and B2 area and the fifth training data of the tail area may be connected to each other.

As aforementioned, training data may be disposed in various ways, and an initialization regarding the training data may be performed in various ways as well.

The digital broadcast receiver detects training data from the location where training data is disposed. More specifically, it is possible to detect information for notifying the disposition location of the training data in the configurations such as the detector or signaling decoder illustrated in FIG. 52. Accordingly, it is possible to detect the training data in the location and correct the error.

[Adjacent Slot]

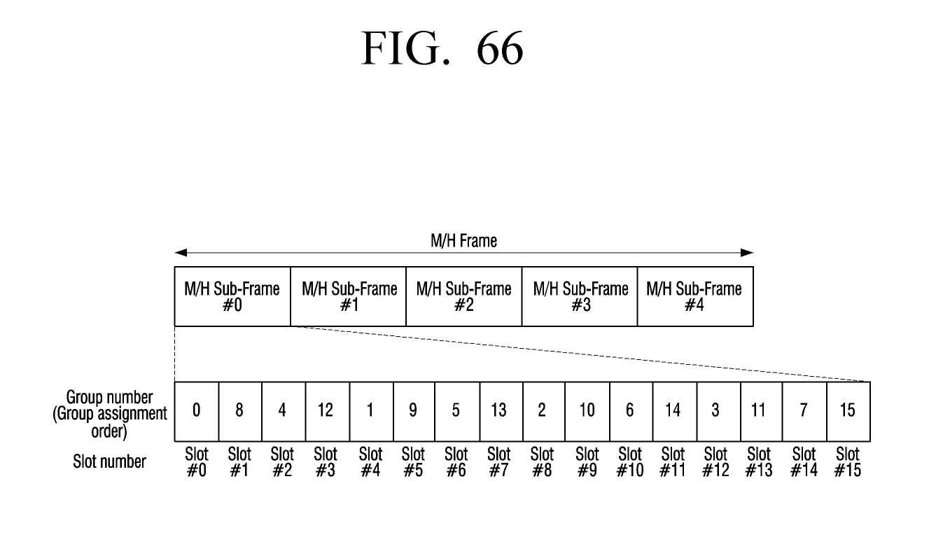

The ATSC-M/H system allocates the M/H group in 16 slots inside the sub frame according to a certain order. FIG. 66 illustrates the group allocation order. There is unique group allocation order for each slot number, for example, 0^{th} for slot #0, 1^{st} for slot #4, 2^{nd} for slot #8, and 3^{rd} for slot #12. Such a group allocation order may be appropriately determined according to the total number of parades, and the number of slots that each parade uses. More specifically, the group allocation order may be determined so that one parade is not sequentially disposed in two or more sequential slots.

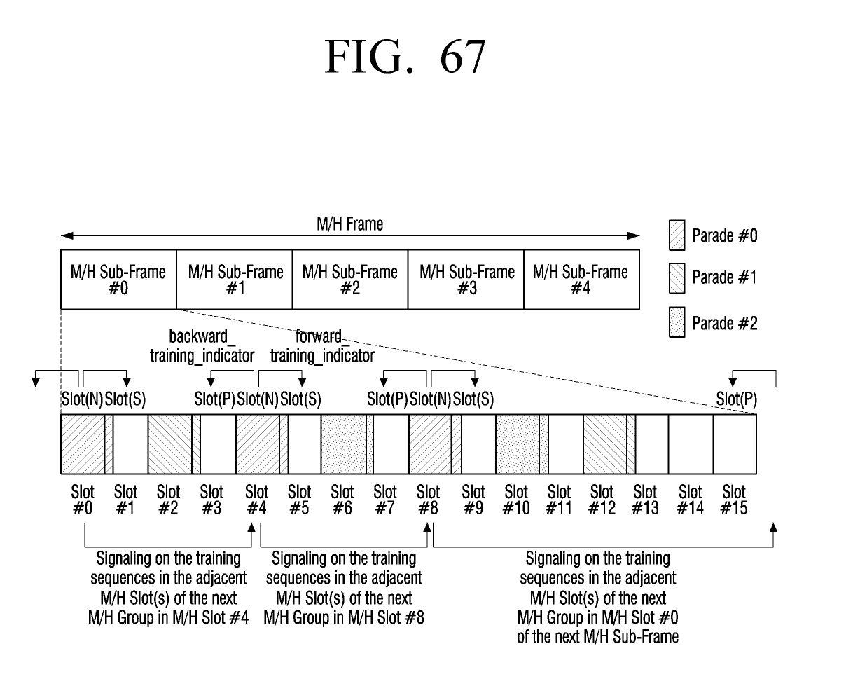

FIG. 67 illustrates an example where a plurality of parades is allocated to a slot. As shown in FIG. 67, 3 parades are not allocated sequentially according to the slot numbers, but are disposed in an allocation order of each slot so that a particular parade is not sequentially disposed in the order of the slot. That is, in the case of parade #0, there are 3 NoG, and thus, mobile data is allocated to 3 slots, not 3 slots #0, #1, #2, but 3 slots #0, #4, #8. Parades #1, #2 are disposed therebetween.

As such, when a particular parade is disposed according to the slot allocation order, mobile data of the same parade may be allocated before/after any slot, but this may not always be the case. As illustrated in FIG. 67, it can be seen that slot #1 which is the next slot after slot #0 is a slot where main data is allocated and not the mobile data of the same parade #0. Consequently, the front/back slot adjacent to any one slot may have different data types, M/H group configuration, etc.

[Notifying Adjacent Slot Information]

Since the configuration of each slot and adjacent slots may be different, in addition to the aforementioned various exemplary embodiments, an exemplary embodiment of notifying information on the adjacent slot and utilizing the same may be provided.

For example, in the TPC (Transmission Parameter Channel) data portion which transmits configuration related information among the signaling data of mobile data, information on the front and back slot of the corresponding slot, that is, the adjacent slot, may be included.

That is, as aforementioned, in the ATSC-M/H system, the front/back slot of any slot may have a different type of data and M/H group configuration. Conventionally, the TPC information of the front/back slot ought to be decoded first so as to obtain information of the adjacent front/back slot besides the slot corresponding to the parade to be decoded by the receiver. As a result, additional power consumption occurred in accessing the adjacent slot at every M/H frame, which served as a burden in embodying the receiver. In order to improve this, there may be provided an exemplary embodiment of adding information of an adjacent slot to the TPC of any slot and transmitting the same.

Of the information on an adjacent slot, the information having the most utility in the receiver is training sequence related information.

As such, according to an additional exemplary embodiment, it is possible to transmit adjacent slot information using the reserve area of TPC.

According to an exemplary embodiment, TPC may be provided as in the following table.

TABLE 24

| | | |
|---|---|---|
| | No. of | |
| Syntax | Bits | Format |

TPC_data{

| | | |
|---|---|---|
| sub-frame_number | 3 | uimsbf |
| slot_number | 4 | uimsbf |
| parade_id | 7 | uimsbf |

| | | |
|---|---|---|
| if(sub-frame_number≦1){ | | |
| current_starting_group_number | 4 | uimsbf |
| current_number_of_groups_minus_1 | 3 | uimsbf |
| } | | |
| if(sub-frame_number≧2){ | | |

| | | |
|---|---|---|
| next_starting_group_number | 4 | uimsbf |
| next_number_of_groups_minus_1 | 3 | bslbf |

}

```
  ~~~~~~~~~~~~~~~
  ~~~~~~~~~~~~~~~
  ~~~~~~~~~~~~~~~
```

if(tpc_protocol_version==‘11000’){

if(sub-frame_number≦1){

| | | |
|---|---|---|
| current_scalable_mode | 3 | uimsbf |

}
if(sub-frame_number≧2){

| | | |
|---|---|---|
| next_scalable_mode | 3 | uimsbf |

| | | |
|---|---|---|
| } | | |
| sccc_block_extension_mode | 2 | uimsbf |
| reserved | 11 | bslbf |
| } | | |

if(tpc_protocol_version=‘11111’){

| | | |
|---|---|---|
| reserved | 16 | bslbf |

}

| | | |
|---|---|---|
| tpc_protocol_version | 5 | bslbf |
| } | | |

As in the aforementioned table 24, in the reserve area of TPC, information on the adjacent slot may be included according to the protocol version. In table 24, tpc_protocol_version is a field denoting the version of TPC syntax structure, and the field consists of 5 bits.

As illustrated in FIG. 67, in the TPC reserve area of slot #0, information on the adjacent slot of slot #4 which is the same parade may be included. In this case, in slot #4, information on the adjacent slot of slot #8 which is the same parade may be included. In addition, in slot #8, information on the adjacent slot of slot #0 of the next sub frame may be included.

Herein, the adjacent slot may be the previous slot or the next slot, or both the previous slot and the next slot. That is, both the first indicator of the previous slot and the second indicator of the next slot may be included.

In addition, adjacent slot information may indicate at least one of whether or not training data exists in the adjacent slot, type of training data, block extension mode of adjacent slot, scalable mode of adjacent slot, and orphan type existing in the adjacent slot. Besides these, information on the field to be transmitted among the existing TPC field may also be included.

In the case where slot(n) is a CMM slot, the information on the adjacent slot(n−1) of which the saw tooth engages the B1, B2 block area of slot(n) may be utilized in decoding of slot(n). Therefore, it is desirable to use the information related field of slot(n−1) with the TPC of slot(n).

However, it is not the B1, B2 block area of slot(n+1) but the 38 packet area of slot(n) where the saw tooth engages with the B9, B10 block area of slot(n), which is CMM slot. Therefore, in the case of CMM slot, it may not be necessary to add the information of the related field of slot(n+1). That is, when adding information of an adjacent slot to the TPC of the adjacent slot, all the information of the adjacent front/back slot may be added according to the type of the slot, or only the information of the adjacent front slot may be added.

As such, there may be a case where information on both the previous slot and the next slot is necessary and a case where only the information on the previous slot is necessary, depending on the type of the slot. Considering this, in other exemplary embodiments, a slot indicator may be utilized in order to distinguish the type of the slots.

In the case of an exemplary embodiment utilizing a lost indicator, the TPC information may be created as in the following table.

TABLE 25
Syntax No. of Bits Format

| | | |
|---|---|---|
| TPC_data(sub-frame_numberslot_numberparad | 34754555513123 | uimsbfuimsbfui |
| e_idif(sub-frame_number≦1) | 13326165 | msbfuimsbfuims |
| {~~~~~~~~~~~~~~~~~~~~~~~~~~~~~~~~~~~ | | bfuimsbfbslbfui |
| ~~~~~~~ omitted | | msbfuimsbfbslbf |
| ~~~~~~~~~~~~~~~~~~~~~~~~~~~~~~~~~~~~ | | bslbfbslbfbslbfbs |
| ~~~~~~~~~~~~~~~~~~~~~~ | | lbfbslbfbslbfbslb |
| }fic_versionparade_continuity_conterif(sub-fra | | fbslbfbslbfbslbf |
| me_number≦1) | | |
| {current_TNoGreserved}if(sub-frame_number≧ | | |
| 2){next_TNoGcurrent_TNoG}if(tpc_protocol_{—} | | |
| version==‘11000’){ slot_indicator | | |
| if(slot_indicator==‘0’{ | | |
| backward_training_indicator reserved } | | |
| if(slot_indicator==‘1’{ | | |
| backward_training_indicator | | |
| forward_training_indicator | | |
| if(sub-frame_number≦1) { | | |
| current_scalable_mode } | | |
| if(sub-frame_number≧2){ next_scalable_mode | | |
| } sccc block_extension_mode_reserved } } | | |
| if(tpc_protocol_version=‘11111’){ reserved | | |
| }tpc_protocol_version} | | |

As in the aforementioned table 25, as new mobile data is transmitted, fields such as a slot indicator, forward training indicator, backward training indicator, etc., may be added to the TPC data. Herein, depending on the location of the slot on the stream, the backward training indicator or the forward training indicator may refer to the first indicator of the previous slot, and another one may refer to the second indicator of the next slot.

According to the exemplary embodiment disclosed in table 25, it can be seen that when the slot indicator is 0, only 3 bits is used regarding the backward training indicator. On the other hand, it can be seen that when the slot indicator is 1, besides the 3 bits regarding the backward training indicator, 1 bit is allocated to the forward training indicator as well.

In table 25, a slot indicator denotes the type of M/H slot. When the slot indicator is “0”, this indicates that the current M/H slot has 118 M/H packets and 38 TS-M packets. On the other hand, when the slot indicator is “1”, this indicates that the current M/H slot has 118+x M/H packets and y TS-M packets. Herein, x+y is 38.

A backward training indicator shows the characteristics of the training sequence in the previous slot for the next slot of the current parade or the characteristics of the training sequence in M/H block B1 and B2 of the next slot for the current parade. The backward training indicator may be set in various ways as in the following table.

TABLE 26

| | | | Slot(P) training | Slot(N) training | Slot(N) training |
|---|---|---|---|---|---|
| Value | Slot(P) type | Slot(N) type | location | location | concatenation |
| 000 | BEM = 01 | CMM(Dual) or | Region E | M/H Blocks B1 | Yes |
| | SM = 000 | BEM = 01 | | and B2 | |
| | | SM = 000-011 | | | |
| 001 | BEM = 01 | CMM(Dual) or | Region E | M/H Blocks B1 | Yes |
| | SM = 001 | BEM = 01 | | and B2 | |
| | | SM = 000-011 | | | |
| 010 | BEM = 01 | CMM(Dual) or | Region E | M/H Blocks B1 | Yes |
| | SM = 010 | BEM = 01 | | and B2 | |
| | | SM = 000-011 | | | |
| 011 | BEM = 01 | CMM(Dual) or | Region E | M/H Blocks B1 | Yes |
| | SM011 | BEM = 01 | | and B2 | |
| | | SM = 000-011 | | | |
| 100 | BEM = 00 | CMM | Region E | N/A | No |
| | BEM = 00 | BEM = 00 | Region E | M/H Blocks B1 | Yes |
| | | | | and B2 | |
| 101 | CMM or Main | CMM | N/A | N/A | No |
| | CMM or Main | BEM = 00 | N/A | M/H Blocks B1 | No |
| | | | | and B2 | |
| 110 | CMM or Main | BEM = 01 | N/A | M/H Blocks B1 | No |
| | | SM = 000-011 | | or B2 | |
| | | | | (Orphan type 1) | |
| 111 | CMM(Dual) | BEM = 01 | M/H Blocks B9 | M/H Blocks B1 | No |
| | | SM = 000-011 | and B10 | and B2 | |
| | | | (Orphan type 2) | (Orphan type 1) | |
| | BEM = 01 | BEM = 01 | Region E | M/H Blocks B1 | Yes |
| | SM = 111 | SM = 111 | | and B2 | |

In table 26, slot(N) denotes the next slot in the current parade, whereas slot(P) denotes the slot directly preceding the slot(N). As aforementioned, the backward training sequence may be set to have various values such as 000, 001, 010, 011, 100, 101, 110, 111 depending on the relationship of slot(P) and slot(N).

A forward training indicator denotes the characteristics of the training sequence of the slot following the next slot in the current parade. As aforementioned, if slot(N) denotes the next slot in the current parade, slot(S) denotes the slot transmitted right after slot(N). A forward training sequence may be set to have various values as in the following table.

TABLE 27

| | | | Slot(N) training | Slot(S) training | Slot(N) training |
|---|---|---|---|---|---|
| Value | Slot(N) type | Slot(S type | location | location | concatenation |
| 1 | BEM = 01 | CMM(Dual) or | Region E | M/H Blocks B1 | Yes |
| | SM = 000-011 | Parial Main or | | and B2 | |
| | | BEM = 01 | | | |
| | | SM = 000-011 | | | |
| | BEM = 01 | BEM = 01 | Region E | M/H Blocks B1 | Yes |
| | SM = 111 | SM = 111 | | and B2 | |
| | BEM = 00 | BEM = 00 | Region E | M/H Blocks B1 | Yes |
| | | | | and B2 | |
| 0 | BEM = 00 | CMM or Main | Region E | N/A | No |

According to table 27, in the case where the block extension mode of the corresponding slot is 01 and the next slot is CMM slot, partial main slot or SFCMM slot having block extension mode 01, and in the case where the block extension mode of the corresponding slot is 00, and the next slot is SFCMM slot having block extension mode 00, the training indicator is set as 1.

On the other hand, in the case where the block extension mode of the corresponding slot is 00, and the next slot is CMM slot or main slot, the training indicator is set as 0.

Herein, a partial main slot denotes an M/H slot which is smaller than the 156 main packets and which has a type 3 orphan in table 17.

As such, a backward training indicator or backward training indicator/forward training indicator may be selectively included according to the value of the slot indicator.

As aforementioned, the slot indicator, backward training indicator, forward training indicator, etc., may be determined based on the next slot corresponding to the same parade as the current parade, but is not limited thereto. That is, the slot indicator, backward training indicator, and forward training indicator may be determined based on the current slot.

In addition, as aforementioned, the adjacent slot information may be notified in various formats.

The configuration of the digital broadcast transmitter configured to transmit adjacent slot information together may be embodied to be the same as the aforementioned configuration of the various digital broadcast transmitters.

For example, the digital broadcast transmitter of the present exemplary embodiment may have the same configuration as illustrated in FIG. 4. More specifically, the digital broadcast transmitter may include a data preprocessor, mux, normal processor, and exciter. For convenience of explanation, the data preprocessor, normal processor, and mux will be referred to as a stream configurer.

As illustrated in FIGS. 66 and 57, the stream configurer allocates groups for a plurality of parades. The group allocation order may be determined depending on the group number of each parade. More specifically, groups of the same parade may be disposed not to be sequential to each other. Such an operation may be made by the control operation of an additional controller and according to programming of each block.

The data preprocessor may dispose 1.0 version data, 1.1 version data and training data according to the mode information set for each parade (that is, block extension mode, etc.). This was already explained in the various aforementioned exemplary embodiments, and thus a repeated explanation thereof is omitted.

As such, when the training data is disposed together with each M/H data, the signaling encoder inside the data preprocessor disposes the information on the adjacent slot in the reserve area of TPC according to the block extension mode information, to provide signaling data. Signaling data is included in the stream by the group formatter, processed together with the operations of the mux and exciter, and then broadcasted.

According to an exemplary embodiment, the stream processing method of the digital broadcast transmitter may include a step of forming a stream containing slots where M/H data is allocated and a transmitting step of encoding and interleaving the stream and outputting the encoded and interleaved stream.

Herein, each slot of the stream includes signaling data. TPC of the signaling data may be embodied in formats illustrated in the aforementioned table 24 or table 25. In the case of the exemplary embodiment of table 25, the signaling data includes a slot indicator which denotes the type of the slots. In addition, the signaling data may include at least one of the backward training indicator and forward training indicator according to the value of the slot indicator.

The step of forming a stream may include a step of disposing each of the plurality of parades in a plurality of slots according to a disposition pattern where the slots corresponding to the same parade are not sequentially connected, creating signaling data including, for example, the slot indicator, backward training indicator, or forward training indicator, encoding the created signaling data, and then adding the encoded signaling data to the stream.

More specifically, parades may be disposed as illustrated in FIGS. 66 and 67. In addition, according to the disposition format and type of each slot, as disclosed in table 25, the value of the slot indicator, backward training indicator, and forward training indicator may be determined. The determined value is recorded in a bit of the field allocated to each indicator.

According to table 25, in the case of a CMM slot, the information on the training data at the previous slot is created by the backward training indicator, and the forward training indicator is not created. On the other hand, in the case of an SFCMM slot, the information on the training data at the previous slot right before the SFCMM slot is created with the forward training indicator.

As aforementioned, it is possible for the digital broadcast receiver to record various types of indicators and effectively use the previous slot and the following slot according to the type of the slot.

The digital broadcast receiver may receive the broadcasted transport stream, detect the signaling data, decode the detected signaling data, and check the adjacent slot information.

The configuration of the digital broadcast receiver according to an exemplary embodiment may be embodied in the same manner as in the configuration of the various exemplary embodiments aforementioned.

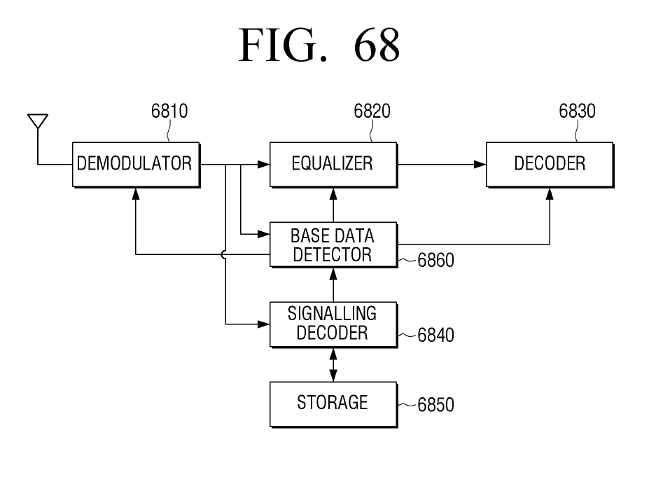

For example, the configuration of the present receiver may be embodied as in FIG. 68.

According to FIG. 68, the digital broadcast receiver includes a demodulator 6810, equalizer 6820, decoder 6830, signaling decoder 6840, storage 6850, and base data detector 6860.

The demodulator 6810 receives the transport stream and demodulates the received transport stream. The demodulated stream outputs the signaling decoder 6840 and equalizer 6820.

The signaling decoder 6840 detects the signaling data from the demodulated stream and performs decoding. The demux (not illustrated) which detects the signaling data may be provided inside the signaling decoder 6840 or at a rear end of the demodulator 6810.

The signaling decoder 6840 processes the signaling data and detects the adjacent slot information from the reserved area of the TPC. More specifically, in the case where the TPC is configured as in the aforementioned table 25, the signaling decoder 6840 checks the tpc_protocol_version and determines whether or not it is CMM slot or SFCMM slot. Then, after checking the slot indicator, the signaling decoder 6840 checks at least one of the backward training indicator and forward training indicator.

In the storage 6850, information on the value of each indicator, a slot type corresponding thereto, and training data location of the adjacent slots, etc., may be stored. More specifically, in the storage 6850, information such as the information in table 26 and table 27 may be stored.

The signaling decoder 6840 reads information matching the indicator value inside the signaling data from the storage 6850.

The read data may be provided to the base data detector 6860.

In the case of a CMM slot, the base data detector 6860 detects base data from the previous slot according to the training sequence information of the previous slot. Accordingly, the detected base data is provided to the demodulator 6810, equalizer 6820, and decoder 6830 together with the base data of the slot. Accordingly, base data may be used in at least one operation of the demodulation, equalization, and decoding etc.

In the case of SFCMM slot, the base data detector 6860 detects the base data disposed in the previous slot and the base data disposed in the following slot according to the training sequence information of the previous slot and the training sequence information of the following slot. In addition, the base data detector 6860 enables the detected base data to be provided to the demodulator 6810, equalizer 6820, and decoder 6830 together with the base data of the slot, and thus, be used in each processing operation.

Besides the above, when an equalizer (not illustrated) is provided, it may be provided to the equalizer.

For example, in the case of having the same BEM 00 mode with the adjacent slots, the equalizer 6820 may use the adjacent slot information notifying the TPC of the slot(n) and use the concatenated long training sequence instead of the short training sequence in the C/D/E area of the slot(n) to perform an equalization operation.

In FIG. 68, the base data detector 6860 is illustrated as a separate module, but instead, the base data detector 6860 may be provided inside the signaling decoder 6840, demodulator 6810, equalizer 6820, or decoder 6830. Accordingly, the base data detector 6860 may be embodied to detect and process the direct base data when the training sequence information is notified.

The value and format of the slot indicator, backward training indicator, and forward training indicator may be determined in various formats as illustrated in the aforementioned tables 25 to 27. Especially, according to table 25, the value of the slot indicator may be expressed as 1 bit, the backward training indicator as 3 bit, and the forward training indicator as 1 bit.

There may be provided an exemplary embodiment which enables modifying the disposition order of the ensemble and predicting the adjacent slot information at the digital broadcast receiver side, unlike in the aforementioned exemplary embodiments.

That is, the digital broadcast transmitter may dispose M/H data and normal data in each slot according to the parade repetition cycle (PRC) of each parade and predetermined rule. A parade repetition cycle refers to a cycle where the same parade is repeated per frame. For example, if the PRC is 3, this indicates that the same parade is transmitted after every 3 M/H frames. Therefore, according to the PRC value of each parade, it is possible to dispose data and transmit the data according to the predetermined rule and have the starting group number (SGN) fixed per frame. In this case, if the digital broadcast receiver knows the rule, it is possible to predict what kind of slot is being used, even if information on the previous slot and the following slot of each slot is not transmitted additionally.

As an example of the aforementioned rule, first of all, a parade of which the PRC is 1, that is, a parade repeatedly disposed per frame is disposed at the foremost. If there is a plurality of parades of which PRC is 1, it is possible to fill sequentially from the one with the smallest group number or from the one with the biggest group number.

Next, regarding the parades of which the PRC is two or above, a PRC aggregation containing all the greatest common denominators and lowest common multiples besides 1 can be created. For example, the PRC aggregation may be created as {2, 4, 8}, {3, 6}, {4, 8}, {5, 5, 5}.

Next, inside the selected PRC aggregation, the PRC is filled in the order of the smallest PRC parade and the smallest group number or in the opposite order thereof.

As such, if the parades are disposed in the slots according to a certain rule, and the digital broadcast receiver shares the aforementioned rule, it is possible to use the training data of the surrounding slots and process together even if adjacent slot information is not transmitted additionally.

As such, according to various exemplary embodiments, it is possible to effectively process the stream using the training sequence of the adjacent slot without additional electricity consumption.

[Exemplary Embodiment for Audio Packet Transmission]

According to the various exemplary embodiments, it is possible to form a stream containing the normal data and mobile data, that is, M/H data, and transmit the formed stream. The number and disposition location of the M/H data may change depending on the various mode settings. In this case, the compatibility with the existing receiver which receives normal data may become a problem. Especially, in the case of the audio packet of normal data, there is a limitation that the digital broadcast receiver has to be provided with an appropriate number of audio packets.

That is, in the case of the MPEG-2 transmission steam, the T-STD (transport stream system target decoders) model defines the main audio buffer size BSn as below:

B_{Sn}=BSₘᵤₓ+BS_{dec}+BSₒₕ

BSₘᵤₓ may be 736 byte, BS_{dec} has a size of an access unit buffer, and BSₒₕ has a size of a PES header overhead.

It is disclosed that MPEG-2 defines BSₙ as a fixed value such as 3584 byte, and an extra buffer may be used for additional multiplexing. When AC-3 elementary stream is transmitted by the MPEG-2 transmission stream, the transport stream must satisfy the main audio buffer size such as BSₙ=BSₘᵤₓ=BS_{pad}+BS_{dec}. Herein, BS_{dec} is 736 byte, and BS_{pad} is 64 byte.

The value of BS_{dec} may be the value of the greatest bit rate supported by the system. That is, when the audio bit rate is lower than the maximum value allowed by a particular system, the buffer size is not reduced. 64 byte in BS_{pad} is valid regarding BSₒₕ and additional multiplexing. According to such limitations, the decoder may have the smallest possible memory buffer.

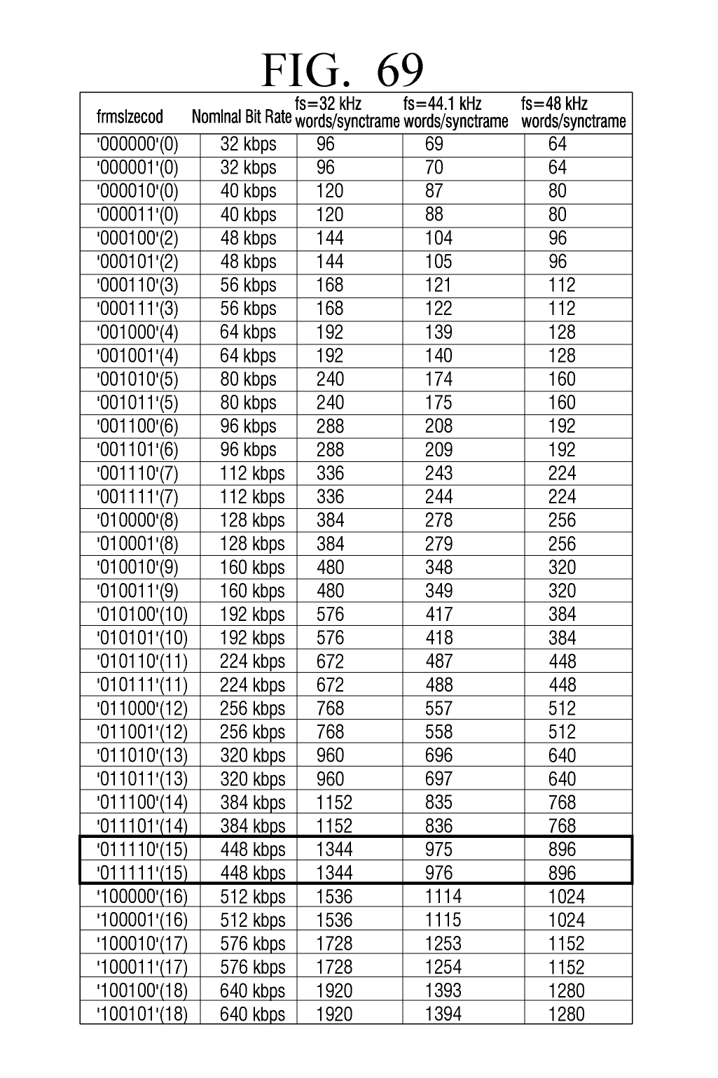

FIG. 69 illustrates a frame size code table defined in A/52.

According to FIG. 69, the duration of the AC-2 access unit is 32 ms in the case of a 48 kHz frequency, 34.83 ms in the case of 44.1 kHz, and 48 ms in the case of a 32 kHz frequency.

According to FIG. 69, when transmitted in 48 kHz, the 448 kbps audio packet has a size of 896*2=1792 byte. Therefore, according to the aforementioned mathematical formula, the main audio buffer size BSn must have 736+64+1792=2592 byte.

In addition, the audio buffer of the digital broadcast receiver must have the entire audio frame before the decoder fetches the packet. According to FIG. 69, in the case of 448 kbps audio stream, one frame has a size of 1792 bytes. Therefore, the audio packet of 1792 bytes must be buffered before the decoding is made. When 48 kHz sampling rate is applied, the time distance that the AC-3 decoder accesses the audio buffer is 32 ms. Therefore, an audio packet of 1792 byte size must be buffered in the audio buffer per 32 msec. Since one packet is 184 byte, 1792/184 is calculated as 9.739. Therefore, at least 10 packets must be disposed in a stream per 32 msec.

However, in some SFCMM slots, M/H data accounts for a significant portion of the normal data area, and thus, an audio packet that does not satisfy the main audio buffer size may be provided. That is, as in the aforementioned example, there may be a case where 448 kbps audio packets are transmitted in 48 kHz frequency, and a case where 2592 bytes are transmitted per 32 ms which may be difficult due to an insufficient normal data area. Therefore, since it is not suitable to the MPEG-2 standard, there arises a problem that compatibility with the existing receiver becomes difficult.

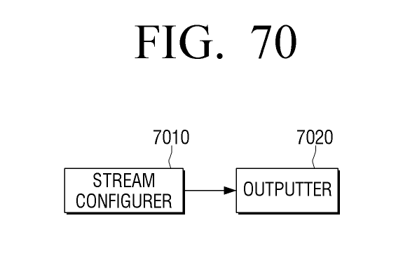

FIG. 70 illustrates a configuration of the digital broadcast transmitter according to another exemplary embodiment capable of providing an appropriate number of audio packets while transmitting a transport stream containing normal data and M/H data.

According to FIG. 70, the digital broadcast receiver includes a stream configurer 7010 and an outputter 7020.

The stream configurer 7010 forms a stream containing normal data and M/H data. The stream configurer 7010 may be configured in a format containing the data preprocessor 100, normal processor 320, and mux 200 illustrated in FIG. 4.

The outputter 7020 encodes the stream formed by the stream configurer 7010, encodes and interleaves the encoded stream, and outputs the encoded and interleaved stream. The outputter 7020 may be configured in a format similar to the exciter 400 illustrated in FIG. 4. Therefore, a repeated explanation on the detailed configuration and operations of the outputter 7020 are omitted.

The stream configurer 7010 may configure the stream so that a predetermined number of audio packets of normal data may be disposed per predetermined type cycle.

The time cycle and number of audio packets may be determined differently according to the size and frequency of the audio stream. That is, as aforementioned, in the case of a 448 kbps audio stream, a stream is configured so that at least 10 audio packets are disposed per 32 ms time cycle.

On the other hand, according to FIG. 69, in the case of a 48 kbps audio stream, the audio frame size is 192 bytes. Since 192/184=1.04, at least 2 packets are to be transmitted per 32 ms. However, in the case of a 48 kbps audio stream, there is concern that an underflow may occur in the audio buffer, and thus it is possible to increase the transmission cycle to twice the predetermined number. For example, when increased by 8 times, the size of the audio stream to be transmitted becomes 192*8=1536, and the time cycle becomes 32*8=256 msec. The packet number is 1536/184=8.35, and thus 9. In summary, regarding the 48 kbps audio stream, the stream configuration 7010 may form the stream such that at least 9 audio packets are disposed per 256 msec time cycle. When configured as such, even if the access unit takes 1.04 packets from the audio buffer per 32 ms, it is possible to prevent underflow from occurring in the audio buffer. Regarding the other audio stream, it is also possible to determine the time cycle and audio packet number according to FIG. 69 and the aforementioned mathematical formula.

The stream forming method may be embodied in various ways according to exemplary embodiments.

First of all, it is possible to embody a method enabling obtaining a normal data area per certain time cycle by determining a parade repetition cycle (PRC) of greater than 1.

That is, the stream configuration 7010 obtains the normal data area per predetermined time cycle by repeatedly disposing each M/H parade configuring the M/H data inside the stream according to the parade repetition cycle, and disposes the audio packet in the obtained normal data area. The parade repetition cycle is determined to be between 1 and 7 so as to obtain the normal data area per determined time cycle. As aforementioned, a parade repetition cycle refers to a cycle where the same parade is repeated per frame. For example, if the PRC is 0, the parade is repeated per frame, and if the PRC is 1, the parade is repeated once every other frame. If M/H parade appears per every frame, there may be a case where there is not enough of a normal data area according to the slot format inside the M/H parade. In order to prevent such a case, for the M/H parade filled with M/H data according to the scalable mode using much of the normal data area, it is possible to determine the parade repetition cycle to be greater than 1, so that at least a minimum amount of normal data area can be obtained per determined time cycle.

As a second method, it may be possible to apply various scalable modes so that the normal data area may be obtained per certain time cycle.

That is, the stream configurer 7010 forms a stream so that a plurality of slots where M/H data is disposed are sequentially disposed according to different scalable modes to obtain a normal data area per predetermined time cycle, and disposes audio packets in the obtained normal data area.

As aforementioned, the scalable modes may be determined in various ways such as 00, 01, 10, 11, 11a. The disposition method of M/H data of each mode has already been explained in detail and thus a repeated explanation thereof is omitted. The size of the normal data area inside each slot changes depending on the scalable mode. That is, in the case of scalable mode 11 or 11a, there is an insufficient normal data area compared to other modes. Considering this fact, it is possible to appropriately design and adjust the scalable mode of the sequential slots so that a normal data area can be obtained per certain cycle.

As a third method, it may also be possible to determine the block extension mode in various ways.

The stream configurer 7010 may form a stream so that a plurality of slots for which different block extension modes are set are sequentially connected and thereby obtain a normal data area, and dispose audio packets in the obtained normal data area.

The block extension mode may be set to 00, 01. In the case of 00, there is no normal data area, and slots where all of the 156 packets are filled with mobile data are created, and in the case of 01, slots having various normal data areas according to the scalable mode are created. Considering the above, it is possible to form a stream so that a normal data area can be obtained per certain cycle by appropriately designing the block extension mode of the sequential slots.

As a fourth method, it is possible to combine different types of slots and obtain a normal data area. For example, it is possible to alternately and repeatedly dispose a CMM slot and an SFCMM slot, or combine at least two of the CMM slot, SFCMM slot, and main slot.

CMM slot refers to a slot where 38 packets of the entire group of packets are allocated to normal data, and the remaining packets are allocated to M/H data. SFCMM slot refers to a slot where M/H data is allocated to the entirety or a portion of the 38 packets allocated to normal data among the entire group of packets, according to the mode. Main slot refers to a slot filled with only normal data.

CMM slot has a slot characteristic that 38 normal data areas exist, and SFCMM slot has a slot characteristic that less than 38 of normal data areas exist. Considering these slot characteristics, the stream configuration 7010 combines the CMM slot and SFCMM slot and forms a stream so that a specific slot is disposed at the point where a normal data area is necessary. Consequently, when a normal data area is obtained, the stream configuration 7010 may dispose audio packet to that area. The slot combining method may be determined in a superior level and be provided to the stream configuration 7010.

In the case where different types of slots are combined, the combination state may be notified to the digital broadcast receiver side through the signaling data. That is, as aforementioned, the slot type may be defined using the TPC or FIC inside the signaling data. Therefore, when the CMM slot and SFCMM slot are combined to obtain a normal data area, information on the slot type recorded in the signaling data is modified. In the case where the stream configuration 7010 is configured as illustrated in FIG. 4, the signaling encoder 150 provided inside the stream configuration 7010 encodes the signaling data and provides the encoded signaling data to the group formatter 130. The group formatter 130 processes the signaling data with M/H data, provides the processed data to the packet formatter 140, and packet formats the provided data and provides the packet formatted data to the mux 200. The mux 200 muxes the data processed in the packet formatter 140 and the normal data processed in the normal processor 320 to form a stream. The signaling encoder 150, group formatter 130, packet formatter 140, and normal processor 320 have already been explained and thus a repeated explanation thereof is omitted.

As a fifth method, it is possible to set the starting group number (SGN) per M/H parade and allocate the appropriate slot at a point where a normal data area is necessary. The starting group number denotes the number of groups initially allocated to the parade where that group belongs to. Therefore, when the group number is set differently, it is possible to prevent specific groups being concentrated to specific parades, thereby appropriately dispersing normal data area.

The stream configurer 7010 may dispose the M/H parade inside the stream according to the starting group number set differently per each M/H parade configuring the M/H data to obtain normal data area per time cycle. In the obtained area, audio packets are disposed.

As a sixth method, it is possible to combine the CMM ensemble with the SFCMM ensemble. An ensemble is a type of service unit, referring to an aggregation of sequential RS frames having the same FEC code. Each RS frame encapsulates the aggregation of an IP strip. An ensemble may be a CMM ensemble or an SFCMM ensemble. A CMM ensemble refers to a primary ensemble or secondary ensemble defined in ATSC A/153 part 2. A SFCMM ensemble refers to a primary ensemble or secondary ensemble for providing SFCMM service. The SFCMM ensemble is not recognized by the CMM receiver or CMM decoder, but has backwards compatibility.

The CMM ensemble consists of CMM slots having 38 normal data packets, and thus, has a greater normal data area than an SFCMM area.

Considering this fact, the stream configuration 7010 combines the CMM ensemble and SFCMM ensemble so that the normal data area may be obtained per determined time cycle. In addition, the stream configuration 7010 disposes audio packets in the obtained normal data area.

Also, in the case where a CMM ensemble and an SFCMM ensemble are combined, it is necessary to modify the signaling data and notify the digital broadcast receiver which ensemble is disposed. That is, the signaling encoder inside the stream configuration 7010 encodes the signaling data for informing the combination state of the CMM ensemble and SFCMM ensemble to be included in the stream.

The various methods aforementioned may be used individually or may be used in combinations. For example, it is possible to combine at least two types of slots of the CMM slot, SFCMM slot, and main slot, and set in at least one of the block extension mode, scalable mode, PRC, and SGN, to obtain a normal data area. It is understood that an ensemble combination may also be combined.

In addition, in the various aforementioned methods, a determination of the PRC, slot type, block extension mode, scalable mode, SGN, ensemble type, etc., for audio packet transmission may be made according to a user command input through the inputter (not illustrated) provided inside the digital broadcast transmitter, or according to an algorithm predetermined by the controller provided inside the digital broadcast transmitter. In the case where the stream configuration 7010 is configured as in FIG. 4, the operation of forming the stream according to the determined parameter may be performed in the group formatter 130 inside the stream configuration 7010. In addition, the operation of disposing the audio packets in the obtained normal data area may be performed by the normal processor 320 inside the stream configuration 7010.

Besides the above, it is possible to set an appropriate limitation to the ATSC-M/H system so that a certain size of audio packets may be transmitted at a certain time cycle. For example, considering the general audio buffer size that is defined in the standard or generally used in the markets, it is possible to set a limitation so as not to transmit a stream having a configuration where an error is expected to occur.

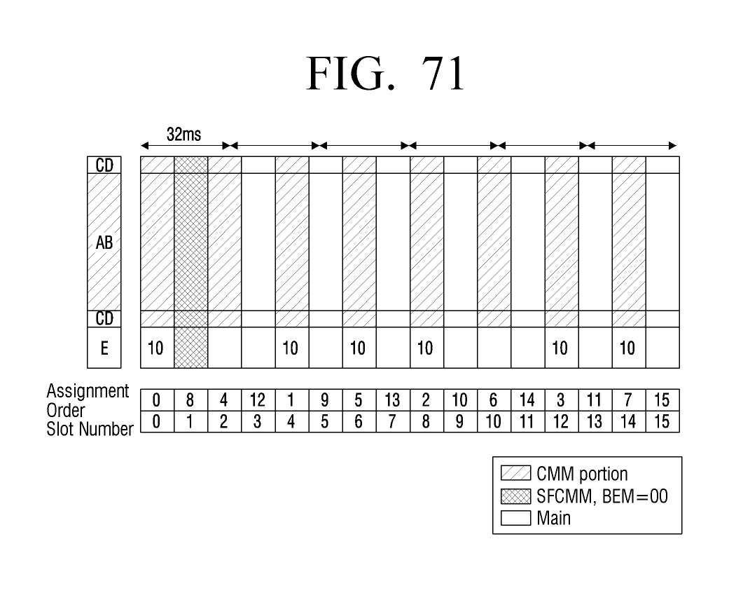

FIG. 71 illustrates an example of a stream configuration where a normal data area is obtained in order to transmit a 448 kbps audio stream. FIG. 71 illustrates a method where a CMM slot, an SFCMM slot, and a main slot are combined to obtain a normal data area, and an appropriate number of audio packets are inserted in the obtained area. According to FIG. 71, while a number 2 slot among a total of 16 slots is being transmitted, 32 msec passes and the second time cycle arrives, and while a number 5 slot is being transmitted, the third time cycle arrives. Considering such time cycles, a number 0 slot consists of CMM slots, and a number 1 slot consists of SFCMM slots having block extension mode 00. In addition, number 2 slots to number 16 slots are configured by a pattern where a CMM slot and main slot are alternately repeated. In this case, a normal data area is obtained per 32 ms. Herein, when audio packets are disposed in E area of number 0, 2-15 slots, an overflow exceeding the size of the audio buffer provided in the digital broadcast receiver may occur. Considering this fact, 10 audio packets are disposed in E area of number 0, 4, 6, 8, 12, and 14 slots. Consequently, it becomes possible to transmit at least 10 audio packets per 32 msec, preventing overflow. The digital broadcast receiver accesses the audio packets stored in the audio buffer per 32 msec time cycle, thereby reproducing audio signals.

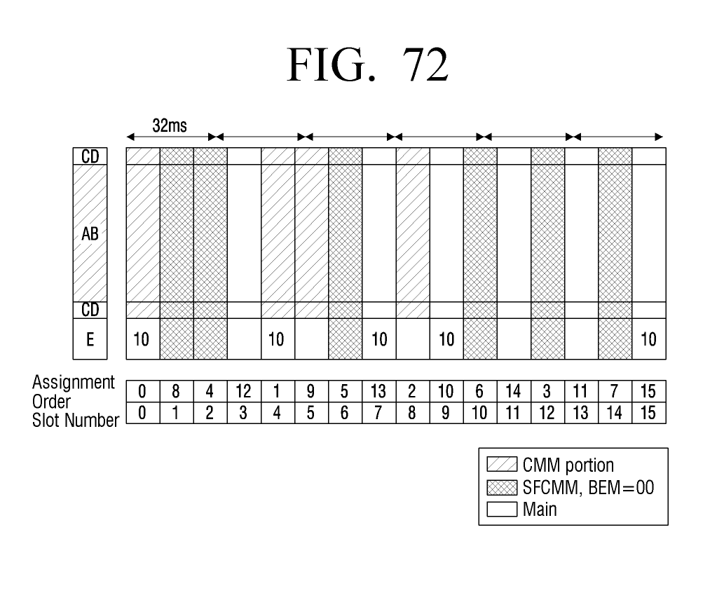

FIG. 72 illustrates another example of a stream configuration where a normal data area is obtained to transmit a 448 kbps audio stream. FIG. 72 illustrates a method of combining the CMM slot, SFCMM slot, and main slot, and adjusting the block extension mode of the SFCMM slot to obtain a normal data area, and inserting an appropriate number of audio packets in the obtained area. According to FIG. 72, number 1, 4, 5, 8 slots consist of CMM slots, and number 1, 2, 6, 10, 12, 14 slots consist of SFCMM slots having block extension mode 00. In this case, when 10 audio packets are disposed in E area of number 0, 4, 7, 9, 11, 15 slots, it becomes possible to prevent the overflow and underflow while transmitting an appropriate number of audio packets. In the case of FIG. 72, the number of groups are not limited as shown, and thus it is possible to change the number of groups (NoG) to provide a main service of 8.5 Mbps.

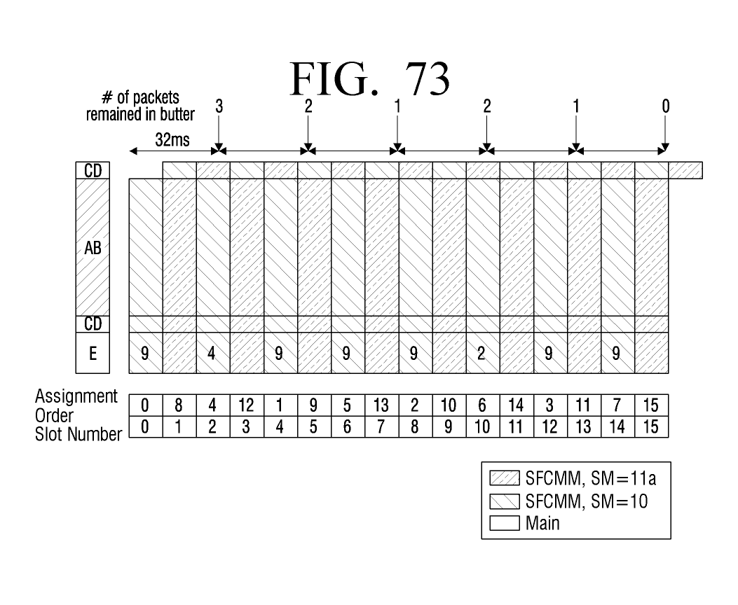

FIG. 73 illustrates another example of a stream configuration where a normal data area is obtained to transmit a 448 kbps audio stream. FIG. 73 illustrates a method of setting the scalable mode of each slot differently and obtaining a normal data area, and inserting an appropriate number of audio packets in the obtained area. According to FIG. 73, a stream is configured with only SFCMM slots. Of these, number 1, 2, 4, 6, 8, 10, 12, 14 slots consist of SFCMM slots of which the scalable mode is 10, and number 1, 3, 5, 7, 9, 11, 13, 15 slots consist of SFCMM slots of which the scalable mode is 10. As explained in FIG. 37, when the scalable mode is 10, that is the third mode, 9 packets are obtained as a normal data area. Accordingly, 9 audio packets are disposed in E area of number 0 slot, 4 audio packets are disposed in E area of number 2 slot, and 9, 9, 9, 2, 9, 9 audio packets are disposed in E area of number 4, 6, 8, 10, 12, 14 slots.

When disposed as above, when the first 32 msec time cycle arrives, 3 audio packets are left in the audio buffer. When the second 32 msec time cycle arrives, 2 audio packets are left. According to FIG. 73, at least 10 audio packets are buffered by the audio buffer whenever 32 msec time cycle arrives, thereby preventing occurrence of overflow or underflow.

In FIG. 73, only scalable mode 11a and 10 are set to alternately be repeated, but it is understood that different scalable modes may also be set.

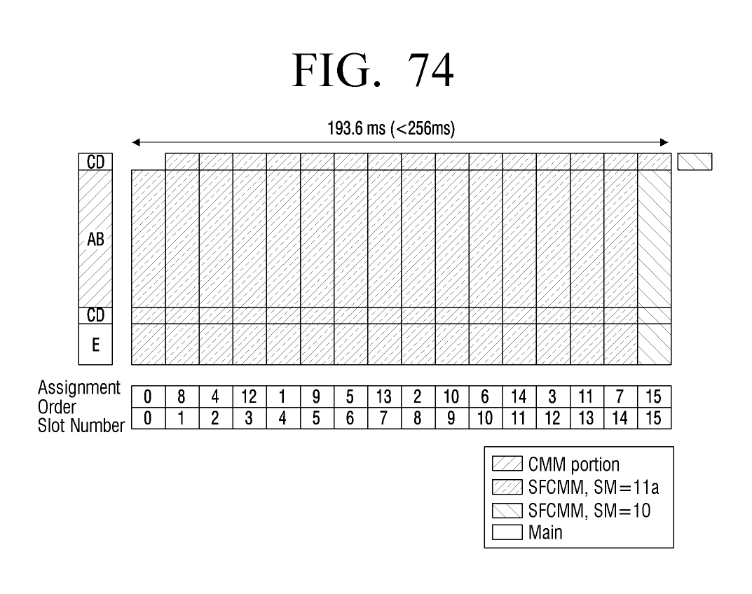

FIG. 74 is an example of a stream configuration where a normal data area for transmitting a 48 kbps audio stream is obtained. As aforementioned, in the case of 48 kbps audio stream, 1.04 packets may be transmitted per 32 msec. There only needs to be a stream having a format as illustrated in FIG. 73 in order to transmit 1.04 packets per 32 ms. However in this case, when there is no other service besides the normal data 48 kbps audio stream, normal data is wasted and an M/H data rate is reduced. Therefore, it is possible to increase the transmission cycle by 8 times and increase the packet to 9 and then make the transmission. In this case, even if the access unit of the digital broadcast receiver takes 1.04 packets per 32 ms from the audio buffer, (9-1.04) packets are left in the buffer, thereby preventing underflow. Accordingly, as illustrated in FIG. 74, it is possible to configure the stream so that 9 audio packets are transmitted per 32*8=256 msec transmission cycle.

That is, according to FIG. 74, number 0 to 14 slots consist of SFCMM slots having scalable mode 11a, and number 15 slot consists of SFCMM slots having scalable mode 10. Accordingly, it becomes possible to transmit 9 audio packets inside 193.6 msec which is lower than 256 msec.

As such, it is possible to change the stream configuration in various methods so as to obtain a normal data area, and normally buffer the audio data at the digital broadcast receiver side, thereby reproducing the audio data.

The aforementioned stream processing method of the digital broadcast transmitter includes a step of forming a stream containing normal data and M/H data and a transmitting step of encoding and interleaving the stream and outputting the encoded and interleaved stream.

The step of forming a stream may include forming the stream so that a predetermined number of audio packets of normal data are disposed per predetermined time cycle. Various stream methods have already been explained hereinabove and thus a repeated explanation thereof is omitted. Flowcharts are also omitted.

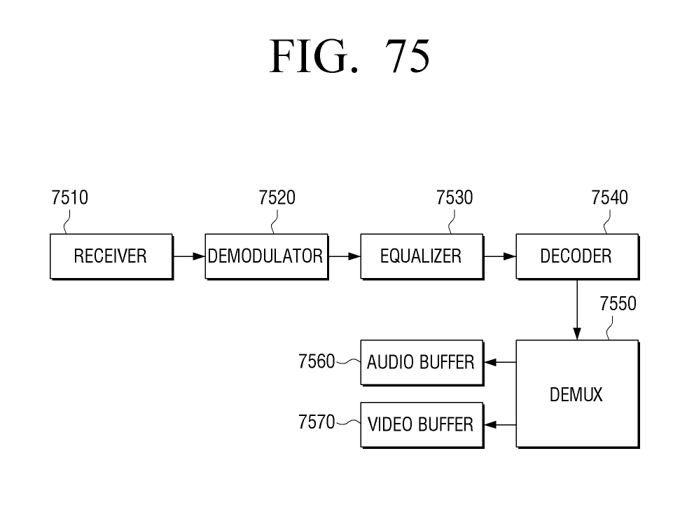

FIG. 75 is a block diagram illustrating a configuration of a digital broadcast receiver configured to receive a stream including M/H data together with the audio packets of normal data and process the received stream.

According to FIG. 75, the digital broadcast receiver includes a receiver 7510, demodulator 7520, equalizer 7530, decoder 7540, demux 7550, audio buffer 7560, and video buffer 7570.

The receiver 7510 is configured to receive a stream containing normal data and M/H data. The received stream is a stream having a structure where a certain number of audio packets are disposed per certain time cycle.

The demodulator 7520 demodulates the received stream, and the equalizer 7530 equalizes the demodulated stream.

The decoder 7540 decodes the equalized stream and provides the equalized stream to the demux 7550.

The demux 7550 checks the packet ID of each packet of the decoded stream and separates the audio packet and video packet. Accordingly, the separated audio packet and video packet are stored in the audio buffer 7560 and video buffer 7570, respectively. The stored audio packet and video packet are read by the access unit (not illustrated) and synchronized and reproduced.

As aforementioned, even in the case where the stream is configured by only an SFCMM slot, a certain number of audio packets are transmitted per certain time cycle, and thus an appropriate number of audio packets are always buffered per access cycle of the access unit. Accordingly, audio services may be supported.

Although a few exemplary embodiments have been shown and described, it would be appreciated by those skilled in the art that changes may be made in these exemplary embodiments without departing from the principles and spirit of the invention, the scope of which is defined in the claims and their equivalents.

1. A stream processing method of a digital broadcast transmitter, the method comprising:
forming a stream containing normal data and mobile/handheld (M/H data); and
encoding and interleaving the stream and outputting and transmitting the encoded and interleaved stream,
wherein the forming of the stream comprises forming the stream such that a predetermined number of audio packets of the normal data are disposed per predetermined time cycle.

2. The stream processing method according to claim 1,
wherein the forming of the stream comprises repeatedly disposing each of a plurality of M/H parades forming the M/H data inside the stream according to a parade repetition cycle to obtain a normal data area per predetermined time cycle and disposing the audio packets in the obtained normal data area, and
the parade repetition cycle is determined to be between 1 and 7 so that a normal data area is obtained per predetermined time cycle.

3. The stream processing method according to claim 1,
wherein the forming of the stream comprises forming the stream so that a plurality of slots where the M/H data is disposed are sequentially continued according to different scalable modes to obtain a normal data area per predetermined time cycle, and disposing the audio packets in the obtained normal data area.

4. The stream processing method according to claim 1,
wherein the forming of the stream comprises forming the stream so that a plurality of slots of which different block extension modes are determined are sequentially connected to obtain a normal data area, and disposing the audio packets in the obtained normal data area.

5. The stream processing method according to claim 1,
wherein the forming of the stream comprises combining different types of slots to obtain a normal data area per predetermined time cycle, and disposing the audio packets in the obtained normal data area.

6. The stream processing method according to claim 1,
wherein the forming of the stream comprises disposing an M/H parade inside the stream according to a starting group number determined differently per each of a plurality of M/H parades configuring the M/H data to obtain a normal data area per predetermined time cycle, and disposing the audio packets in the obtained normal data area.

7. The stream processing method according to claim 1,
wherein the forming of the stream comprises combining a channel mobile mode (CMM) ensemble and a scalable full channel mobile mode (SFCMM) ensemble to obtain a normal data area per predetermined time cycle, and disposing the audio packets in the obtained normal data area.

8. A digital broadcast transmitter comprising:
a stream configurer configured to form a stream containing normal data and M/H data; and
an outputter configured to encode and interleave the stream and output the encoded and interleaved stream,
wherein the stream configurer is configured to form the stream so that a predetermined number of audio packets of the normal data are disposed per predetermined time cycle.

9. The digital broadcast transmitter according to claim 8,
wherein the stream configurer is configured to repeatedly dispose each of a plurality of M/H parades forming the M/H data inside the stream according to a parade repetition cycle, and
the parade repetition cycle is determined to be between 1 and 7 so that a normal data area is obtained per predetermined time cycle.

10. The digital broadcast transmitter according to claim 8,
wherein the stream configurer is configured to form the stream so that a plurality of slots where the M/H data is disposed are sequentially continued according to different scalable modes to obtain a normal data area per predetermined time cycle, and to dispose the audio packets in the obtained normal data area.

11. The digital broadcast transmitter according to claim 8,
wherein the stream configurer is configured to form the stream so that a plurality of slots of which different block extension modes are determined are sequentially connected to obtain a normal data area, and to dispose the audio packets in the obtained normal data area.

12. The digital broadcast transmitter according to claim 8,
wherein the stream configurer is configured to combine different types of slots to obtain a normal data area per predetermined time cycle, and to dispose the audio packets in the obtained normal data area.

13. The digital broadcast transmitter according to claim 12,
wherein the stream configurer comprises:
a normal processor configured to process the normal data;
a data preprocessor configured to format the M/H data; and
a muxer configured to mux the data output from each of the data preprocessor and the normal processor to thereby form the stream;
wherein the data preprocessor comprises a signaling encoder configured to encode signaling data for notifying a type of the slot.

14. The digital broadcast transmitter according to claim 8,
wherein the stream configurer is configured to dispose an M/H parade inside the stream according to a starting group number determined differently per each of a plurality of M/H parades configuring the M/H data to obtain a normal data area per predetermined time cycle, and to dispose the audio packets in the obtained normal data area.

15. The digital broadcast transmitter according to claim 10,
wherein the stream configurer is configured to combine a CMM ensemble and SFCMM ensemble to obtain a normal data area per predetermined time cycle, and to dispose the audio packets in the obtained normal data area.

16. A digital transmitter, comprising:
a data preprocessor configured to receive mobile data, process the received mobile data, and convert the processed mobile data into a format suitable for transmission to a mobile device; and
a multiplexor configured to multiplex the processed mobile data with data suitable for transmission to a fixed device, to thereby form a transport stream,
wherein the transport stream comprises a plurality of first areas and a plurality of second areas, the first areas primarily comprising the processed mobile data, and the second areas primarily comprising the data suitable for transmission to the fixed device, and
wherein the data preprocessor is further configured to insert base data into the second areas, the base data being used for error correction.

17. The digital transmitter according to claim 16, wherein the base data comprises a sequence known to the digital transmitter and a digital receiver configured to receive the transport stream.

18. The digital transmitter according to claim 17, wherein the data preprocessor inserts the base data into the second areas in a long training sequence format where data of or above a predetermined size are sequentially connected.

19. The digital transmitter according to claim 17, wherein the data preprocessor inserts the base data into the second areas in a discontinuously dispersed format.

20. The digital transmitter according to claim 17, wherein the digital transmitter conforms to the ATSC-MH standard.
